(19) United States
(12) Patent Application Publication
(10) Pub. No.: US 2025/0086662 A1
(43) Pub. Date: Mar. 13, 2025

(54) STATEFUL EVENT ANALYTICS THROUGH VISUAL PROGRAMMING

(71) Applicant: Conviva Inc., Foster City, CA (US)

(72) Inventors: Zhengyan Yu, Beijing (CN); Hun Namkung, San Mateo, CA (US); Henry Milner, Burlingame, CA (US); Jiang Guo, Beijing (CN); Joel Goldfoot, San Francisco, CA (US); Yang Wang, Champaign, IL (US); Vyas Sekar, Foster City, CA (US)

(21) Appl. No.: 18/816,913

(22) Filed: Aug. 27, 2024

Related U.S. Application Data
(60) Provisional application No. 63/538,240, filed on Sep. 13, 2023.
(60) Provisional application No. 63/644,743, filed on May 9, 2024.

(51) Int. Cl. G06Q 30/02

(52) U.S. Cl. CPC G06Q 30/02

(57) ABSTRACT

Visual composition of stateful metrics includes receiving, via a user interface, an indication of a user interaction with respect to a visual representation of a timeline operator included in a stateful metric that is being visually composed. It further includes, based on the indication of the user interaction with respect to the visual representation of the timeline operator, providing visual feedback.

### CROSS REFERENCE TO OTHER APPLICATIONS

This application claims priority to U.S. Provisional Patent Application No. 63/538,240 entitled STATEFUL EVENT ANALYTICS THROUGH VISUAL PROGRAMMING filed Sep. 13, 2023 which is incorporated herein by reference for all purposes, and claims priority to U.S. Provisional Patent Application No. 63/644,743 entitled STATEFUL EVENT ANALYTICS THROUGH VISUAL PROGRAMMING filed May 9, 2024 which is incorporated herein by reference for all purposes.

### BACKGROUND OF THE INVENTION

Across many domains (e.g., media/entertainment, mobile apps, finance, IoT, cybersecurity, etc.), there is a growing need for stateful analytics over event streams. Unfortunately, existing frameworks and languages entail significant code complexity and expert effort to express such stateful analytics because of their dynamic and stateful nature.

### BRIEF DESCRIPTION OF THE DRAWINGS

Various embodiments of the invention are disclosed in the following detailed description and the accompanying drawings.

FIG. 1A illustrates an embodiment of raw measurements from a video session.

FIG. 1B illustrates an embodiment of a tabular representation of events.

FIG. 1C illustrates an embodiment of data to be determined.

FIG. 1D illustrates an embodiment of determining a time-state condition.

FIG. 1E illustrates an example of an SQL query.

FIG. 2 illustrates an embodiment of a system for performing time-state analytics.

FIG. 3 illustrates an embodiment of a system for determining time-state metrics.

FIG. 4A illustrates an embodiment of a visualization of discrete events.

FIG. 4B illustrates an embodiment of a timeline representation of an attribute.

FIG. 4C illustrates an embodiment of a timeline.

FIG. 5A illustrates an embodiment of events at discrete points in time.

FIG. 5B illustrates an embodiment of a player state timeline.

FIG. 5C illustrates an embodiment of a Boolean timeline.

FIG. 6A illustrates an embodiment of manipulating timeline representations of attributes.

FIG. 6B illustrates an embodiment of a context timeline.

FIG. 6C illustrates an embodiment of a duration timeline.

FIG. 7 illustrates an embodiment of a time-state metric directed acyclic graph.

FIG. 8 illustrates an embodiment of merging time-state metric graph representations.

FIG. 9 illustrates an embodiment of a timeline configuration file.

FIG. 10 illustrates an embodiment of time-state operators.

FIG. 11 illustrates an embodiment of a timeline operator.

FIG. 12 illustrates an embodiment of determining a time-state metric.

FIG. 13 illustrates an embodiment of performing multi-dimensional aggregation of time-state metrics.

FIG. 14 illustrates an embodiment of a stateful event analytics platform.

FIG. 15 illustrates an embodiment of a metric template.

FIG. 16 illustrates an example of a source data set.

FIG. 17A illustrates an embodiment of selecting an input data set.

FIG. 17B illustrates an embodiment of a dataset preview.

FIG. 18A illustrates an embodiment of an operator tooltip.

FIG. 18B illustrates animation of a stateful operator at an initial or starting time.

FIG. 18C illustrates animation of a stateful operator at an intermediate time.

FIG. 18D illustrates animation of a stateful operator at an intermediate time.

FIG. 19 illustrates an embodiment of an operator tooltip.

FIG. 20A illustrates an embodiment of an operator tooltip.

FIGS. 20B-20D illustrate an example of an operator tooltip animation.

FIG. 21 illustrates an embodiment of an operator tooltip.

FIG. 22 illustrates an embodiment of an operator tooltip.

FIG. 23 illustrates an embodiment of an operator tooltip.

FIG. 24 illustrates an embodiment of an operator tooltip.

FIGS. 25A-25K illustrate embodiments of visual stateful metrics composition interfaces.

FIG. 26A illustrates an embodiment of a stateful event analytics platform.

FIG. 26B illustrates an alternative embodiment of a stateful event analytics platform.

FIGS. 27A-27C illustrate embodiments of visually composed stateful metrics graphs.

FIG. 28 is a flow diagram illustrating an embodiment of a process for visual composition of stateful metrics.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Described herein are embodiments of a timeline framework for time-state analytics that arise across several real-world domains including operational management of large-scale systems and digital infrastructures. Embodiments of the techniques described herein may be used to solve a class of problems referred to herein as time-state analytics. Time state analytics appear in various applications and contexts, such as fitness tracking, healthcare data, mobile app data, video streaming data, infrastructure monitoring, and many other operational analytics and monitoring use cases.

For example, time state analytics are applicable to data that comes in from real world tracking measurements of particular entities, such as a user, device, video playback session, etc. In an example use case such as fitness tracking, various types of status events are collected from data measured with respect to a user, such as when the subject woke up, when they went for a run, various sensor measurements such as heart rate, etc. over time.

For entities being measured, whether devices, users, sessions, etc., suppose that various attributes and values are being measured over time. It would be beneficial to be able to perform analytics on such data collected over time. Examples of such types of analytics include summaries, such as the amount of time spent resting, average stress level, etc.

It would be further beneficial to be able to perform deeper analytics to understand the behavior of an entity, such as the user in a particular status or particular context. This includes determining insights based on both time and state context. In a health and/or fitness example, this includes determining how long a user was in deep sleep, how long the user was in a high stress state, how long the user was in an aerobic range (for heartbeat) when running, was the average VO2 increasing when running, etc. This includes determining measures that are conditioned on the entity also being in a particular context or set of states.

Described herein are techniques for performing time-state analytics, which includes determining time-state metrics. In various embodiments, the time-state metrics are measured in the context of time and state that an entity was in, beyond coarse aggregates (e.g., counts or averages). The time-state metrics include measures of interest of a particular data stream calculated in a particular stateful context. This includes tracking the state or the behavior of a system over time, including measuring statistics and durations of that particular entity over time. For example, determining time-state metrics includes determining, from streaming event data, statistics or measures for entities that are calculated while an entity is in a particular context or state. Other complex examples of time-state metrics and analytics include determining an amount of time or duration that an entity spent in a particular status, the amount of time spent in a certain status while another event was occurring (e.g., how long (duration) a subject was in an aerobic heart range (state) while running (another state)), etc. In such a complex stateful metric example, various states of a user are being tracked, such as whether they are running, the state of the heart rate (e.g., whether it is in an aerobic range), etc.

In some embodiments, determining a time-state metric includes determining measurements or statistical summaries of measurements when in a particular status, such as a count of the number of times events of a certain type occurred when in a particular state. In some embodiments, the time-state metrics include behavioral measures (e.g., counts, statistics, durations) or metrics for entities calculated in a particular context (e.g., status/states, time periods). Time-state metrics are beneficial to understand behaviors in a variety of applications, examples of which are described below.

### Time-State Metrics for Food Delivery

The following is an example of determining time-state metrics in the context of a food delivery service. Suppose a user orders food via the food delivery service via an application such as a mobile app. A stream of event data is generated by a platform associated with the food delivery service, where the event stream includes various event information such as when the order was placed, when the order was received by the restaurant, when the order was picked up for delivery, when the chef started making particular items in the order, whether a modification to the order occurred during making of an item, when the order was delivered, etc. For example, the event stream includes food delivery data that is collected and associated with corresponding date/timestamps.

The following is an example data model for the food delivery example described above. There are various different entities whose behaviors can be tracked, such as the order, each item in the order, the user, the restaurant, etc. For each entity over time, various types of attributes (which may have various types of values) are determined. In various embodiments, attributes that are tracked over time include statuses, events, measurements, etc.

In this food delivery example, different entities may have different types of statuses, events, and measurements. For example, for an order or item entity, example statuses include ready, delivered, prepared, etc. Examples of events pertaining to an order or item entity include whether a modification (a type of event) occurred with respect to the order/item entity. An example of a measurement pertaining to the restaurant entity includes the busyness level of the restaurant. In some embodiments, attribute values (e.g., measurements, status, events, etc.) pertaining to various entities are extracted from event streams.

By evaluating an event stream and tracking attributes for entities over time using such a data model as described above, various time-state metrics related to food delivery may be determined. The following are examples of such time-state metrics for food delivery. As described above, the time-state metrics may be used to understand the behavior of an entity (e.g., user or order) in a contextual manner over time. This allows patterns of behavior for entities to be efficiently determined.

One example type of time-state metric behavior pattern is how much time an entity spent in a certain status. In a food delivery context, this includes, for example, determining how long an order (entity) that is ready (example of status of order) was waiting to be picked up by a delivery driver (where the waiting is another example status).

Another example type of time-state metric behavior pattern is how much time did an entity spend in a particular status when a certain type of event also occurred. In a food delivery context, this includes, for example, determining the amount of delay (duration measure) that was introduced due to a modification (event) to an order (entity). Determining such behavior would allow the food delivery service to understand why delays occurred, and allow them to debug such issues to avoid them going forward.

Another example type of time-state metric behavior pattern is how many occurrences of events of a certain type happened in a given status of an entity. In a food delivery context, this includes, for example, determining what is the number (measure) of modifications (event type) requested before/after the restaurant (entity) started preparing food (status).

### Time-State Metrics for Fitness Tracking

The following is an example of determining time-state metrics in a fitness tracking context described above. One example is a fitness tracker that collects fitness data for a user. As one example, the fitness tracker generated an event stream of data indicating various information, such as outputting, over time, stress level, activity status, sleep status, etc. For example, the event stream includes fitness data that is collected and associated with corresponding date/timestamps.

The following is an example data model for structuring event stream data to generate time-state metrics for fitness tracking. In this example, time-state metrics are modeled for an entity, which is the user in this example. Values for attributes of various types are extracted from the event stream from the tracker over time. Examples of such types of attributes include statuses, events, and measurements.

Examples of statuses for the user (entity) include whether they are asleep, stressed, etc. Examples of events include waking up, starting a run, etc. Examples of measurements include heart rate, VO2, etc.

As described above, the various time-state metrics corresponding to different behavior patterns for entities may be tracked using the data modeling and time-state metric computation techniques described herein.

One example time-state metric pattern is how much time did the entity spend in a certain status. In the context of a fitness tracker, this includes determining how long a user (entity) was in deep sleep (status) per day.

Another example time-state metric pattern is how much time did the entity spend in a certain status when an event or status of a certain type also happened. In the context of a fitness tracker, this includes determining how long the user (entity) was in an “aerobic” heart rate range (status) when running (event type).

Another example time-state metric pattern is an (aggregate) measure (e.g., average, peak, minimum, etc.) of a particular attribute when the entity was in a certain status. In the context of a fitness tracker, this includes determining what is the peak heart rate (attribute measure) when the user (entity) was running (also an example type of status).

Another example time-state metric pattern is how many of a certain type of event occurred when the entity was in a certain status. In the context of a fitness tracker, this includes determining how many stress level transitions (where the transitions are examples of a type of event) occurred when the user (entity) was resting (status).

### Time-State Metrics for Video Streaming

The following is an example of determining time-state metrics in the context of video streaming. Suppose a client device (e.g., user's smartphone, set top box, gaming device, laptop, etc.) collects video streaming data for video sessions played on the client device. As one example, a video streaming application on a mobile device generates an event stream of data indicating various information, such as the occurrence of events, status changes, quality metrics, etc. in heartbeat messages, where the collected video streaming data is associated with corresponding date/timestamps.

The following is an example timeline data model for structuring event stream data to generate time-state metrics for video streaming. In this example, time-state metrics are modeled for an entity, such as a video session. Values for attributes of various types are extracted from the event stream from the tracker over time. Examples of such types of attributes include statuses, events, and measurements over time.

Examples of statuses or states for the video streaming session (entity) include the player state (playing, buffering, seeking), the current network state of the device (e.g., WiFi vs. cellular), the current delivery service being used (e.g., content distribution network A vs. B), etc. Examples of events include user actions (e.g., play, pause, seek), the player actions (e.g., bitrate level changes), network changes (e.g., switching to cellular), and service provider actions (e.g., switching the content delivery server). Examples of measurements include the current bitrate level, the current state of the player, the current frames per second, network errors if any, etc.

In some embodiments, the different data types that attributes may take are encoded in different types of timeline representations. In some embodiments, timeline objects (generated from observed data values) may be of different timeline types.

As described above, various time-state metrics corresponding to different behavior patterns for entities may be tracked using the data modeling and time-state metric computation techniques described herein.

As described above, one example time-state metric pattern is how much time did the entity spend in a certain status when an event or status of a certain type also happened. In the context of video streaming, this includes determining how much time the streaming session/player (entity) was buffering (status) when using a particular type of network or app (event types).

As shown in the examples above, time-state problems are pervasive in a variety of contexts in which data is collected, example domains of which include fitness, food, video, apps, finance, etc.

Embodiments of the time-state metric generation and computation techniques described herein facilitate the determination of time-state metrics in various types of contexts, allowing for the construction of metrics that are measured in a context that is in terms of time and state, beyond coarse aggregates or counts or averages. Embodiments of the time-state metric techniques described herein facilitate actionable insights contextualized in time and status. As will be described in further detail below, the time-state metrics capture behavior measures of interest for entities that are calculated in a specific time and state context. Example patterns of behavior that are determined using the time-state metrics described herein include:
How much time did the entity spend in Status X?
How much time did the entity spend in Status X when Y also happened?
What is the average/peak/min of measurement V when entity was in Status X?
How many of Type-X event occurrences happened when status of Y was Z?

As shown in the examples described above, time-state metrics such as those described herein are beneficial in a variety of contexts, including fitness, food delivery, video streaming, e-commerce, fintech, apps, automotive domains, etc. The time-state metrics described above, which include behavioral measures of interest calculated in a time/state context, are beneficial for determining actionable insights in a variety of applications.

Embodiments of the time-state metric techniques described herein provide improvements over existing basic summary statistics, which may be too coarse-grained to be actionable. Further, the techniques described herein facilitate the determination of time-state metrics in a manner that is more efficient than existing techniques to determine similar types of actionable insights.

For example, existing data processing techniques are based on a tabular or relational model of computation. Suppose a database and collected data. The collected data is placed in a table. The collected data stored in the database is queried using a structured language such as SQL (Structured Query Language). Such a relational model is beneficial for manipulating and querying tabular data such as individual records in rows, where queries are made to, for example, aggregate properties of a population of interest across a column or multiple columns (e.g., by selecting, grouping-by, filtering, etc.).

However, it is challenging to use such a relational or tabular model of computation, which does not inherently have a notion of time or state, to track event streams over time. For example, implementing time-state metrics such as those described above using an existing relational or tabular model would result in the use of complicated and expensive queries that are prone to errors.

The following is an example of attempting to implement a time-state metric using queries of existing relational or tabular databases. An example involving video streaming is described herein for illustrative purposes.

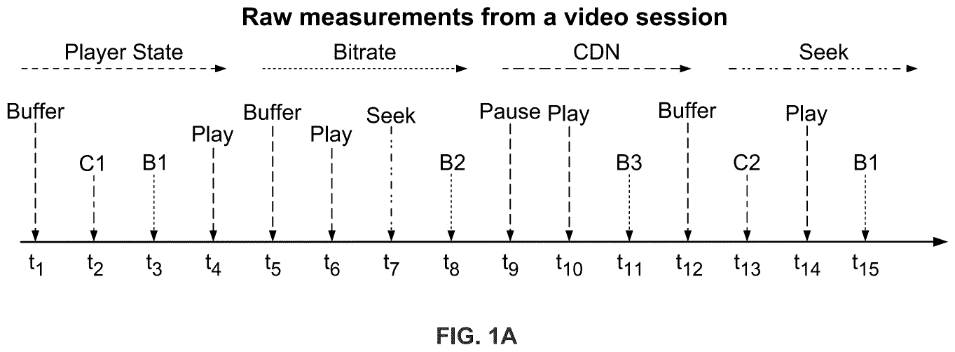

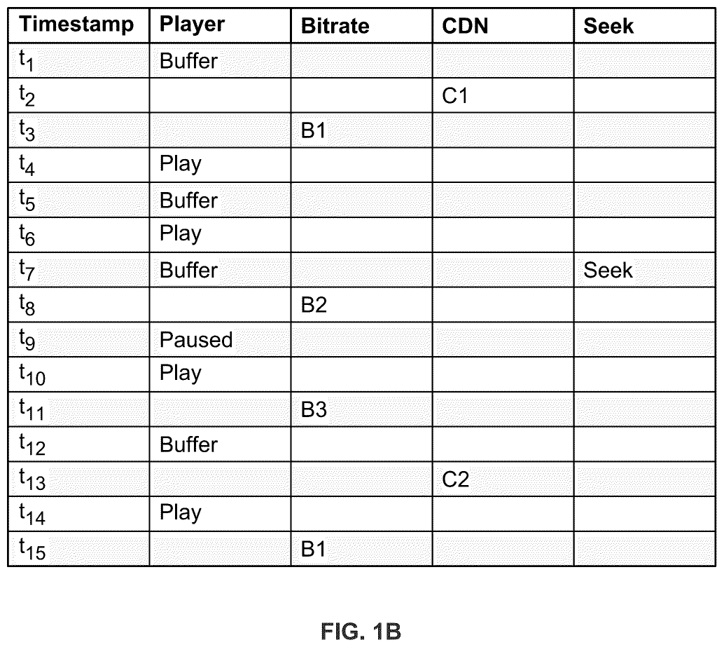

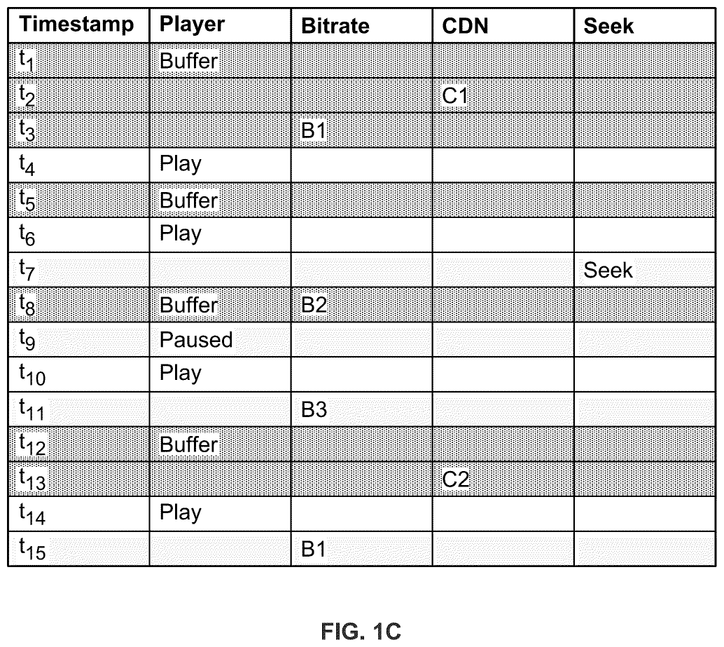

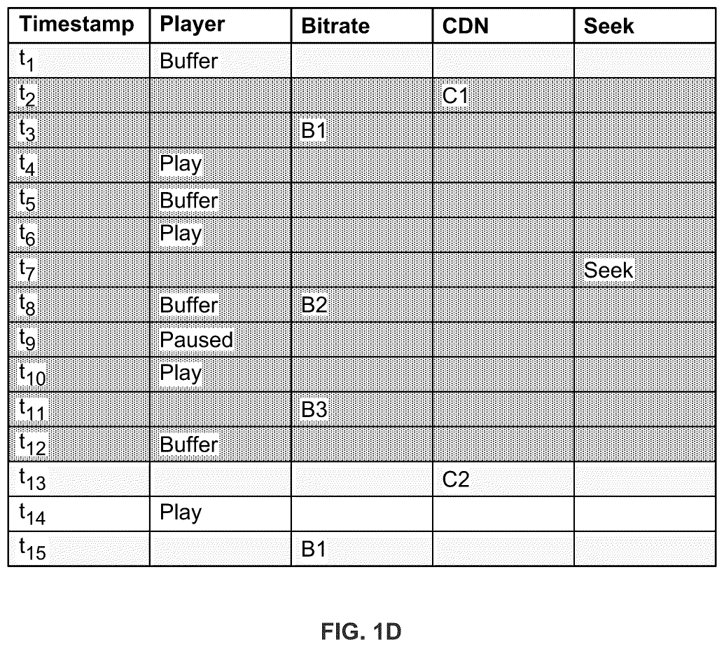

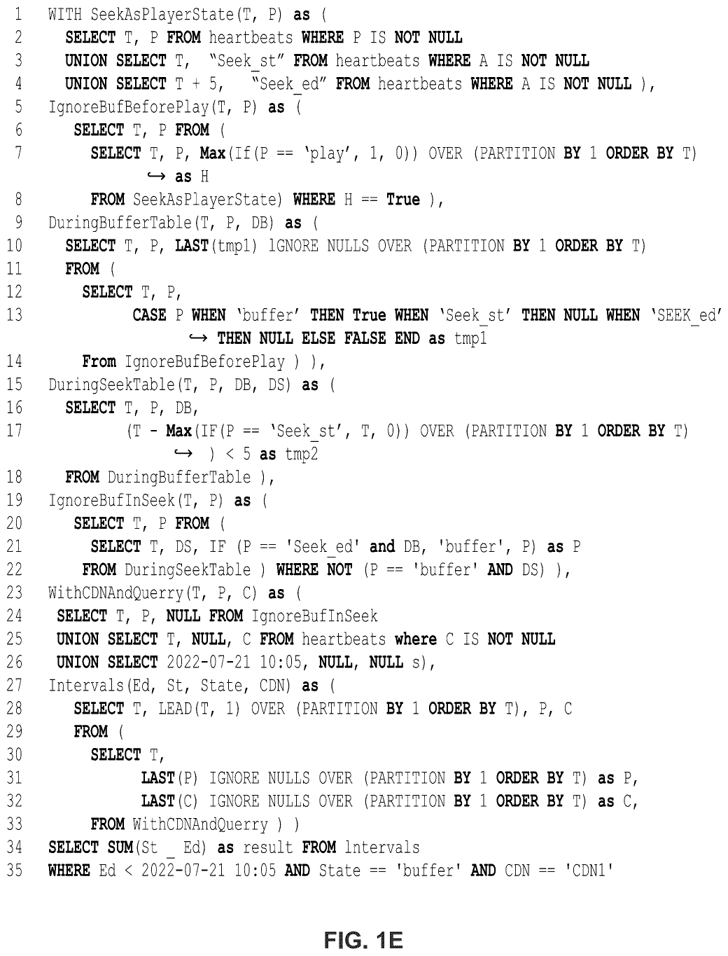

FIG. 1A illustrates an embodiment of raw measurements from a video session. For example, the raw measurements are events received from a client content player. A visual representation of the events over time is shown in the example of FIG. 1A. Shown in this example are various events such as player state changes, bitrate changes, seek events, and CDN (content delivery network) switches that occur over time.

FIG. 1B illustrates an embodiment of a tabular representation of events. In this example, a tabular representation of the raw events described in conjunction with FIG. 1A is shown. In this example, each row corresponds to a timestamp. The events associated with a given timestamp are populated with corresponding values from the raw event stream. In this example, raw measurements for the attributes such as player state, bitrate, CDN, and seek are shown.

In this example, the collected raw events have been stored in a table. The table in this example includes various columns, such as a timestamp column. The columns also include columns for attributes present in the raw event data, such as a player state column, a bitrate column, a CDN column, and a seek column. For each event type, a column is created, where values for the various types of events are stored in the appropriate locations within the table (e.g., appropriate column at cell corresponding to associated timestamp).

Suppose that in this video streaming scenario, the following metric is desired to be determined:
How much time did a session spend in a connection-induced rebuffering state while using CDN C1?

Such a metric is an example of a time-state metric, where a measure of a duration of time in a specific context is to be evaluated. For the measure of duration, the temporal and state context includes four sub-components, such as that the player is in a buffering state, the player had already started playing, the user has not recently seeked, and CDN C1 is being used.

That is, in order to determine this time-state metric, a count of duration (example of a measure) is determined while in the context of the following four conditions:
1. Currently buffering &&
2. Play has already initialized &&
3. User has not seeked in last 5 seconds &&
4. Using CDN C1

As shown in this example, determination of the time-state metric is dependent on multiple conditions, where determination of when the conditions are met is based on the tracking of the occurrence of multiple types of events that may be occurring at different times, and are separated over time.

Given the tabular representation of the raw event data shown in the example of FIG. 1B, in order to generate the connection-induced rebuffering measure given the desired context/state, a complex combination of queries would need to be implemented to ensure that the metric is computed only in the appropriate context, which includes numerous conditions, each of which may be complex to compute in a relational of tabular model.

For example, consider the first state component: that the player was currently buffering. FIG. 1C illustrates an embodiment of data to be determined. In this example, to determine the duration of buffering, a query would have to be written to determine the time when the player was in the buffering state (e.g., condition 1 above). As shown in this example, this would involve scanning the values of the player state column, and determining the amount of time that the player was in the buffering state, which in this example includes determining the sum of t4-t1, t6-t5, t9-t8, and t14-t12, all of which are non-contiguous entities. As shown in this example, the value for the player attribute is only provided when the player changes state, where the player attribute value is only populated for specific timestamps. Thus, determining the amount of time that the player was within a specific state requires a number of queries to be written (e.g., to find the timestamp when the player==buffer, to find the next point in time when a change in the player value occurred, and then finding the difference between the two timestamps, repeating such processing, and aggregating such time periods in which the player was in the buffer state).

In this case, it would be beneficial to model time in a table, as well as model differences in time when a particular state is occurring. However, existing relational or tabular techniques provide insufficient mechanisms to do so, resulting in complex, time-consuming, and error-prone query code.

In addition to generating a complex query to determine the above player state, given the desired constraints/state, furthermore, the buffering state before the first play would have to be ignored (to satisfy condition 2 of the context, which is that the player has already initialized), which would in turn involve writing a complex query to track whether play has started, and ignoring buffering (as every player will buffer at start). That is, further code would need to be written to discount buffering before play started. Doing so in a code language such as SQL code is challenging, as there is not a mechanism by which to track the play state, and remove the buffering before the play. That is, in a tabular or SQL-like model or language, it is difficult to express such intents.

FIG. 1D illustrates an embodiment of determining a time-state condition. In this example, determining when CDN C1 was being used (e.g., condition 4, above) is shown. As shown in this example, it is desired to be able to track when C1 was in use. While the tabular representation can be queried to determine in which rows the CDN column value was equal to C1, it is more challenging to determine the collection of rows (timestamps) or interval in which the CDN was C1 until switching occurred.

As shown in the above example, determining time-state metrics using tabular representations of collected event data is challenging, as, for example, determining intervals or periods in which a system is in a certain state can be challenging. Further, it can be complex to determine logic when multiple conditions are present in the desired time-state metric and are to be combined.

FIG. 1E illustrates an example of an SQL query. In the example of FIG. 1E, a complex SQL query to implement the time-state metric above (with four conditions) is shown. The complex queries result in inefficient computation, in particular, if being scaled for numerous video-playing sessions and many time-state metrics. That is, there is significant compute effort to implement time-state metrics when the data is maintained in a tabular or relational model. Further, significant effort is needed to develop and debug such code, in which there may be difficult to discern semantic errors.

The following are embodiments of techniques that facilitate efficient configuration and computation, at scale, of time-state metrics, which are usable to determine state and behavior of a system in context. The techniques described herein provide various benefits over existing data processing tools that are based on tabular frameworks. Using embodiments of the time-state framework or model described herein, the evolution of attributes over time is modeled in what is referred to herein as a timeline representation, facilitating efficient configuration and computation of time-state metrics. Modeling the evolution of attributes includes tracking values of attributes over time, rather than, for example, at specific points in time. Further, the techniques described herein include computational operations that operate on the timeline representations described herein, where such timeline operations are used to determine how attributes change in relation to other variables, events, and entities. This includes determining, for example, the evolution of a column, and then also understanding the evolution of that column in the context of other columns, which are also evolving over time. The techniques described herein further allow understanding of group and aggregate behaviors over an entire population, as well as over windows of time. This is an improvement over existing tabular or time series models, which do not track such stateful evolution over time, or require high computational cost and effort in order to implement such a class of time-state analytics. Compared to existing relational-based systems, the techniques described herein are more flexible and efficient.

In addition to being more computationally efficient as compared to existing data processing techniques, the techniques described herein facilitate configuration of time-state metrics without requiring coding or writing SQL or other types of code.

The following are embodiments of modeling and computing time-state analytics. Embodiments of the time-state analytics techniques described herein include a number of components, including system architecture and integration of time-state metrics, further details of which will be described below.

Time-state analytics are a class of big data computation problems for actionable insights that require stateful context-sensitive processing over event streams. As shown in the examples above, time-state analytics are important for a variety of applications. For example, in video streaming, many quality of experience (QoE) metrics such as connection induced buffering, exit before start, average bitrate, etc. are stateful and context-sensitive, falling under the time-state analytics class of computational problems.

Described herein are embodiments of a specialized data/compute model for supporting time-state analytics. Embodiments of the data/compute model are also referred to herein as a timeline model implementation. When determining time-state analytics, the timeline processing techniques described herein provide improvements over existing data processing systems, which are based on legacy tabular, relational, or SQL computation models. The timeline processing techniques described herein support fine-grained metrics in real time, at scale. As described above, example benefits provided by the timeline processing techniques described herein include providing actionable fine-grained metrics at reduced cost, with reduced development time, and increased visibility and clarity.

While embodiments of timeline processing and time-state analytics are described below in the context of video streaming, the techniques described herein may be variously adapted to accommodate any other type of time-state metrics as appropriate.

### System Architecture

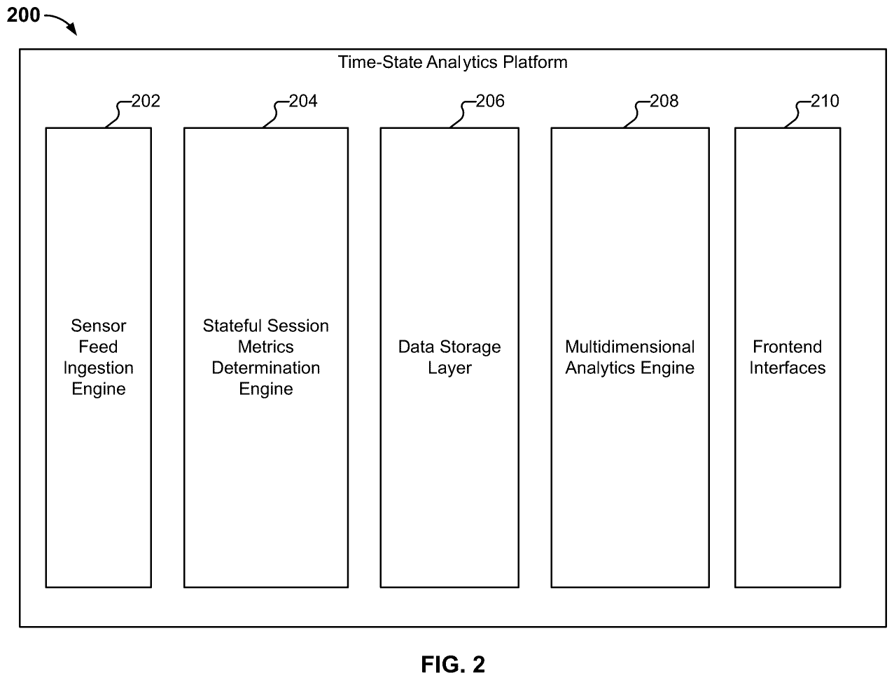

FIG. 2 illustrates an embodiment of a system for performing time-state analytics. Embodiments of queries to the timeline processor described herein include two components-types of metrics of interest, and types of dimensional aggregations to be performed. For example, a query may include an intent to understand aggregate properties of a stateful metric in the context of some metadata. Embodiments of the time-state analytics platform described herein support stateful metrics, as well as dimensional summarizations.

In this example, time-state analytics platform 200 includes a compositional system architecture. In this example, sensor feed ingestion engine 202 is configured to ingest feeds or streams of sensor data from client devices. In the example of video streaming, content players on various devices (e.g., laptops, mobile phones, tablets, desktops, set-top boxes, game consoles, etc.) are configured to stream sensor data (collected by the content player for a video streaming session) to platform 200. For example, various event data or values measured by the content player are transmitted in messages that are transmitted to platform 200 over a network such as the Internet.

Stateful session metrics determination engine 204 is configured to determine stateful session metrics (e.g., time-state metrics) on the feed of sensor data ingested by ingestion engine 202. In some embodiments, stateful session metrics determination engine 204 is configured to convert the stream of raw session data, which may include measures and events collected for multiple types of attributes, into timeline representations of attributes. In some embodiments, the timeline representations for attributes are updated as new values for the attribute are ingested. Further details regarding conversion of a stream of ingested values of an attribute into a timeline representation of the attribute are described below.

In some embodiments, stateful session metrics determination engine 204 is further configured to determine time-state metrics by applying a set of timeline operators on the timeline operations. This includes logically combining timeline representations of multiple attributes in order to determine the context in which a time-state metric is computed. Further details regarding timeline operators and combining of timeline representations to compute a time-state metric are described below.

In some embodiments, the time-state metrics that are computed (e.g., for a video streaming session) by stateful session metrics determination engine 204 are stored to data storage layer 206.

In some embodiments, a time-state metric is computed for events that are included within a certain scope. One example of such a scope is a streaming session (e.g., in the context of video streaming). In some embodiments, time-state metrics are determined on an individual session-level basis. In some embodiments, analytics on cohorts of sessions may be of interest. For example, an individual session is associated with a set of metadata dimensions, such as the ISP (Internet Service Provider, such as Comcast, AT&T, etc.) of the session, the operating system of the session (e.g., iOS, Android, etc.), device type, etc. In some embodiments, multidimensional analytics engine 208 is configured to perform aggregations or rollups on groupings of metrics that share a set of dimensions.

In some embodiments, time-state metrics and aggregations of such time-state metrics are provided as output of platform 200 via frontend interfaces 210.

In this example system 200, a system decomposition is shown in which stateful session metrics are computed when sensor feeds come in, and where multidimensional analytics are performed in a backend. In this example, there is a form of decoupling of the two tasks of determining stateful session metrics and determining multidimensional analytics. In this example, state session metrics are precomputed, with multidimensional analytics performed on the backend. In some embodiments, the time-state metrics are computed in real-time, as a stream of data is ingested. In other embodiments, the timeline representation conversion and manipulation to determine time-state metrics is performed as a batch process (e.g., as a backend process, not only during streaming).

### Timeline Representation Transformation and Time-State Metric Computation

The following are embodiments of computing stateful session metrics. In some embodiments, the computing of stateful session metrics is based on embodiments of the timeline data/compute model for time-state analytics described herein. Using the timeline data structure and computation models described herein, data is processed as a timeline, allowing for modeling of attributes with values that vary over time. As will be shown below, the use of such a timeline data structure and computation model as described herein facilitates the intuitive configuration of queries and metrics, reduces development effort, and allows for various optimizations to reduce resource usage.

In some embodiments, time-state metrics are computed based on timeline representations of attributes. The timeline representations of attributes represent the change in state of values of attributes over time. The timeline representation of an attribute is generated by transforming the raw event data collected for an attribute (which is indicated at points in time, or timestamps) into a state representation that models the change in the values of the attribute over spans of time. In some embodiments, time-state metrics are computed on a session level. For example, raw events for a session are collected. The raw events collected for a session are transformed, using operators, into timeline representations of the changes in values for attributes during that session. A session-level time-state metric is then computed by using a set of timeline operators on the generated timeline representations of one or more attributes, further details of which will be described below.

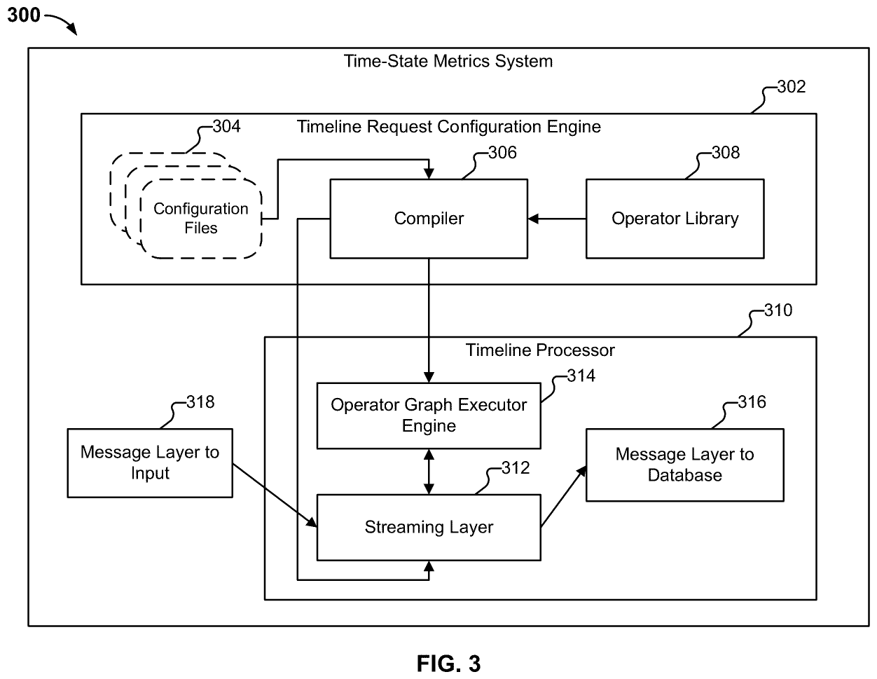

FIG. 3 illustrates an embodiment of a system for determining time-state metrics. In this example, time-state metrics system 300 is an embodiment of stateful session metrics determination engine 204.

In this example, time-state metrics system 300 includes timeline request configuration engine 302 and timeline processor 310. In this example, timeline request configuration engine 302 includes configuration file(s) 304, compiler 306, and operator library 308. In this example, timeline processor 310 includes streaming layer 312, operator graph executor engine 314, and message layer (to database) 316. Further details regarding time-state metrics system 300 and its various components are described below.

In some embodiments, the timeline processor 310 is configured to implement time-state operators and time-state data structures and model representations. In various embodiments, this includes generating timeline representations of attributes and computing time-state metrics by applying a chain of timeline operators. In some embodiments, the timeline processor is implemented using programming languages such as Scala, Rust, etc. In other embodiments, the timeline processor is implemented as an application programming interface (API) on top of existing analytics databases. Other implementations may be utilized, as appropriate.

In some embodiments, the timeline processor takes as input a data stream (e.g., via message layer to input 318), computes time-state metrics, and outputs the time-state metrics to a database.

In this example, the input data stream (e.g., ingested via message layer 318, which is an example of sensor feed ingestion engine 202) includes session data provided in the form of heartbeats, which as one example is implemented in a format such as JSON (JavaScript Object Notation). In some embodiments, the stream is from a source such as Amazon S3, where the stream is processed through the timeline processor.

In some embodiments, the timeline processor receives as input a timeline request configuration from configuration files (304). In some embodiments, the timeline request configuration is a configuration file for individual time-state metrics. Different metrics may be written for processing the data, where each different metric is associated with a corresponding timeline request configuration file. The time-state metrics are to be computed on the stream of raw data received for a session. An ensemble of multiple time-state metrics may be configured to be computed for the session.

In some embodiments, the time-state metric configuration files are consolidated through compiler 306. For example, the system includes an operator library through which metrics are written. In some embodiments, a time-state metric is implemented as a collection of timeline operators that are applied and combined in a particular sequence. In some embodiments, each time-state metric is represented as a graph, such as a DAG (directed acyclic graph). The collection or ensemble of DAGs is provided to the compiler. The compiler, based on the DAGs, refers to the operator library to obtain the code needed to execute the operators specified on the DAGs.

In some embodiments, to execute a time-state metric (e.g., apply a DAG for every session that comes in), the compiler reads the configuration file for a time-state metric. The compiler then instantiates code to execute the graph of operators that form the time-state metric. The compiler synthesizes code for the DAG runtime to execute. For example, the compiler follows the timeline operator graph, identifies the operators to be performed in sequence, as well as retrieves the code for executing the operators and includes any specified operator parameters. For example, the compiler instantiates runtime objects for the runtime to execute. In some embodiments, the runtime has implementations of the operators in a time-state metric configuration.

In some embodiments, the timeline configuration file is in a machine-readable format such as YAML. As one example, the configuration is in a JSON format. In some embodiments, the configuration file is the output of an editor, such as a visual UI (user interface) editor used by a metric-designer to configure a time-state metric.

In this example, the compiler generates the runtime code corresponding to the DAG representation specified in the timeline configuration file. The operator graph executor engine 314 (also referred to herein as a DAG executor) is configured to execute the code provided by the compiler. The DAG executor is applied to data processed by the streaming layer 312, which is configured to receive a stream of raw data. For example, there is a message queue (e.g., message layer to input 318) that takes heartbeats and ingests them into the system. For example, the message layer is configured to stream raw data into the platform. For example, the DAG executor is configured to traverse the nodes of the DAG, and execute the operators at each node according to the parameters and specification of the node (e.g., input arguments, parameters, etc.). Further details regarding graphs of timeline operators used to implement a time-state metric are described below.

In some embodiments, the streaming layer 312 is configured to support complex event processing by performing various tasks such as fault tolerance, checkpointing, watermarking, etc., or any other data quality processing as appropriate. For example, in the real-world, events may not always arrive in sequence due to network delays, failures, data drops, etc. The streaming layer provides a canonical or cleaned up stream of event data that the DAG executor runs on.

In some embodiments, every heartbeat of raw data that is ingested passes through the DAG of operators, end-to-end. For example, the time-state metric is updated for every heartbeat (or message with a set of raw event data). In some cases, the heartbeat may not have events that are of interest to the time-state metric, and may in part be ignored (where the value of the heartbeat may not be changed, since the raw data is not of interest to the operators in the time-state metric and computations are not performed on them, although the span of a timeline may be updated to extend the span range in some embodiments, further details of which are described below).

In some embodiments, the input to an operator is a timeline, and the output of a timeline operator in the operator library is a timeline. In some embodiments, the output provided to the database is in a format that is appropriate for the output database. For example, the message layer to the database is configured to translate or convert the timeline output of the time-state metric into a format applicable to the output database. This includes encoding information in formats acceptable by the output database.

In some embodiments, the message layer to database 316 is configured to format time-state metric outputs into an output database. In some embodiments, the message layer also performs summarizations. For example, for a session, it may be desired to have a value of the metric on a periodic basis, such as every minute or every thirty seconds. In some embodiments, when reporting the session to the database, a summary is generated based on aggregated session value metrics and converted to a format applicable to the database. In this example, what is reported to the database is a “real-time” metric, where the current value of the metric is reported according to some frequency or period. Another example type of metric that is reported is an end-of-lifetime metric. For example, at the end of a session, values for the time-state metrics that were applied are reported to the database.

In some embodiments, the messaging layer is an interface to an output database that is configured to report the results of the time-state processing. In some embodiments, the interface is configured to determine, for a metric, what to report based on the time-state metric value, when to send the report, how to package the report, etc.

The following are embodiments of determining what output data is to be sent. In some embodiments, not only the final result of the metric is provided as output. For example, any node in a DAG (not only the final node) may be tapped, and the corresponding data from that node provided as output.

As one example, suppose that the output of the final node in the DAG is tapped into. The output of the time-state metric may be values, as well as timelines themselves (if supported by the database).

The following are embodiments of determining when to send or transmit output based on a computed time-state metric. In some embodiments, the results of the metric, which are being applied to data as it is ingested, are used to generate an updated value over time as well. The output of the time-state metric may be provided at the end of a session. The values generated by the metric may also be reported periodically to the database (e.g., every thirty seconds). Metric values may also be provided on demand, as the session raw data is streaming in and processed in real-time.

In some embodiments, the processing described herein occurs in a streaming layer, in real-time, operating on raw event data that is being ingested and collected.

As described above, the context in which a metric is computed may be based on the combination of measured attributes being in certain respective states. In some embodiments, metadata associated with a session (whose stream of raw data to which the time-state metric is being applied) is stored along with the metric values. For example, when the time-state processor performs a computation on raw data corresponding to time t=X, the time-state processor generates an output value corresponding to time t=X. A row with a timestamp corresponding to t=X is sent to the database with the metric value computed at that timestamp along with metadata describing the session whose raw sensor data the time-state metric was applied to.

If multiple metric values are being computed, then, for example, the output row includes multiple columns, one for each type of metric. Each row corresponds to a particular timestamp, and the output values computed for the various time-state metrics for that timestamp are included as column values in the row of data provided to the database.

In some embodiments, aggregations or rollups can be performed to aggregate information across different time windows. For example, providing output values as they are computed for every time step may be resource intensive. In some embodiments, samples of time-state metric values (which are potentially being updated as new session raw data is received) may be provided periodically. Rollups can also be performed to determine, for example, averages of the output of a time-state metric, where the average is delivered periodically. This is an example of providing a summary of the metric value. In other embodiments, raw timelines are provided as output to the database. As another example, the time-state metric data structure representation is sent to the database.

In some embodiments, the reported data is packaged as raw data or sent in a “session summary”-like data structure composed of the session attributes and the associated time-state metrics of interest.

In the above example of FIG. 3, the timeline processor facilitates the use of timeline data models in existing data-processing systems. In some embodiments, the timeline processor is configured to translate the events stored in the system's original format to one or more timeline objects/representations. In some embodiments, producing a timeline object includes determining an encoding of an input and identifying the timestamp or time range associated with each piece of incoming data.

The timeline processor is configured to then apply timeline operators. In some embodiments, the timeline operators are selected from a timeline library of pre-defined operators.

The timeline processor is also configured to translate the resulting timeline objects to another data format appropriate for exporting. In some embodiments, digesting or translating the timeline objects includes calculating final outputs (e.g., stateful metrics such as connection-induced rebuffering) by evaluating final timeline object data at specified timestamps or time ranges. In some embodiments, digesting timeline objects includes encoding and exporting results of timeline data evaluation in a format appropriate for downstream consumers (e.g., tables, summary statistics, etc.).

### Example Time-State Metric Determination

The following is an example of computing a time-state metric. In some embodiments, the processing described in this example is implemented by time-state metrics system 300 of FIG. 3.

In this example, suppose that the following time-state metric is to be computed for each video session:
How much time did each video session spend in connection-induced buffering when using Cellular?

In this example, the amount of time that the video session spent in buffering is determined within the context of when the player was using cellular.

Suppose the following received heartbeats that are streamed from a content player, where heartbeats are sent out including sensor data that is measured for various attributes:

```
  {“timestamp”: “1”, “UserID”: “U1”, “SessionID”: “S1”; “Bitrate”: “720p”,
“Network”: “WiFi”, “Player”: “Init”}
  {“timestamp”: “3”; “UserID”: “U1”, “SessionID”: “S1”, “Player”: “Init”}
  {“timestamp”: “7”, “UserID”: “U1”, “SessionID”: “S1”, “Bitrate”: “1080p”}
  {“timestamp”: “8”, “UserID”: “U1”, “SessionID”: “S1”, “Network”: “Cellular”}
  {“timestamp”: “10”, “UserID”: “U1”, “SessionID”: “S1”, “Player”: “Buffer”}
  {“timestamp”: “12”, “UserID”: “U1”, “SessionID”: “S1”, “Bitrate”: “480p”,
“Player”: “Buffer”}
  {“timestamp”: “14”, “UserID”: “U1”, “SessionID”: “S1”, “Player”: “Play”}
  ...
```

As shown in this example, an arbitrary sequence of events or raw or observed or reported data values is received.

While in this example, a heartbeat is shown corresponding to a certain timestamp, in some embodiments, heartbeats are batched together and may include multiple heartbeats, each corresponding to some particular time (indicated by a timestamp).

### Timeline Representation of Raw Measurement Data

In order to determine the duration metric described above, two durations or ranges of time are to be determined. The first duration is the span(s) of time in which the player was in the buffering state. The second duration to be determined is the span(s) of time in which the network was in the cellular state. The end-to-end or overall duration is the amount of time in which the player being in the buffering state overlaps with the network being in the cellular state. That is, the final duration of interest is the amount of time in which the player is in the buffering state AND the network is cellular.

In order to determine the time-state metric, two durations are to be determined: (1) when the player is in the buffering state; and (2) when the network is in the cellular state. A logical AND operation is performed to determine the overlap in time, which in turn is used to determine the final duration metric value.

The following is an example of determining the portion of the context state that corresponds to “when using Cellular.” This includes modeling when the player was using a cellular network (versus, for example, WiFi).

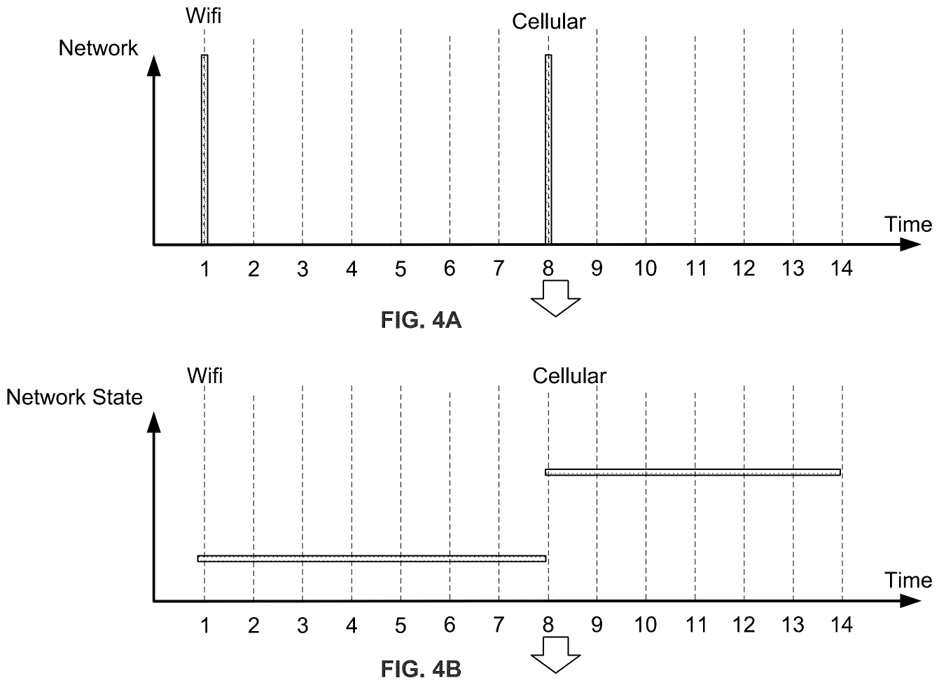

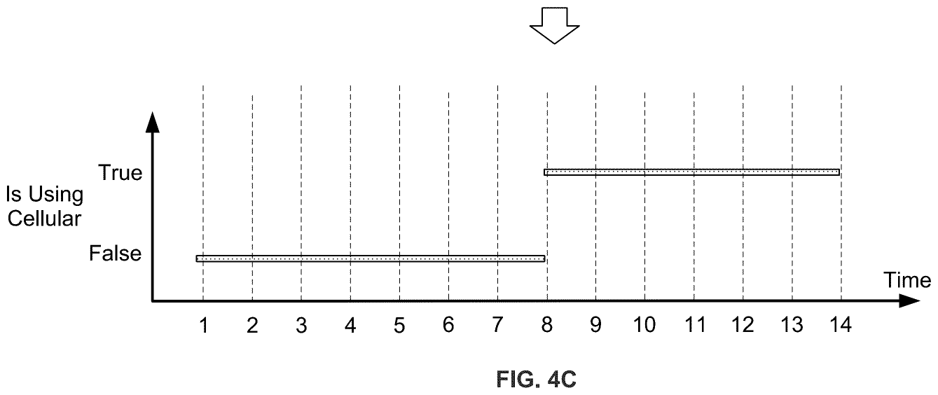

In this example, the network events are extracted from the above example raw data for the session. FIG. 4A illustrates an embodiment of a visualization of discrete events. In this example, a visualization of the values of the network attribute at their corresponding timestamps in the raw event stream is shown.

While the value of the network attribute is shown at selected points in time that correspond to when a sensor measurement (determination of network state) was transmitted, it would be beneficial to determine a timeline of when the player was using WiFi or Cellular. FIG. 4B illustrates an embodiment of a timeline representation of an attribute. In this example, the raw network event data is passed through a timeline operator that reconstructs the “network state” of when the player was using WiFi or cellular. In this example, the player transitioned to cellular at timestamp=8. In this example, a state timeline of the status of the network being used is constructed. As shown in the example of FIG. 4B, the network state is now modeled as spans of time in which the network state was a certain value (rather than at discrete points corresponding to timestamps in the raw data).

In the example of FIG. 4B, the network state over time is constructed, where in this case, the network state is either cellular or WiFi. With respect to the metric under consideration, the particular context with respect to network state of interest is whether or not the network state was cellular. As shown in this example, the discrete network events have been transformed into a state function over time.

In this example, to facilitate determination of when the network state was cellular, as well as to facilitate combining with the other context to be determined (when the player was buffering), the network state timeline of FIG. 4B is passed through another timeline operator to generate a new Boolean timeline representation/model whose value is either True (corresponding to when the network state is cellular) or False (corresponding to when the network state is not cellular). For example, a timeline operator is utilized on the timeline of FIG. 4B, where a True/False value is assigned based on whether the network state value for a span of time was Cellular or WiFi. FIG. 4C illustrates an embodiment of a timeline. As shown in the example of FIG. 4C, the timeline of FIG. 4B is evaluated to determine that “Is Using Cellular?” is true after timestamp t=8, and false prior.

As will be shown below, transforming the raw network events to a True/False timeline facilitates manipulation of multiple timelines in order to determine the overall time-state metric of interest.

The following is an example of determining the portion of the time-state metric context that corresponds to connection-induced buffering.

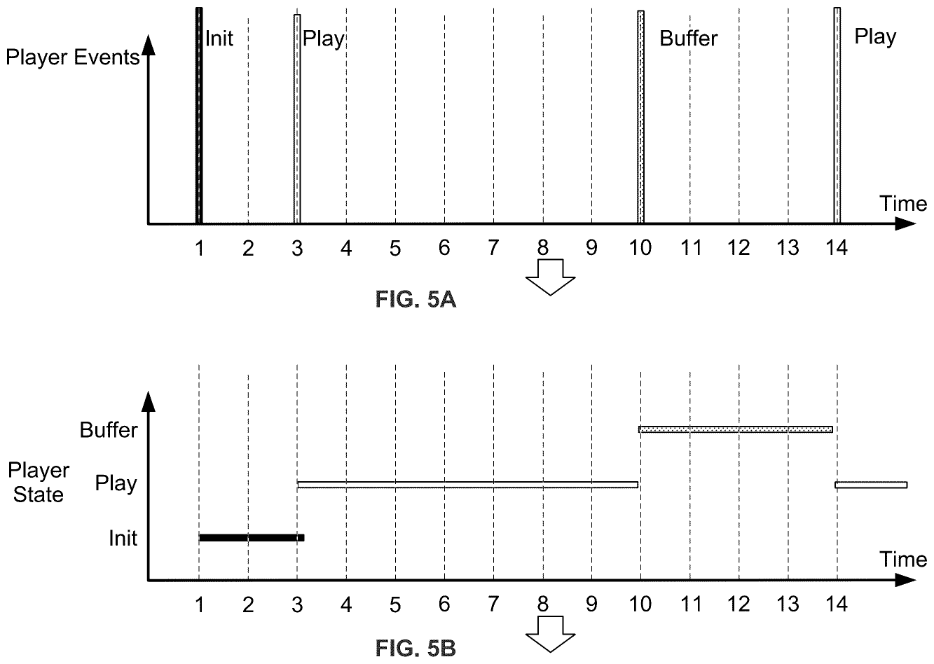

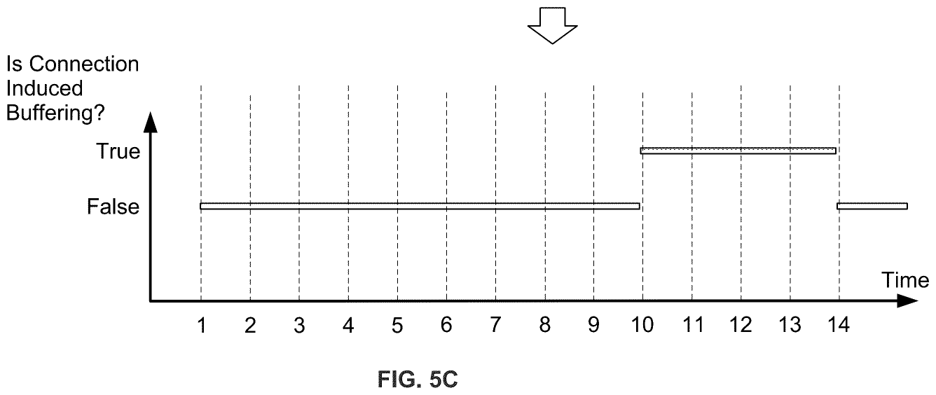

FIG. 5A illustrates an embodiment of events at discrete points in time. The example plot of FIG. 5A visualizes the value of the player events at times corresponding to timestamps in the received raw data above.

FIG. 5B illustrates an embodiment of a player state timeline. In some embodiments, the player state timeline representation is constructed from raw player events extracted from the raw event data received in heartbeat messages. In this example, the player events have been converted to states, where the player state is represented via spans of time in which the player has a certain state.

In order to facilitate determination of the final duration metric, the timeline of FIG. 5B is further converted into another Boolean timeline that indicates whether the player is in the connection induced buffering state.

In this example, the new timeline has Boolean values of either True or False (whereas there were at least three different player states). In this example, the player state timeline is passed through another timeline operator to generate the new Boolean timeline representation/model of FIG. 5C, whose value, for a given span of time, is either True (corresponding to when the player state is buffering) or False (corresponding to when the player state is anything other than buffering).

As shown in the example of FIG. 5C, the timeline of FIG. 5B is evaluated to determine that “Is Connection Induced Buffering?” is true between timestamp t=10 to timestamp t=14, and false otherwise (in the time range of timestamp t=1 to t=15).

The following is an example of determining the end-to-end metric, which is the duration of time when conduction-induced buffering and using cellular are performed. In this example, to determine the time-state metric, first the context is determined. In this example, the context is connection-induced buffering when using cellular. In order to do this, the player state and the network state are combined via a logical AND operator. For example, the timelines of FIGS. 4C and 5C are combined by applying a logical operation (AND) at each point in time.

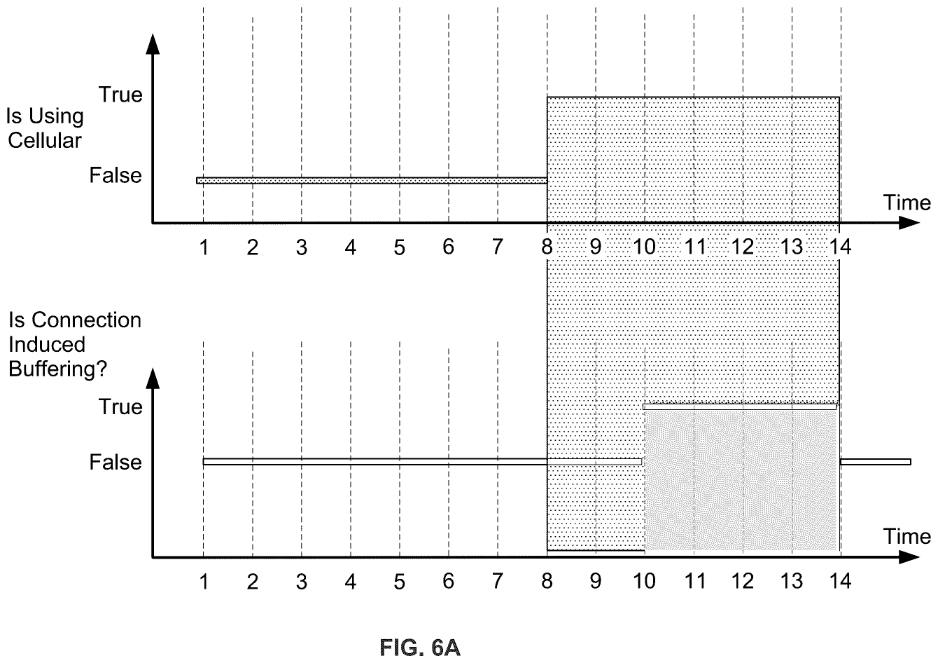

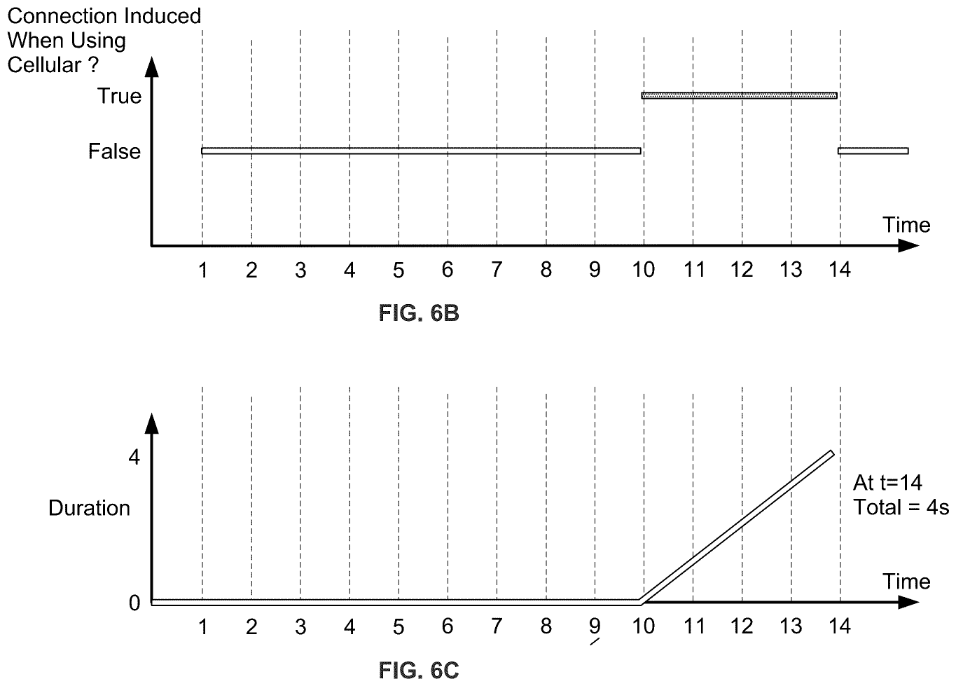

The following is an example of using timelines to efficiently determine the context by manipulating timeline representations of attribute/variable states. FIG. 6A illustrates an embodiment of manipulating timeline representations of attributes. As shown in the example of FIGS. 4C and 5C, Boolean timeline representations were generated from the raw events. In the example of FIG. 6A, the Boolean timelines corresponding to “Is Using Cellular” and “Is Connection Induced Buffering?” shown in FIGS. 4C and 5C are reproduced. In this example, by generating Boolean timeline representations for the context of interest, the overall context is determined by determining when both timelines were equal to true.

In this example, the timelines of FIGS. 4C and 5C are ANDed together to generate a new timeline representing when there was connection-induced buffering AND when the player was using cellular. FIG. 6B illustrates an embodiment of a context timeline. As described above, the context timeline of FIG. 6B is the AND of the timelines of FIGS. 4C and 5C. In this example, the timelines of FIGS. 4C and 5C have been combined by applying a logical AND operation at each point in time.

Now that a timeline representation of the overall context has been determined (e.g., when the overlap in time was true), the metric of duration is computed as the summation of the duration where the overlap was true. In some embodiments, the duration is determined using the context timeline representation of FIG. 6B. In this example, the summation is represented also as a timeline. FIG. 6C illustrates an embodiment of a duration timeline. As shown in the example of FIG. 6C, if the value of duration were measured at time t=4, then the duration value will be 4 seconds spent in buffering time when also using cellular. The timeline representation of FIG. 6C is generated by determining the cumulative duration of where the state of the input timeline (that of FIG. 6B) was True.

As shown in this example, a time-state metric is computed by manipulating timeline representations of attributes. Generating the time-state metric includes the user of various operators to implement the various desired logical functions. As shown in the above example, in order to determine the end-to-end metric of connection-induced buffering when using cellular, a logical overlap of the buffering Boolean timeline of FIG. 5C and the network Boolean timeline of FIG. 4C was determined. Computing the end-to-end duration metric then in turn involves determining an integral of the combined buffering/network timeline.

In some embodiments, time-state metrics are specified through the use of various operators. In some embodiments, the operators are included in a library of operators such as operator library 308.

As shown in this example, events were converted to timeline representations. The timeline representations were then passed through a sequence of timeline operators. For example, the timeline operators take timelines as input and generate output timelines. Some timeline operators also take multiple timelines as input and combine them into one or more output timelines, which may in turn be fed as input to yet other timeline operators. As shown in this example, to determine a time-state metric, raw events are converted to timeline representations and then passed through a chain of timeline operators that are applied in a sequence (e.g., graph of operators as described above).

One example type of operator is one that manipulates raw event data into timeline representations of states. Another example type of operator is one that manipulates the timeline representation of states into a manipulatable timeline representation (e.g., to define Boolean values conditioned on a desired logical operator). Further operators for determining certain types of metrics over time (e.g., duration) are also included. The various types of operators thus provide an efficient mechanism by which to create compact queries for desired time-state metrics.

In some embodiments, the specification of specific operators is composed based on the type of attribute to be converted. For example, to determine the player state Boolean timeline of FIG. 5C, a first operator is used to extract the raw player state events and generate the player state timeline representation of the player attribute of FIG. 5B. To generate the Boolean timeline representation, the timeline representation of FIG. 5B is passed through a logical operator which is configured to determine, over time, when the value of the player attribute is equal to buffer. If the value of the player attribute at some time was equal to buffer, then the output value for that time is set to True. If the value of the player attribute at that time was not equal to buffer, then the output value for that time is set to False. Applying the logical operator over the timeline of FIG. 5B results in the timeline of FIG. 5C.

In this example, the use of timeline representations provides various benefits. Such benefits include more efficient manipulation of data to determine complex state over time, as well as more intuitive visualization of data over time. The use of the representations described herein also simplifies the set of operations used to compose define complex time-state metrics, as compared to using existing relational or tabular techniques.

As shown in the above example, determining a time-state metric from raw events includes multiple components. One component is a data structure/model in which raw events are converted into timeline representations. The timeline representation is a data model for data that appears in time-state problems, such as events, step functions, and measurements. A second component is a computation model which includes executing various operators to manipulate such timeline representations (e.g., combine them) in order to determine the end-to-end time-state metric of interest.

In some embodiments, the computation model includes what are referred to herein as time-state operators. In some embodiments, time-state operators are configured to take as input one or more input timelines, and produce as output one or more output timelines, according to the specification of the time-state operator. The timeline operators of the computation model are configured to manipulate the aforementioned timeline representation, and provide an efficient mechanism by which to express logic that would be more difficult to implement in tabular models such as SQL.

The following are further embodiments regarding time-state operators. As described above, time-state operators are used to manipulate time-state timelines to construct metrics. In some embodiments, time-state operators are configured to take as input one or more timelines, apply one or more transformations, and produce one or more output timelines.

In some embodiments, a configuration of a time-state metric involves specification of a chain of time-state operators to be applied in a particular sequence. For example, the time-state operators are primitives from which time-state metrics are composed. In some embodiments, a compositional language is provided that allows users to combine the aforementioned operators into a directed acyclic graph (DAG) to implement the desired or intended time-state metric.

One example type of operator is to extract a field or attribute from a heartbeat and add a field or attribute value to a timeline representation of the attribute. As one example, to generate the timeline representation of FIG. 4B, an extraction operator for the network field/attribute is executed. In the example of heartbeats in the JSON format, the network extraction operator is configured to identify the network key in the heartbeat message (e.g., as it is ingested) and extract the corresponding value for that key name.

The extracted attribute value is then added to a timeline representation for the attribute. For example, network values are extracted from heartbeats and added to a network timeline.

The following are embodiments of a timeline representation of an attribute. In some embodiments, raw events are converted into a timeline representation. For example, the raw event values are encoded as spans. In some embodiments, the timeline representation includes a representation of the states (e.g., corresponding to different values) that an attribute can be in.

In the example of the network attribute, the network attribute may be one of two values, WiFi or Cellular. In this example, these event values are treated as the two states that the network attribute can be in at any given time. In heartbeats, network events include indications of when the player was using WiFi or Cellular, along with corresponding timestamps. In some embodiments, a network event occurs when the network attribute value changes. For example, suppose that at time t=1, the network value was WiFi. At time t=8, the network value changed to Cellular. This change in network value is an event that is included in the heartbeat. However, between time t=1 and t=8, no network values were sent (as the value was WiFi during that period). This is shown in the example of FIGS. 4A and 4B.

In some embodiments, the network field is tracked over time, where the extracted network values from heartbeats are encoded as spans. In some embodiments, a span includes a start time, an end time, and a value that the attribute had between the start time and the end time.

In some embodiments, the timeline representation is a data structure that includes a set of span data structures. For example, an event-to-state operator is executed to convert the raw events shown in FIG. 4A (which is based, for example, on the raw heartbeat data shown above) to the representation shown in FIG. 4B. In some embodiments, the timeline processor is configured to convert raw events recorded at discrete points in time into state functions over time (also referred to herein as a timeline state representation of an attribute, where the timeline representation is generated by performing a transformation on the raw event data).

For example, the timeline representation of FIG. 4B is encoded as a set of spans, where each span is determined when a change in the value of the network attribute was detected from the raw data. For example, the timeline representation of FIG. 4B is implemented with the following spans:
Span_1: {start_time: t=1, end_time: t=7, value: WiFi}, Span_2: {start_time: t=8, end_time t=14, value: Cellular}.

In some embodiments of the timeline data model representation, the start and end times are inclusive.

In some embodiments, the timeline representation of FIG. 4A is also encoded as a set of spans, where each span represents zero or more raw events. In some embodiments, one span contains a list of events (here in this example denoted as a comma-separated list of event values enclosed in square brackets) that happened at the end_time of the span. For example, the timeline representation of FIG. 4A is implemented with the following spans:
Span_1: {start_time: t=1, end_time: t=1, value: [WiFi]}, Span_2: {start_time: t=2, end_time t=8, value: [Cellular]}, Span_3: {start_time: t=9, end_time: t=14, value: [ ]}.

The above example is an example event-type timeline object in which events are encoded.

In some embodiments, timeline data structures include lists of spans, such as in the example shown above, storing the “span” s of interest where the timeline had a particular value. Various other semantically equivalent encodings of the timeline data structure may be used as appropriate, such as using discretized vector measurements in time, columnar representations akin to columnar analytics databases, and other compressed representations as well. The above example representations are usable directly as data structures (in addition to other semantically equivalent data structures).

In some embodiments, new spans are created, and current spans are closed when a raw event indicates a change in state of the attribute. For example, a new span is generated when an event indicating a change in the value of an attribute is encountered. The now-previous span is closed. For example, at time t=8, a change in the network state value is determined (as it has changed from WiFi to Cellular). Based on this change, the first span is closed, where its end time, which had previously been unspecified and open, is now set to t=7, or the time step just prior to the time of the newly observed value (as this indicates when the network state value stopped being WiFi), thereby closing the span. For example, if the new value was received at time T, then the previous span's end time is now T−1. As one example, the time is modeled discretely, at a granularity of nanoseconds, or any other granularity of units of time or time steps as appropriate.

A new span is created to track the span of time that the network attribute is in its new state of Cellular. The start time is set to be when the new network state was detected, which is t=8. The end time for this new span is not set until the next timestamp at which the state of the network changes yet again. In another embodiment, the end time of a current span is set to be the timestamp of the most recent heartbeat. If a heartbeat comes at the next timestamp, and the attribute value has not changed, then the span is extended by updating the end time of the span to be that next timestamp. This is to account for the fact that the timeline processing is occurring in real time, as raw or observed or reported data samples are being streamed (in real-time) and ingested. In this example, the new span is added to or otherwise included in the sequence of spans of the timeline representing the attribute, and the new span is temporally subsequent to the previous span in the sequence.

As shown in the example above, a timeline object representing the attribute over time includes a sequence of spans or span elements. Each span specifies an interval of time and an associated value of the attribute over that time interval. The spans are created and updated as observed values of the attribute (which are associated with corresponding timestamps of when the events occurred, were sampled, were reported, etc.) are streamed in.

In one embodiment, a span element includes a span start time, a span end time, and a span value. For example, the span start time and the span end time specify a time interval of the span. In some embodiments, the span value is an encoding of the value(s) of the attribute over that time interval specified by the start time and end time. For example, while raw data values for the network attribute may be received intermittently (e.g., when changes in the network attribute occur) as shown in the above example, such as at time t=1 and time t=8, spans are created that specify the value of the network attribute over all time. For example, the span value in the first span of the sequence encodes that the network attribute is the constant state value of “WiFi” during the entire interval of time specified from the start time to the end time of the span. In this way, the span representation may be queried for the value of the network attribute at any time, such as at time t=5, which would return the span value of “WiFi,” even though a network sample corresponding to time t=5 did not exist in the stream of raw data.

Performing such a conversion of observed attribute samples into a compact timeline representation using the techniques described herein provides various benefits. For example, specifying an encoding of value(s) of an attribute that is valid over an interval of time that is determined by a start time and end time specified in a span element allows for a compact representation of the varying of the attribute over time, in contrast to explicit enumerating of the value at each possible timestamp. This provides an improvement in the amount of storage needed to maintain information pertaining to the evolution of values of the attribute over time. The encoding of time-varying attribute values in the compact span representation described herein reduces the amount of storage needed to maintain the information about the attribute over continuous time. Further, the compact representation provides for the benefit of indicating a value for the attribute at points in time where samples were not taken or observed (e.g., at intermediate points in time between times at which samples were taken).

The following are further embodiments of determining the parameters (start time, end time, and encoded value) of a span. In the above example, the end time of a most recent span, and a start time of a next span in the sequence of spans in a timeline representation were determined based on receiving of updated values of an attribute. For example, the end time of a current span is updated until an event timestamp corresponding to a change in state of the attribute is received, where the end time is no longer updated for the current span element, and a new span is created in the sequence to encode the new attribute state and the interval of time over which the new attribute state value is valid.

In some embodiments, the end times and/or start times of spans are determined using other types of time markers. One example of such a marker of time is based on watermarks that are determined when processing real-time streaming data. For example, while a data point or event may be received by the platform at a certain time, the actual event timestamp of a raw data point (timestamp of when the event occurred) would be some time prior. Due to delays, lateness in receipt of data may result in that data not being appropriately incorporated (e.g., where it should have been incorporated based on event time, but was received by the processing system too late to be included). Watermarking may be used to determine thresholds for accounting for late receipt or arrival of events.

In some embodiments, the start/end times of spans may be set to timestamps determined based on watermarks. For example, a span end time may be set to a timestamp that is determined according to a watermark threshold (which specifies, for example, an expected or allowed amount of lateness between event time and receipt time), such that for that interval of time specified for the span, no late arrivals of data points are expected (which could potentially indicate changes or updates to the attribute state value that would require, for example, the end time of the span to be retroactively changed based on the late-arriving event). A new, subsequent span element is also created in the sequence of spans, where the start time is based on the timestamp generated according to the watermark threshold, where the value for the new span is set to the value of the prior span (in the case where a new event data value was not received). Existing spans may be closed (e.g., end time is set and no longer changed), and new spans created based on new watermark-based timestamps being determined (which may occur as a batch process over time).

In some embodiments, the value of the attribute at a given timestamp or point in time is determined by querying the timeline with the given queried-for timestamp and determining which span (which has a corresponding time span) the queried for timestamp is included in. The value of the attribute at that span is returned.

As described above, it would be beneficial to determine when a timeline for an attribute has a certain value. In some embodiments, this is performed by using what is referred to as an “Equals” operator, which takes as input an attribute timeline, and generates a Boolean (e.g., true-false timeline such as that shown in the examples of FIGS. 4C and 5C). For example, each of the spans in the timeline representation is accessed, and the value for each span is compared against a value of interest. A new timeline is generated that has the same spans, but for each span, now has a true or false value based on the comparison between the attribute value for that span and the value of interest.

### Time-State Metric Request Configuration

As shown in the above example of determining how much time did a video session spend in connection-induced buffering when using cellular, the computation of the time-state metric involved the execution of a chain of operators applied in a particular sequence to transform raw events to timeline representations, manipulate timeline representations (e.g., perform logical operations on timelines to combine them), as well as determine measures (e.g., cumulative duration) on timelines.

In some embodiments, the chain or sequence of operators used as primitives to construct or build the time-state metric is expressed as a directed acyclic graph (DAG) of operators. The processing logic represented by the DAG of operators is registered as a configuration for the time-state metric. Such processing logic is used to perform computations on the event stream in a streaming manner.

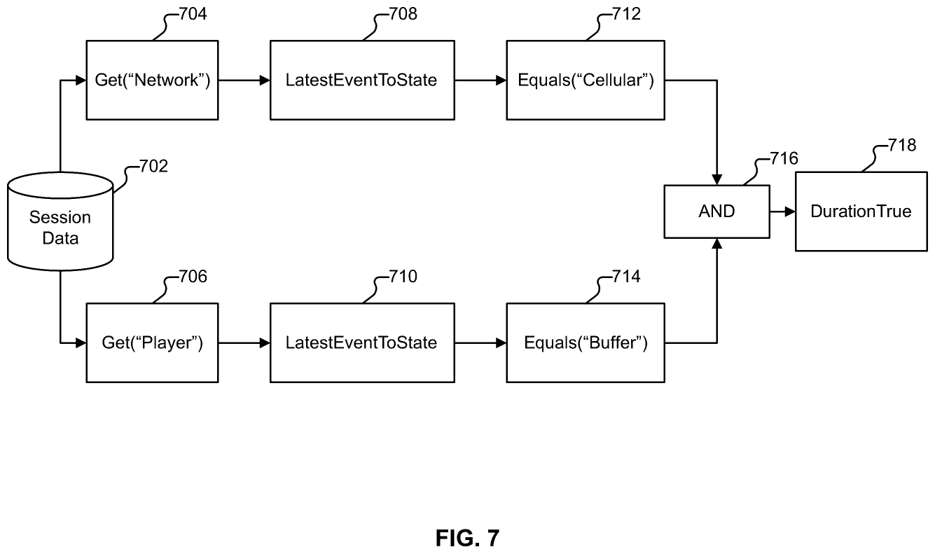

FIG. 7 illustrates an embodiment of a time-state metric directed acyclic graph. FIG. 7 shows an example composition of operators to create a metric DAG for the time-state metric above (How much time did each video session spend in connection-induced buffering when using Cellular?). In this example, Get operators 704 and 706 are used to extract specified attributes (network and player attributes, respectively) from the session data 702 (that may be streaming in). Timeline representations are generated by using the “LatestEventToState” operators 708 and 710 to generate the timelines shown in the examples of FIGS. 4B and 5B, respectively. In this example, the “GET” operators are configured to extract specified information (e.g., specific fields, or according to a function) from raw data (e.g., JSON format heartbeats, or any other raw data format such as CSV). The “LatestEventToState” operator is configured to take the extracted values for the field and convert the raw events into a timeline representation with the encoding of spans as described above (and update the timeline representation as new events are received).

Equals operators 712 and 714 are used to generate the True/False timelines shown in the examples of FIGS. 4C and 5C, respectively. For example, the equals operator is configured to compare each update or state with a fixed value or parameter specified for the parameter (network=True and player=buffer), producing True or False.

The output timelines provided as outputs of operators 712 and 714 are logically ANDed together using timeline AND operator 716 to create the timeline shown in the example of FIG. 6B. The timeline of FIG. 6B is then passed as input to duration operator 718, which is configured to perform integration and create the timeline shown in the example of FIG. 6C.

The DAG representation of a time-state metric is used to capture the sequence of operations to be executed, as well as the combining of sub-operations, which models the combining of multiple contexts in multiple states.

As shown in this example, a node of a DAG representation of a time-state metric is an operator (selected form the operator library) with (optional) corresponding parameters. The directionality of the edges between nodes indicates the input to an operator node, and where the output of the operator node proceeds to (e.g., another node in the graph of operators). Further details regarding timeline operators are described below.

### Operator Graph Optimizations

In some embodiments, new metrics are registered to the timeline analytics system. For example, an ensemble of metrics may be registered or configured, where each time-state metric is represented as a DAG.

In some embodiments, the DAGs of the metrics in an ensemble are evaluated, and DAG consolidation is performed. For example, graphs or subgraphs of operators that are common to multiple metrics are identified so that they are only determined once (rather than being computed multiple times and repeated for the entire ensemble). This is one example type of DAG optimization. The following are further details of performing such operator graph optimization.

As described above, a compiler is configured to read timeline metric configurations and execute the metric by implementing the operators in the DAG representation of the timeline metric configuration. In some embodiments, multiple time-state metrics are to be applied to the stream of raw data for a session (where the collection of time-state metrics is referred to herein also as an ensemble of time-state metrics). In some embodiments, the compiler is configured to perform optimizations such as consolidation, which includes determining whether there are any common or overlapping portions of the graph representations of the collection of time-state metrics being computed. When a portion of a graph that is common to two or more time-state metrics is identified, the sequence of operations (e.g., sub-graph of nodes) identified in the common portion of the graph is performed once, rather than being repeated for each metric computation. For example, one global sub-DAG of operators can be performed. For example, by representing time-state metrics as a directed graph of operators, graph optimizations are performed to prevent common nodes (where nodes are operators, and the common nodes are those operators that are being performed across multiple metrics) from being repeated. Rather, that portion of time-state processing is reused. In some embodiments, such graph optimizations are performed by the compiler. This improves computation efficiency and reduces computation cost.

For example, the compiler is configured to identify subgraphs that are common to graph representations of two or more time-state metrics in an ensemble of multiple time-state metrics to be applied to an incoming session's raw data. In some embodiments, the consolidation performed by the compiler includes performing merging of DAGs.

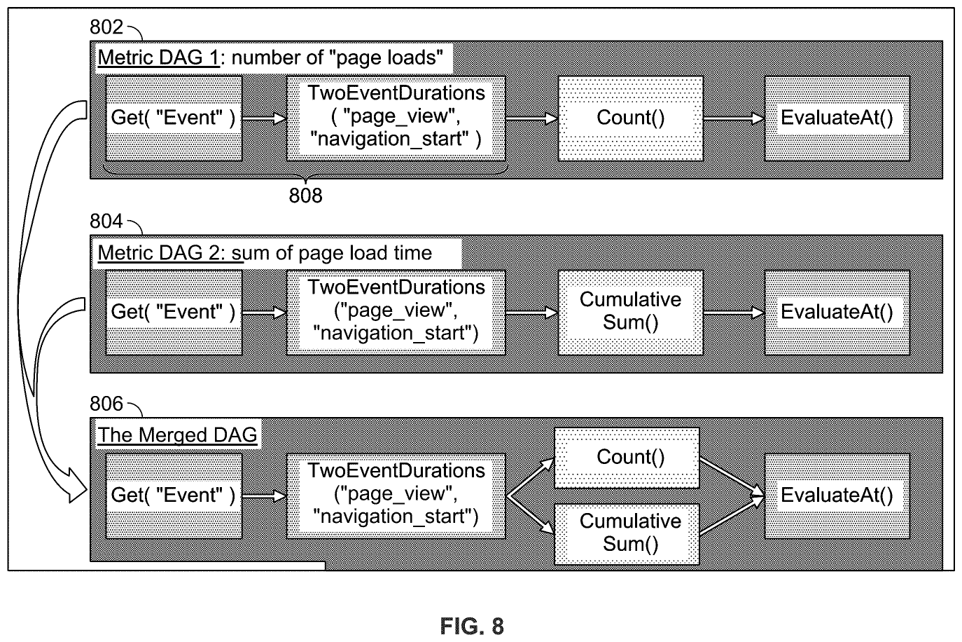

FIG. 8 illustrates an embodiment of merging time-state metric graph representations. In this example, suppose two time-state metric graph representations 802 and 804 are in an ensemble of metrics to be applied to a session's stream of raw data. As shown in the DAG representations of the metrics, the two metrics' graphs share common subgraph portions, such as the subgraph 808 with the node for the operator Get with the same parameter of “Event” to get, as well the next node being the TwoEventDurations operator, also with the same parameters “page_view” and “navigation_start.” At the end of both metrics is also the EvaluateAt( ) operator.

As shown in this example, the compiler is configured to evaluate the DAGs of both Metric DAG 1 and Metric DAG 2 and identify overlapping portions of the timeline graph representations to be executed. As an optimization, the compiler merges the two DAGs to generate merged DAG 806. As shown in this example, by having graph representations of time-state metrics (which are composed of sequences of operators), various types of graph optimizations may be performed to reduce computation cost. For example, the subgraph with nodes Get (“Event”) and TwoEventDurations (“page_view,” “navigation_start”) need not be performed (e.g., executed) twice.

### Timeline Configuration File Example

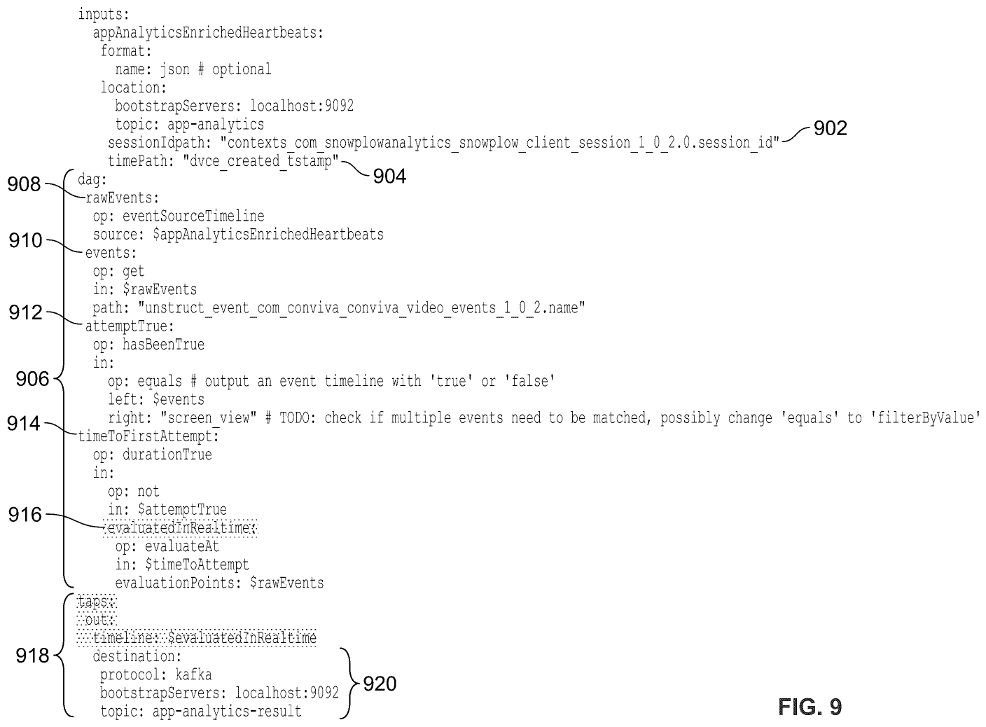

FIG. 9 illustrates an embodiment of a timeline configuration file. In this example, the configuration file is in a JSON format from a particular host. The configuration file may be written in other formats, as appropriate. In this example, at 902, an identifier of the computation scope (session identifier path to events for the session) to which the time-state metric will be applied is shown. At 904, the data that will be used to designate timestamps is also indicated, as different data may be encoded differently.

The DAG portion 906 includes named nodes, such as “rawEvents” (908), “events” (910), “attemptTrue” (912), “timeToFirstAttempt” (914), “evaluatedInRealtime” (906), etc. For each node, the following node parameters are specified:
op: the timeline operator to be performed
in: the input to the node that the timeline operator will operate on. The input may be the output of another node, the logical combination of multiple outputs, etc.

In some cases, multiple metrics may share portions of their respective DAGs.

In the example of the rawEvents node 908, the operator is “eventSourceTimeline” which is applied to the source raw data included in heartbeats.

Following the node specifications of the inputs, outputs, and operators forms a directed-acyclic graph of a processing chain of operations. Each operator refers to what the input node is. For example, the operation called “get” refers to the output “rawEvents.”

In this example, the “rawEvents” node is configured to use the operator “eventSourceTimeline” to convert the source data from the heartbeat format to a timeline compatible format. The heartbeats for a session (identified by the session identifier path) specified in the source parameter are treated as an event source. The “events” node includes a “get” op(eration) that takes as input the raw event timeline from the “rawEvents” node (where the “$” symbol refers to the output of a node in the DAG).

In some embodiments, the node specifies a parameter to be used in conjunction with the operator, which includes, for example, a field name in a data set.

Some operators, such as the “attemptTrue,” take as input two timelines. That is, an operator may be configured to take in multiple inputs. Operators may also provide multiple timelines as output.

In this example, the time-state metrics configuration also includes a taps section 918. In some embodiments, the taps portion is a specification of where (e.g., output of particular node) in the DAG that output data is to be obtained. For example, the output of any node may be tapped and provided as output. In this example, the output of node 916 (“evaluatedInRealtime”) is to be obtained. A specification of where and how the tapped output is to be provided is shown at destination portion 920. For example, a protocol and server location for the output to be sent to is specified. The outputs of multiple nodes of the DAG may be specified and provided as output.

### Operator Taxonomy

The following is an example taxonomy of time-state operators:
Extract: Take in as input raw data or a time-state object (object with timeline representation) and perform manipulations (e.g., get by field, filter by value) to produce time-state objects (e.g., timelines).
Transform: Take in as input one or more timelines and apply different types of arithmetic (e.g., add, subtract, multiply, divide), logic (e.g., AND, OR, Not, etc.), comparisons (e.g., =Equals, <Less than, >Greater than, >=Greater than or equal to, <=Less than or equal to, etc.), accumulations (e.g., count, duration), stateful operations (e.g., time between events) to produce new timeline objects. Example types of transform operators include logic, arithmetic, comparison, stateful model, accumulator, etc.

In some embodiments, applying a transformation to a timeline includes evaluating each span in a timeline, and applying the transformation to the span value in a given span. An output timeline is generated with a corresponding set of spans, but with the span values including transformed versions of the span values of the input timeline. In some embodiments timeline operations are configured to combine two or more timelines and generate a third timeline as output. In some embodiments, the value for the output timeline at a given point in time is determined by accessing the spans of the input timelines, determining which spans of the input timelines the given point in time belongs, and determining the values of the spans that the given point in time is included in. The transformation is then applied to the values obtained from the input timelines. The result of the transformation is then included in the output timeline. In this way, for the output timeline, the value of the output timeline at all points in time for the session is determined. For example, for every point in time, an input timeline is queried. The value of the attribute at the queried-for time is returned. For example, querying a timeline at a queried-for time includes identifying a span in which the queried-for time is included. The span value for the identified span in which the queried-for time is included is returned. If the span value is a function, then the value at the queried-for time is determined according to the function specified in the span value. A transformation is applied to the value returned based on the querying of the input timeline with the queried-for time. If there are multiple input timelines, then each of the input timelines is queried at a queried-for time, as described above, and the returned values are combined in accordance with an operator to be performed. An output timeline is then updated based on the combining of the values returned from the querying of the input timelines.

As shown in the example above, in some embodiments, the output of the timeline operator is also a timeline, which also includes a sequence of spans, where the parameters of each span (start time, end time, and encoded value for the interval of time specified by the start and end times) in the output sequence are determined based on the transformation applied to the span elements of the input timeline.

The number of spans in the output sequence need not match the number of spans in the input sequence, or have the same start/end times. For example, when a timeline operator evaluates a span in the input sequence of spans, this may result in splitting of the input span into multiple spans in the output sequence.

As one example, suppose an operator that checks whether a condition is True if a value is above a threshold, or False if the value is below the threshold. Suppose a span in the input sequence of spans with the following span parameters:
Input_span: {start_time: t1; end_time: t3; value: y=m*time+b}

Suppose that based on the encoded value of the input span, which is a linear function of time in this example, the operator determines that the condition is False (value is below the threshold) until t2, and True on/after t2, where time t2 is between t1 and t3.

This results in the operator splitting the input span into two output spans, such as the following:
Output_span_1: {start_time: t1, end_time: t2-1, value=False}, Output_span_2: {start_time: t2, end_time: t3, value=True}
Export: Take in as input one or more timeline objects and repackage them into a format/schema that is amenable or compatible for a downstream consumer (e.g., file, database, stream, etc.).

As described above, in some embodiments, metrics are implemented as a DAG of time-state operators. The operators are implemented to operate in the domain of timeline representations/data models, where the operators may then be composed in a variety of ways to create time-state metrics as desired. For example, the set of operators (except for “GET” and “LatestEventToState,” which encode raw events measured at points in time into spans) takes timelines as input, and outputs timelines. This allows the output of one operator to become the input of the next or subsequent operator.

The following are further embodiments of timeline operator taxonomy.

In some embodiments, operators are classified along the following dimensions:
Stateful vs. Stateless Operation
Number of Inputs: Unary vs. Binary vs. K-ary
Type of Input/Output Timelines specified by the temporal type, value type, etc. for input and output timelines
Computation: Mathematical/Algebraic function to apply

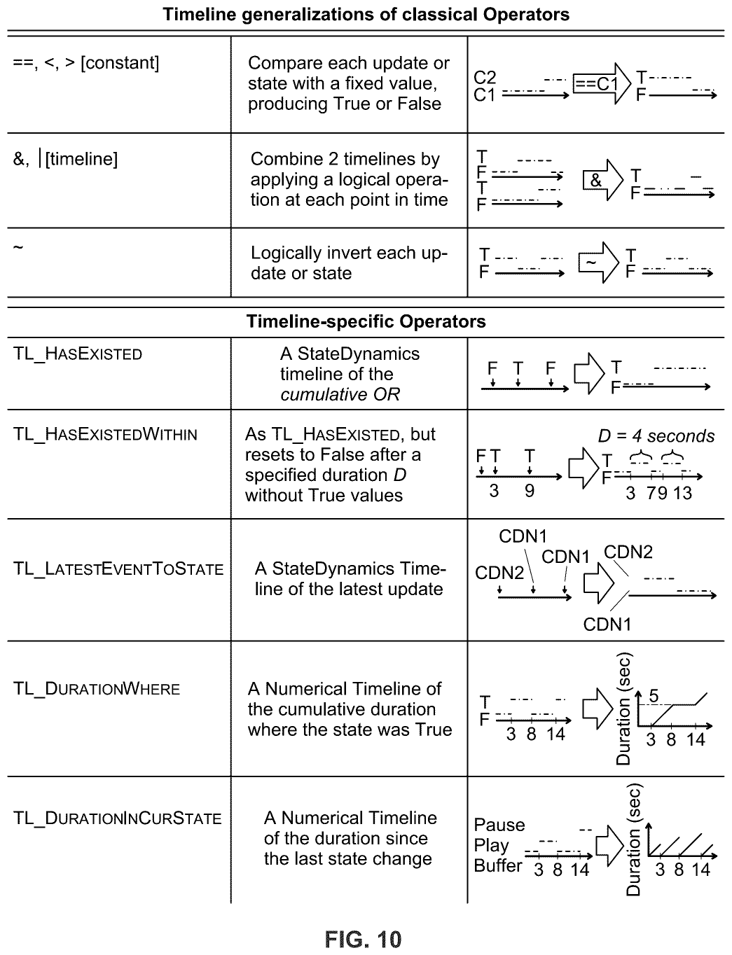

FIG. 10 illustrates an embodiment of time-state operators. One example of such an operator is referred to herein as “LatestEventToState.” In some embodiments, the latest event to state operator is configured to perform stateful modeling, including treating event updates as state machine values. This includes interpreting raw event data as a state machine, where updates to events (changes in attribute values) are triggers that are interpreted as state or status changes.

In some embodiments, generating a timeline request configuration includes selecting a set of timeline operators and specifying an arrangement (e.g., chain or sequence) of the timeline operators to form a time-state metric. In some embodiments, a library of timeline operators is provided for selection by a designer, where the timeline operators provided form a set of primitives from which time-state metrics are composed.

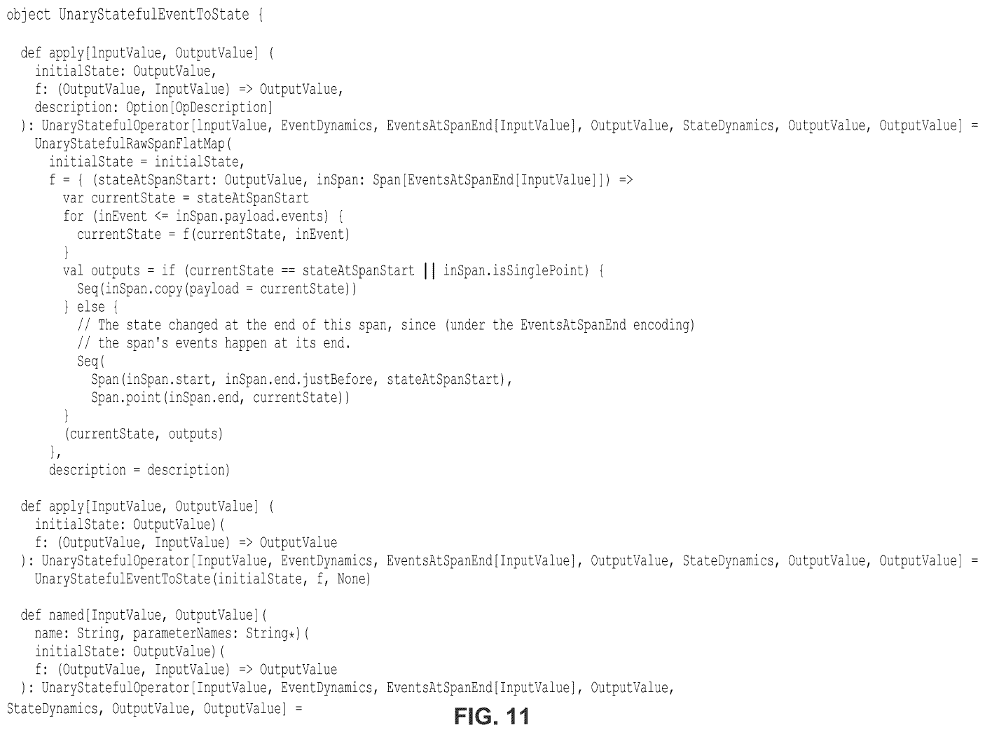

In some embodiments, each timeline operator is associated with a set of code to implement the timeline operator. FIG. 11 illustrates an embodiment of a timeline operator. In this example, the code shown is configured to take a timeline of events as input and produce a timeline of states, which may be used, for example, to compute a cumulative count of events, or interpret events as state changes.

Handling of Attributes with Continuous Values and Discrete Events

The network attribute described above is an example of a step function or state function-type event data, where the value for the attribute is one of a finite set of discrete states. The events related to the network attribute are converted into states in a timeline representation.

Not every event is convertible into a state change (where, for example, the value of an attribute is constrained to being one of a finite set of values). For example, frame rate is a continuous measurement. When a change in frame rate value is received in a heartbeat, this does not necessarily mean that the frame rate was the same value between the current timestamp and the last time a frame rate measurement was received. For example, if at timestamp t=1, the frame rate was reported as 60 frames per second, and at timestamp t=10, it is reported that the frame rate was measured to be 30 frames per second, this does not necessarily mean that the frame rate had stayed at 60 frames per second between t=1 and t=10. That is, for attributes with continuous values, what is received in the raw data may include samples of measurements, which are not necessarily translatable into a finite set of states. That is, not every piece of raw data can necessarily be translated from an event to a state machine.

The following are embodiments of operators for transforming attributes with continuous measurement values (of which samples are received over time) into a timeline representation, including encoding continuous measurement values into spans.

As one example, suppose that a bandwidth sample measurement is received in heartbeat messages. The timestamp at which a bandwidth sample was taken is recorded. In some embodiments, for each measurement sample, a span is created and/or a previous span is closed. For example, the timestamp corresponding with a received measurement sample is used to mark the end of one span and the start of a next span. In some embodiments, for the period between two bandwidth samples, interpolation is performed. For example, the values of the attribute during the interval of time are encoded as a time-dependent function.

As one example, linear interpolation is performed between the bandwidth values. In this way, according to the linear function, the interpolated bandwidth at a time between the two timestamps is determined. This results in a timeline that has piecewise linear spans. For example, the bandwidth samples are treated as events at discrete points in time. The value for the attribute at intermediate points in time within the span between the times of two bandwidth samples is determined based on interpolation (e.g., linear interpolation, polynomial interpolation, or any other type of interpolation as appropriate). For example, in the data structure for a timeline representation of an attribute with continuous values, the value for a span (e.g., for timestamps in the span between two samples) is specified as a function of the sample values received at the beginning and end of the span. In some embodiments, the sample itself is recorded as a zero-width span, for example, with the start time set to be the same as the end time, and with the value of the zero-width span being the sample measurement that was received in the raw data. In some embodiments, the samples themselves are encoded in an event-type timeline.

Duration is another example of a continuously changing value, which may be a native value from raw data, or a derived measurement. Consider for example FIG. 6C. In some embodiments, such a continuous value that changes over time is represented or encoded in a numerical-type timeline object. As one example, the timeline representation for the timeline of FIG. 6C has the following data structure representation:
{start_time: 0, end_time: 9, value: 0} {start_time: 10, end_time: 14, value: duration=(time-10)}

In this example, the possible values of the attribute within the span or interval of time are encoded in a function that, as one example, is determined based on linear extrapolation/interpolation, where the value within a span (start time to end time) is determined according to a linear function of time. In the span from t=0 to t=90, there was no change in value, the slope was 0, and the value is 0. In the span from t=10 to t=14, the value is encoded as a linear function of the form y=m*time+b, where the slope m is 1 and the intercept b is −10.

In some embodiments, time is modeled in a discrete manner, such as in the examples described herein. For example, inclusive spans and discrete time are used in various embodiments of the timeline data model described herein. In other embodiments, time is modeled continuously. That is, the timeline implementation described herein may be variously adapted to accommodate discrete or continuous models for time.

Another type of timeline is an event-type timeline that is used to encode discrete events. Examples of discrete events include indications of an occurrence of an action. For example, a user clicking on a button is an example of an occurrence of a discrete event, where there is not an associated state. The button press is recorded as a discrete event and provided as raw data. The following is an example of generating a timeline representation of discrete events. For such discrete events, the start time and the end time of the span are the same. In this way, the event is recorded. If the timeline is queried for a time in between the times at which the event was recorded, a null set may be returned (as that event was not known to have occurred in those in-between times).

As described above, example types of timelines include event timeline objects for encoding discrete events, state-dynamic-type timelines for encoding step (state) function, and numerical-type timelines for representing continuously evolving values. Span representations are generated for each type of event timeline. In the example of attributes with continuous values, while samples are received at discrete points in time, the value for spans (in the numerical-type timeline representation used to encode such continuous values) is determined as a function of the received samples. For example, rather than treating continuous values such as temperature measurements or humidity measurements as discrete values, they are treated as continuously evolving values, where samples are received, and the continuous nature of the attribute over time is represented by interpolation (where the value over time in some span is computed as a function rather than a specific value).

As shown in the above, three example types of timelines supported by the platform described herein include:
StateDynamics: embodiments of this type of timeline capture a state having a value at each point in continuous time but changing at discrete points: e.g., player state and CDN state in the above examples. In some embodiments, this type of timeline captures state/step functions. For example, a step function-based timeline is generated and updated based on the latest measurement.
Numerical: embodiments of this type of timeline represent (continuous) values varying over time. Such types of timelines may also arise as intermediate representations—for example, the cumulative time spent in the connection-induced rebuffering state. Examples of span values for such a type of timeline representation include time-dependent functions.
Event: embodiments of this type of timeline capture a sequence of discrete events. As one example, user seek events, player state updates, and CDN updates are encoded as Event-type timelines.

Event-type timeline objects may entail sparse encodings, where instead of tracking whether events occurred at each timestamp/window, an event-type timeline object stores when events occur.

For StateDynamics and Numerical objects, in some embodiments, spans are defined. In some embodiments, a span is an event time interval associated with either the value over that interval (for StateDynamics-type timelines) or an encoding of its evolving numerical values (for Numerical-type timelines, such as encoding via time-dependent functions). In some embodiments, StateDynamics and Numerical-type timeline objects are represented as a compact list of span elements (rather than, for example, enumerating each timestamp/window).

As shown in the above examples, different types of timeline objects are used for representing different types of attributes, or are used to determine different types of encodings of values that vary over time. Different types of timeline objects are also associated with different ways of determining span starts/ends and encoding values.

The use of such compact data structures facilitates the efficient implementation of semantic-aware operations over such encodings.

### Multidimensional Analytics

The following are embodiments of performing multi-dimensional aggregations and analytics.

As described above, in some embodiments, time-state metrics are computed within a certain scope, such as on a session-level basis. After session-level metrics have been computed and stored, aggregations over metadata may then be performed. For example, aggregations of the time-state metric across sessions that share one or more characteristics (e.g., device type, operating system type, location, etc.) may be performed. Examples of such roll-ups or aggregations include averages, counts, etc.

For example, the system performs pre-computing the per-session metric (as a stream of raw event data is ingested) using the timeline representation described above. A user may then perform an aggregation to determine what that metric was in aggregate for all sessions that happened for Android in San Francisco, or for any other segment, as desired. That is, in a first stage, individual, per-session metrics are computed. A second stage of processing includes performing aggregation across a segment of sessions that share a set of characteristics.

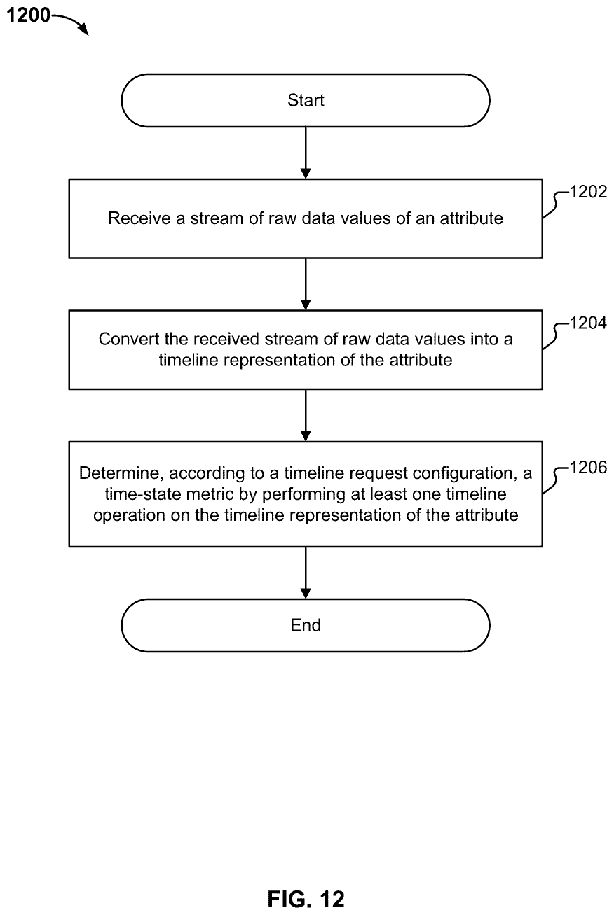

FIG. 12 illustrates an embodiment of determining a time-state metric. In some embodiments, process 1200 is executed by time-state metrics system 300 of FIG. 3. The process begins at 1202 when a stream of raw or observed data values of an attribute is received. Each raw data value is associated with a timestamp (e.g., event timestamp of when an attribute value was measured, collected, reported, sampled, etc.).

At 1204, the received stream of raw data values is converted into a timeline representation of the attribute over time. In some embodiments, the converting includes encoding the received stream of raw data values into a sequence of one or more spans or span elements. In some embodiments, a span element includes a span start time, a span end time, and a span value. In some embodiments, the span value includes an encoding of the value (or values) of the attribute over a time interval determined by the start time and the end time of the span. For example, a span is an event time interval associated with either the value over that interval (e.g., for attributes with finite states), or an encoding of its evolving (over time) numerical values (e.g., for attributes with continuous values).

As one example, the value associated with a span is (semantically) encoded as a constant value (e.g., state) for the interval of time. For example, raw events with observed values at sparse, discrete points in time are converted or encoded into values specified over intervals of time, allowing for the value of the attribute to determined over all time (and not just at the timestamps corresponding to when events were observed or reported).

As another example, the value associated with a span is encoded as a time-dependent function that is valid over, or otherwise applicable to, the interval of time (e.g., function that determines, as a function of time, the value of the attribute at points in time within the span's specified time interval).

In some embodiments, the timeline objects representing attributes over time are represented as a sequence of spans. As one example, a timeline object is represented as a compact list of span elements. As another example, a timeline object is represented as a table, where each row represents a span, and the table includes columns for span parameters, such as span start time, span end time, and span value. Further details regarding encoding of raw or observed data values into spans of a timeline representation are described above.

At 1206, a time-state metric is computed according to a timeline request configuration. The timeline request configuration includes one or more timeline operations. The time-state metric is computed at least in part by performing a timeline operation on the timeline representation of the attribute. Further details regarding timeline request configurations, composing of time-state metrics using a set of timeline operators, graph representations of time-state metrics, etc. are described above. In some embodiments, determining the time-state metric includes performing computations on, or otherwise combining, timeline representations of multiple different attributes whose values may vary over time (and where the attributes may be of different data types).

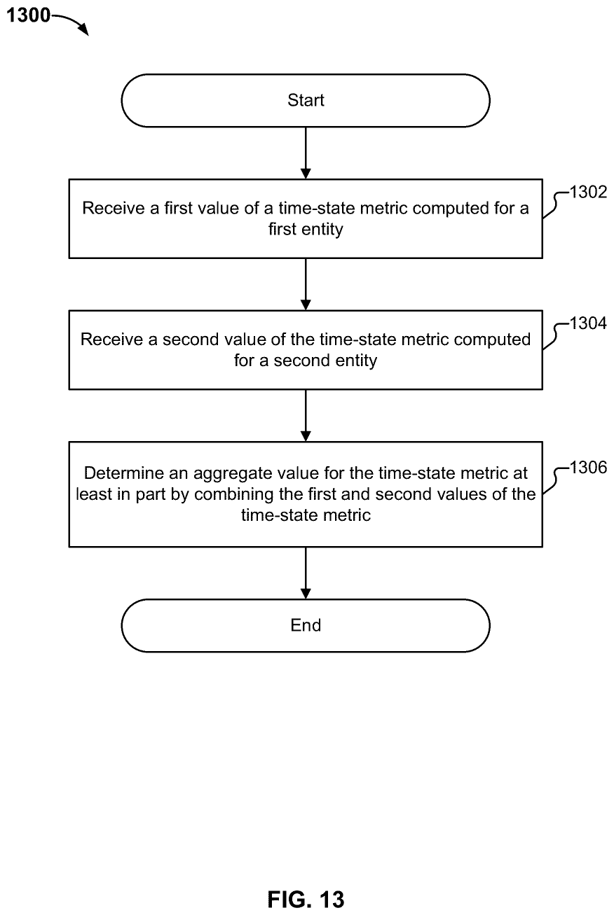

FIG. 13 illustrates an embodiment of performing multi-dimensional aggregation of time-state metrics. In some embodiments, process 1300 is executed by multidimensional analytics engine 208 of FIG. 2. The process begins at 1302 when a first value of a time-state metric computed for a first entity is received. In some embodiments, the first value of the time-state metric is computed using process 1200 of FIG. 12. For example, the first value of the time-state metric is computed at least in part by performing, according to a timeline request configuration, one or more timeline operations on a first timeline representation of an attribute for the first entity, where the first timeline representation is generated at least in part by converting a first stream of raw data values of the attribute associated with the first entity into a first set of span data structures comprised in the first timeline representation of the attribute for the first entity.

At 1304, a second value of the time-state metric computed for a second entity is received. In some embodiments, the second value of the time-state metric is computed using process 1200 of FIG. 12. For example, the second value of the time-state metric is computed at least in part by performing, according to the timeline request configuration, the one or more timeline operations on a second timeline representation of the attribute associated with the second entity generated at least in part by converting a second stream of raw data values of the attribute associated with the second entity into a second set of span data structures comprised in the second timeline representation of the attribute for the second entity

At 1306, an aggregate value for the time-state metric is determined at least in part by combining the first value of the time-state metric and the second value of the time-state metric computed, respectively, for the first entity and the second entity. For example, the first entity and the second entity are grouped together into a segment based at least in part on one or more shared dimensional attributes. For example, the first entity and the second entity are two video streaming sessions that are grouped together based on the first and second sessions sharing dimensional attributes in common (e.g., common CDN, ISP, device type, etc.). Based on the grouping of the first entity and the second entity into the segment, an aggregate value for the time-state metric is determined by performing an aggregation on the first and second values of the time-state metric.

### Stateful Metrics Visual Composition

The following are embodiments of visual composition and programming of stateful metrics.

As described above, in many domains, such as content streaming in media and entertainment (also referred to herein as M&E), app analytics, internet of things (IoT), security, and FinTech, streams of events are collected. It would be beneficial to analyze the streams of events in a stateful manner. In some embodiments, stateful analytics and metrics refer to data processing that is dependent on the sequence, order, timing, and/or context in which events occur.

For illustrative purposes, the following are examples of a stateless computation versus a stateful computation.

As one example of a stateless computation, suppose data is in a table. An average of the values in a column is to be performed. This is an example of a stateless computation, where the order of the rows does not impact how the average is computed. For example, the rows could be swapped amongst each other, and the same average value would be computed. In this example stateless computation, the sequence of the rows in the table did not impact the computation being performed.

Now consider an example of a stateful computation. In this example stateful computation, the sequence in which data is processed, as well as the context in which the data is processed impacts the result of the computation being performed. For example, suppose a fitness tracker that senses and records various events over time, such as heart rate or stress rate at particular points in time, as well as when various user activities occurred, such as when a user started running, stopped running, started working, stopped working, etc. Suppose a table of various detected events, such as what the user's stress level was at different times, what their detected activity was, etc. Suppose that the computation to be made is the average stress rate when working. For this stateful computation, the stress rate while the user was also in the status of working (where the working activity status is the context in which the event data is to be processed) should be evaluated. In this example, the sequence or ordering of events impacts whether the requested computation will be correct, as the context in which relevant events occur matters. In this example, the working status is determined by one set of events (activity status), stress levels are determined based on another set of events on stress measurements, and to compute the average level of stress when working, the two sets of events are correlated and aligned. If the rows of events were mixed or jumbled, the computation would be incorrect.

Another example of a stateful computation is determining the time that a webpage or app takes to load when the server load is high or low. Loading time is determined from when a user clicked on a page until the page is loaded. In order to determine the load time, the time between two events is to be computed, which involves processing the sequence of user clicks. If the timestamps for these events were evaluated in an arbitrary order, this could result in a negative value of page load time, which would be invalid. Further, correlation with when server load was high would not be able to be performed.

Stateful metrics are also beneficial in the context of video streaming, where experience metrics can be modeled as stateful metrics. In various embodiments, in the context of video streaming analytics, computing stateful metrics includes evaluating a sequence of events, where the timing, the sequence, and the order of events is modeled in order to facilitate computation of a measure or a quality experience metric. One example of a complex stateful metric in the video streaming space that is facilitated by embodiments of the techniques described herein is buffering after a subtitle change was clicked on by a user. For example, a user selects an option to add captions, subsequent to which video started buffering. In this case, an event happened (captions request), where buffering occurred within some amount of time of the subtitle/captions request. Another example of a complex stateful metric in the video streaming space that is facilitated by embodiments of the techniques described herein is connection induced buffering ratio, examples of which are described above.

As described above, stateful metrics are dependent on the sequence, order, and the timing in which events occur. For example, converting raw event streams into actionable insights and stateful metrics includes modeling the sequence of events, timing between events, and temporal correlations with other system variables. As another example, computing a stateful metric includes evaluating event sequence, timing, as well as other attributes at the same time. Embodiments of the techniques described herein address challenges in the domain of stateful metrics and analytics.

The following are two example challenges with supporting stateful metrics. One example challenge is that existing systems, such as existing analytics and columnar databases, are not performant (or have poor performance), and lack the capabilities for supporting such stateful computations over a sequence of events. Embodiments of the time-state analytics framework and architecture, as well as embodiments of the timeline representation described above support such a class of workloads (stateful metrics) in a manner that is more performant, and with reduced code complexity, as compared to existing systems.

Another challenge with existing systems in handling stateful computations is that there is engineering and development complexity in writing the code to create such stateful metrics. Using existing techniques, a programmer would have to write highly complex SQL, Spark, Flink, or Java programs in order to implement stateful metrics. That is, with existing techniques, complex raw code would have to be written to process a stream of events to create a model to express stateful metrics. Debugging and validation of such a class of metrics would also be exacerbated when coded using existing techniques. Such implementation complexity with existing systems reduces the accessibility of stateful metrics to users and increases the time to implement such metrics to track key business outcomes.

Described herein are embodiments of an interactive system by which users can directly create sophisticated stateful analytics and immediately see the results on dashboards, without requiring the users to write code. Using the stateful metrics visual composition techniques described herein, a tool is provided to simplify the process of stateful event analytics.

As described above, in some embodiments, to simplify, and make more efficient, processing of the class of workloads including stateful metrics computation and analytics, rather than processing event streams in tabular format, event stream data is represented as a timeline including spans. As further described above, to process such timeline representations of event data, embodiments of a timeline computational framework, including timeline operators, are utilized. For example, the operators include extraction operators to convert raw event data into timelines (e.g., event stream data into event timelines and state timelines). The operators also include functions that are specified or configured to perform transformations on timeline representations of data. As described above, with such a timeline data representation and a timeline processing framework, the logic of stateful metrics can be specified as chains or directed acyclic graphs (e.g., DAGs) of timeline operators that are configured to operate on timeline representations of event stream data. Here, event data is viewed or represented as logical timelines, and timeline operators are used to manipulate such logical timelines to express stateful analysis. Embodiments of the timeline data representation and timeline processing framework described herein translate low level event measurements into higher level actionable insights by modeling the event sequence, event timing, and correlations with other system variables at a given point in time.

Further details regarding embodiments of timeline representations of event data, a timeline framework and timeline operators, as well as graph representations of stateful metrics that are specified as chains of the aforementioned operators, are described above.

The approach of using the timeline data representation and timeline operators, as compared to existing tabular-based approaches, provides system performance improvements, increasing the speed and efficiency at which stateful analytics can be computed.

It would be beneficial to have an interactive tool that facilitates efficient creation and interactive debugging of stateful analytics and stateful metrics. Embodiments of a stateful metrics visual composition system are described herein. The visual composition system described herein leverages both the aforementioned representation of event stream data as logical timelines, as well as the operators of the timeline framework described herein to provide an easy-to-use interactive system by which sophisticated stateful analytics and metrics can be created. Embodiments of the visual composition system described herein facilitate efficient user-creation of stateful metrics that are specified in the realm of timeline data representations and operators. Embodiments of the visual composition system described herein simplify the process of creating stateful analytics, lowering the barrier of entry to express complex stateful analysis using a “no-code” visual programming approach. For example, the stateful metrics visual composition system described herein is much more intuitive and less time-consuming than using existing tools such as SQL editors to implement stateful metrics. Embodiments of the visual composition system described herein further support fast prototyping and validation of stateful metrics.

Embodiments of the timeline representation described above provide a “geometric,” visual, or graphical basis for viewing data as visual timelines of events, measurements, and continuously evolving system variables. Embodiments of the timeline operators described above support stateful analytics, and provide various system performance improvements. Embodiments of the interactive metrics composition system described herein facilitate simplification of the creation of stateful analytics that is easy to use for developers. Embodiments of the techniques for interactive metrics composition described herein address challenges in stateful analytics where existing data analytics abstractions (e.g., tabular) and capabilities (e.g., SQL, Spark, Flink, etc.) are lacking. For example, existing data analysis systems are based on tabular models, where existing analysis tools based on such tabular models are not equipped to support the class of stateful processing needs, such as manipulating time, duration, and event sequences. Thus, the status quo for existing data analysis systems and programming paradigms is that stateful analytics require expert code developers to create complex code to express their data analysis intents. Embodiments of the techniques for interactive metrics composition improve upon existing systems by making it easier to express and debug stateful analytics.

Embodiments of the stateful metrics programming techniques described herein democratize the ability to create stateful metrics over event streams, giving access to stateful metrics creation to a larger number of users that may have varying levels of coding experience, and also reduce the time to debug such metrics for both expert and novice users. This is an improvement over using existing systems to implement stateful metrics, which have various challenges, examples of which are described above. Using the techniques described herein, users are able to express logic for specifying stateful metrics without necessarily having to write code, and visually debug potential logic issues in the metric definitions interactively, as they develop the metric logic.

The following are embodiments of a visual programming interface for composing stateful metrics (also referred to herein as time-state metrics). For example, the intent or logic of a program representing a stateful metric can be expressed without requiring a user to write low-level code. Embodiments of the time-state/timeline architecture described above provide primitives such as time-state/timeline operators for stateful metrics. In some embodiments, such primitives are made accessible (e.g., via an API) to support creation of stateful metrics. Embodiments of the stateful metrics builder described herein further democratize building or constructing of stateful metrics, such that a user can compose or program such complex metrics with low or no code. For example, the visual composition system described herein democratizes metrics creation, as it allows those users who may not traditionally create metrics (using SQL or other streaming frameworks) to be able to create metrics by drawing DAGs rather than writing code. Compared to the stateful metrics visual composition tool described herein, writing stateful metrics with existing tools such as SQL queries is much more complicated and tedious, less intuitive to debug, and difficult to verify. On the other hand, the stateful metrics visual composition system described herein is more convenient and takes much less time to finish by providing intuitive step-by-step visual verification as the developer creates their stateful metric.

In some embodiments, the stateful metrics composition techniques described herein include a visual programming or composition interface. For example, using the techniques described herein, the complex logic of a stateful metric can be programmed or expressed visually, such as by visually drawing a graph of operators to form the stateful metric. For example, as will be described in further detail below, using the visual stateful metrics composition techniques described herein, a user can graphically construct stateful metrics (e.g., via dragging and dropping in a stateful metrics interface). Embodiments of the visual composition system described herein further allow users to visually observe the impact of what they are doing as they compose a stateful (time-state) metric.

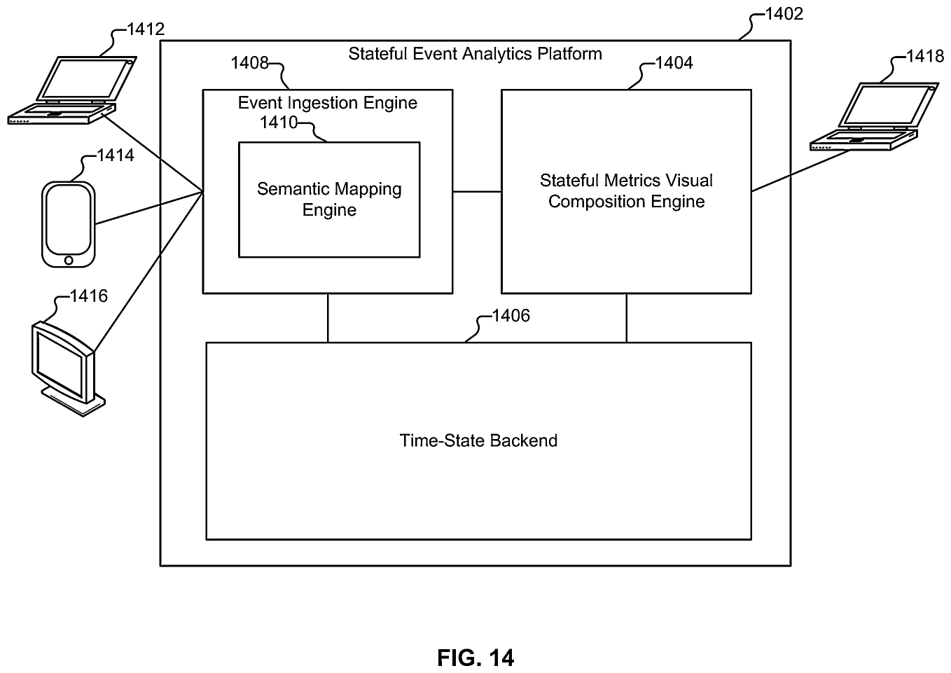

FIG. 14 illustrates an embodiment of a stateful event analytics platform. In some embodiments, stateful event analytics platform 1402 is configured to facilitate stateful metrics composition. In some embodiments, stateful event analytics platform 1402 is an alternative view of time-state analytics platform 200.

In this example, stateful event analytics platform 1402 includes stateful metrics visual composition engine 1404, time-state backend 1406 (also referred to herein as a timeline backend), and event ingestion engine 1408.

In some embodiments, event ingestion engine 1408 is an embodiment of sensor feed ingestion engine 202. In some embodiments, the event ingestion engine is configured to ingest feeds or streams of sensor data from client devices such as client devices 1412, 1414, and 1416. In the example of video streaming, content players on various client devices (e.g., laptops, mobile phones, tablets, desktops, set-top boxes, game consoles, smart TVs, etc.) are configured to stream sensor data (collected by the content player for a video streaming session) to event ingestion engine 1408. For example, various event data or values measured by the content player are transmitted in messages (also referred to herein as “heartbeat” messages) that are transmitted to event ingestion engine 1408 over a network such as the Internet.

In this example, event ingestion engine 1408 further includes semantic mapping engine 1410. Suppose a raw data set that is ingested. The raw data set may have numerous fields, heartbeat messages, events, etc. The semantic mapping engine is configured to facilitate identifying what raw data is significant, and map it to logic. For example, there is a diversity of devices that may send raw data in different formats and versions, with different naming conventions, tags, etc. Different versions of a device may even send the same type of data with variations in the way that they are reported. The semantic mapping engine is configured to facilitate identifying which events are of significance and the events that are semantically relevant. The semantic mapping engine is further configured to normalize such events. For example, consider page load events. Different mobile operating systems may report page load events differently. The semantic mapping engine is configured to canonicalize and normalize the raw events from the various disparate devices.

In various embodiments, the semantic mapping engine is configured to process raw data and create semantically rich, relevant information, including performing normalization across different diverse devices. For example, the semantic mapping engine takes as input raw data, and maps the raw data to semantically logical events. In some embodiments, when stateful metrics are built, they are programmed to refer to logical events, without requiring a configuration user to know the different underlying ways that page load events were formatted or tagged or otherwise reported from different devices. In some embodiments, the time-state backend obtains data according to logical events. In other embodiments, the stateful metrics composition and computation are specified with respect to raw events as well, or a mixture of raw and logical events.

In this way, the semantic mapping engine acts as a pre-processing layer, taking in raw, noisy data and performing cleaning of the raw data, and placing the raw data in a clean format for downstream consumption or use by other portions of the stateful event analytics platform, such as for stateful metrics composition, as well as time-state (e.g., timeline-based) computation. This allows configuration users to create stateful metrics logic using canonicalized, cleaned versions of event data, without having to deal with the disparate underlying raw data that may be difficult for a developer to parse and understand.

In some embodiments, time-state backend 1406 is an embodiment of time-state metrics system 300. In some embodiments, the time-state backend executes and computes stateful metrics that are provided to the backend as metrics configuration files. As one example, and as described in further detail above, a metric configuration specifies a stateful metric as a Directed Acyclic Graph (DAG) of timeline operators that operate on timelines, where a result of the stateful metric is computed by the time-state backend by applying the graph of the metric to an input dataset.

In some embodiments, the time-state backend is configured to compute stateful metrics on input datasets. For example, a stateful metric may be a session-level stateful metric that is computed on a per-session basis. The input dataset may include data corresponding to numerous sessions. The stateful metric may be used to compute individual session-level values for the stateful metric, which are then aggregated across sessions.

In some embodiments, stateful metrics visual composition engine 1404 is configured to facilitate visual composition of stateful metrics. For example, a developer (e.g., using developer client device 1418) utilizes a front end provided by visual composition engine 1404 to visually create and compose stateful metrics.

In some embodiments, the stateful metrics visual composition engine utilizes mapped logical events generated by the semantic mapping engine. The stateful metrics visual composition engine can also be specified using raw events, or other logical events.

In this example, the stateful metrics visual composition engine is also configured to leverage the time-state timeline representation (embodiments of which are described in further detail above), as well as the time-state backend 1406 to facilitate visual composition of stateful metrics. In some embodiments, facilitating visual composition of stateful metrics includes providing a visual or graphical user interface via which stateful metrics can be composed.

It would be challenging to build such a visual composition system on top of a tabular environment. In the stateful visual composition techniques described herein, embodiments of the time-state representation described above, as well as embodiments of the framework for time-state computation described above are leveraged to support the class of stateful metrics. The timeline representation and timeline algebra described above support the geometric visual composition system described herein, by providing a geometric basis for visualizing data as timelines, and for visualizing stateful metrics as graphs of timeline operations. In some embodiments, the efficiency of the timeline backend framework described herein also facilitates real-time interactive debugging to visualize timelines for individual nodes, immediately, as soon as the user adds them to the current DAG.

In some embodiments, stateful metrics visual composition engine 1404 provides a no-code visual programming platform for quickly and efficiently creating stateful metrics. As will be described in further detail below, embodiments of the techniques for visual programming for stateful analytics described herein include providing a node-graph editor, interactive tooltips with animation, embedded data views, and auto-suggestion capabilities to facilitate metrics creation and validation.

Existing techniques for visual programming are ill-equipped to handle the temporality and stateful characteristics of stateful metrics, which involve operating logic on sequences of events over time. For example, when creating stateful analytics, it would be beneficial to view a sequence of events over time, the state of the metric and/or events over time, etc. For example, with stateful analytics, there is a time granularity to how events are mapped, how events are changing over time, how values are changing over time, etc. which is challenging to express visually with existing visual programming techniques.

The following are embodiments of visual programming for stateful analytics. As described above, in some embodiments, the techniques for visual programming for stateful analytics leverage embodiments of the timeline framework for time-state analytics described above, such as timeline representations, timeline operators, etc.

In some embodiments, providing a visual programming interface for stateful analytics includes providing explanatory interfaces for educating users about timelines and timeline operators. For example, timeline operators have stateful, time-state semantics. In some embodiments, explanations of the logic of timeline operators is visually provided, such as in the form of tooltips, animations, etc. For example, animations are provided to visually represent the logic of a timeline operator to facilitate onboarding of new users.

In some embodiments, providing a visual programming interface for stateful analytics includes providing an interactive composition interface in which real-time (or near real-time) feedback is provided to the user as they visually construct a stateful metric.

Stateful metrics can involve complex logic with multiple steps, where sub-logic of one part of a metric may rely on the results of another part of the metric. In existing coding techniques, users often write the entire metric before being able to test whether the metric is correct or incorrect. If the metric is generating incorrect results, it can be challenging for the user to determine what part of their logic should be changed or fixed. The interactive stateful metric composition interface described herein addresses such issues. For example, the interactive composition interface described herein provides interactive, real-time feedback as a user constructs or develops a stateful metric.

For example, as described above, stateful metrics can be made up of multiple timeline operators that are connected from one to the other in a particular manner (which can be expressed via a directed acyclic graph representation). In some embodiments, via the visual stateful metrics composition interface described herein, users can construct stateful metrics by manipulating graphical elements corresponding to timeline operators. As one example, via embodiments of the composition interface described herein, a developer can visually create a graph representation of a stateful metric that is a visual representation, for example, of the example underlying DAG data structure shown in FIG. 7.

The following are further embodiments of an interactive visual composition and programming system for creating and validating stateful metrics. Embodiments of the interactive stateful analytics composition system described herein provide a no-code platform for stateful analytics. As will be described in further detail below, embodiments of the interactive composition system described herein provide a visual programming frontend that allows users to, for example, drag and drop, and then connect operators to create stateful metrics in the form of directed acyclic graphs (DAGs) (corresponding at least in part to the underlying structure of stateful metrics used in computation). Further details regarding graph representations of stateful metrics are described above. The interactive composition system described herein further utilizes a performant time-state backend (e.g., time-state metrics system 300, further details of which are described above) that is configured to compute complex stateful metrics in both batch file and streaming modes.

### Node-Graph Editor

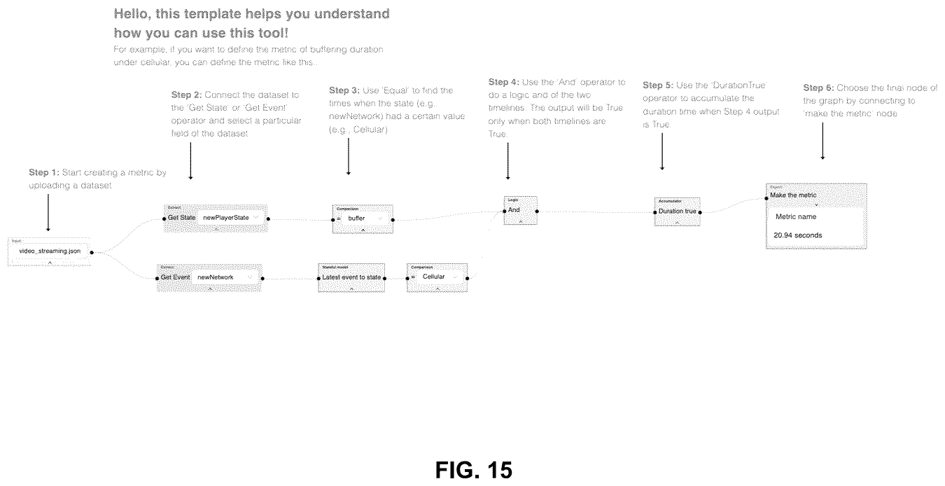

FIG. 15 illustrates an embodiment of a metric template. In some embodiments, the visual stateful metrics interface is a node-graph editor. The node-graph editor assists users to rapidly create stateful metrics in a visual programming environment.

The following are example steps of composing a graph of a stateful metric:
adding a node of a dataset
interpreting the fields as discrete events or states over time
transforming the data—e.g., equals, greater than, AND, duration true, etc.
exporting the metric

Using the node-graph editor, users can draw DAGs to specify the logic of their stateful metric, where the drawn DAG and visual programming constructs (e.g., nodes and timeline operators of DAG) map or correspond to the manner in which the stateful metrics are configured internally for execution in the underlying timeline framework described herein.

In some embodiments, the metric template of FIG. 15 provides developers an overview of the metric creation process. In some embodiments, the metric template is a starting page of the editor canvas when a developer (e.g., developer 1418) first opens the metrics composer. In some embodiments, to create a new metric, users can either directly modify the metric template or create a new metric from scratch.

In this example, and as will be described in further detail below, the metric template illustrates to the user a visual representation of the node-graph structure of a metric. As will be described in further detail below, the node-graph editor allows users to construct a stateful metric by selecting, placing, and connecting nodes/operators from a nodes/operators library. For example, users can drag nodes/operators from the library, and then connect nodes by dragging a line between their connectors (e.g., dots on the node edges).

In some embodiments, as the user connects timeline operator representations together, the interactive composition interface provides real-time feedback of what the output (timeline) of such an arrangement of timeline operator representations would result in. Intermediate output of any node in the graph can be provided. This feedback is provided as the user develops their metric (not necessarily waiting until the user has completed the metric). For example, suppose a user is starting out developing the initial stages of their stateful metric logic, and manipulates a representation of a timeline operator B to follow a representation of a timeline operator A. In some embodiments, the composition interface provides a visual representation of an example output timeline of this arrangement of timeline operators.

As another example, suppose the user includes a Boolean timeline operator that takes as input a timeline of numerical values, and outputs a timeline of Boolean values (True or False), depending on whether input values are greater than a threshold value (as specified in the Boolean timeline operator). In some embodiments, responsive to the user including such a Boolean timeline operator, the composition interface provides real-time feedback to the user by presenting an example output Boolean timeline. In this way, the user is provided visual feedback as they develop their metric, allowing them to see, as they construct their stateful metric, whether the stateful metric so far is behaving in the desired manner. Put another way, immediate visual feedback is provided to indicate, when a timeline operation is performed, how the operation processes and changes data. In this way, the composition interface provides an intuitive representation of what occurs as the user composes various different timeline operations together. This allows the user, as they build their stateful metric, to visually see feedback of what the timeline operation does. In this way, over the course of constructing their stateful metric, as the user develops the stateful metric (e.g., adding timeline operators, removing timeline operators, changing how timeline operators connect to each other, or otherwise modifying or editing their stateful metric), the composition interface provides real-time visual feedback on the state of the development of their stateful metric, such as visual representations of example outputs of the various timeline operators included in the stateful metric so far (given some sample input data, for example). This provides the user an intuitive representation of what is occurring as they compose different timeline operations.

In some embodiments, and as will be described in further detail below, the stateful metrics visual composition interface described herein further provides automatic suggestions and recommendations of next timeline operators that can be applied. For example, as described above, one example representation of a stateful metric is a graph (DAG) of timeline operators. In some embodiments, and as will be described in further detail below, as the user develops their stateful metric, a graph representation of the stateful metric is also updated. In some embodiments, based on the logic and semantics of the current stateful metric graph, the composition system described herein automatically suggests a next set of candidate operators that are applicable. For example, rather than presenting all possible timeline operators for selection, the system determines, based on where the user would like to add or connect a next operator in the current graph representation of their stateful metric, what subset of timeline operators are applicable at that point in the stateful metric graph representation. As one example, suppose that the output of a node in the graph is a Boolean timeline. Based on the type of output being Boolean values, the next set of applicable operators is automatically suggested to be limited to those timeline operators that can take as input timelines with Boolean-type values. Such automated suggestion of timeline operators reduces the barrier for users in developing their stateful metric.

The following is an example of visual composition of a stateful metric. In some embodiments, the graphical composition user interfaces described herein are provided by stateful metrics visual composition engine 1404. In this example, suppose that an analytics developer uses their device 1418 to access the stateful metrics visual composition engine 1404 to compose a stateful metric.

In some embodiments, the developer selects an input data set. In some embodiments, the input dataset is the dataset to which the stateful metric will be applied. In some embodiments, stateful metrics are composed based on the input data set. For example, different datasets may have different fields with various data types, and the stateful metric is composed given the schema of the input data set.

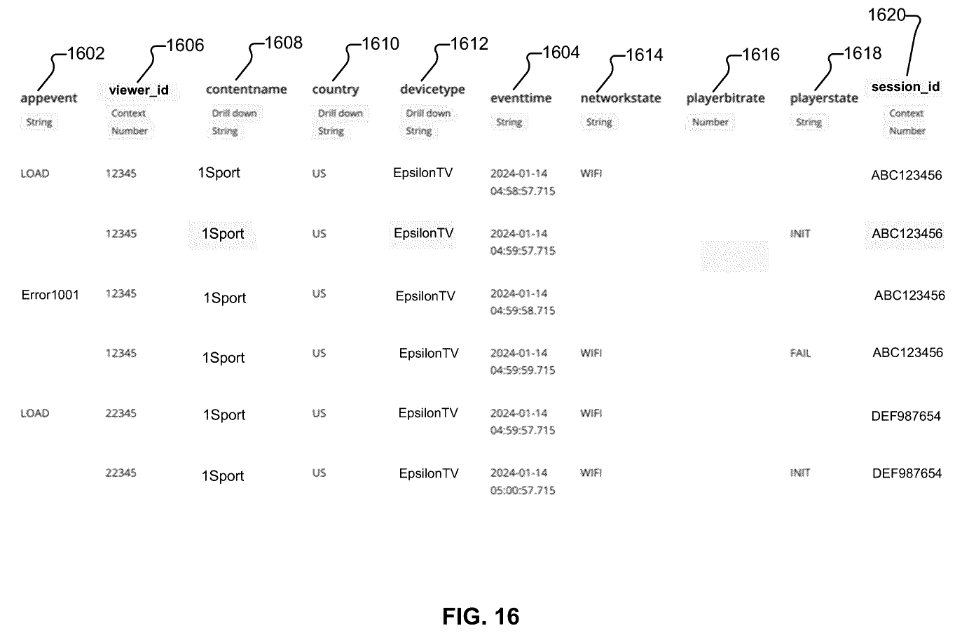

FIG. 16 illustrates an example of a source data set. In this example, a set of timestamped events is shown. In the example of FIG. 16, various events reported by a content player of a video streaming device are shown. For example, data in a table structure or tabular format is shown, where each row corresponds to a reported event. Each reported event is associated with a timestamp (as shown in eventtime column 1604) Each reported event may also include further information such as viewer identifier (1606), content name (1608), country (1610), device type (1612), and session identifier (1620), as well as indications of different types of events that have occurred, such as app events (1602), current network state (1614) (e.g., WiFi or Cellular), current player bitrate (1616), current player state (1618) (e.g., initialization or fail), etc.

As one example, the data set shown in FIG. 16 is an output of semantic mapping engine 1410. For example, there may be various different devices that have sent network state, player state, and player bitrate in various, disparate languages. For example, bitrate may be referred to as “BR” in the raw data of one type of device, while another type of device refers to bitrate as “player quality” in its raw data. In some embodiments, the semantic mapping engine canonicalizes, normalizes, and cleans up the raw data into logical relevant events. Stateful metrics can then be built from the canonicalized logical events that the raw events have been mapped to. For example, node setting specifications, further examples and details of which are described below, can be based on the names of mapped events and/or raw events. Stateful metrics can also be built from the raw event data.

The following are examples and embodiments of stateful metrics visual composition interfaces provided by the visual stateful metrics composition techniques described herein.

As will be described in further detail below, embodiments of the interactive visual composition system described herein provide a “drag and drop” composition interface for users to create custom stateful metrics on their datasets. In some embodiments, stateful metrics are created by chaining together different timeline operators as a directed acyclic graph (DAG). In some embodiments, to facilitate such visual composition, operators or building blocks are exposed, user-friendly interaction for chaining together operators is facilitated, and visual cues and hints to the users as they build the metric to validate their semantic intents are provided.

As will be shown in the example user interfaces described below, in one example implementation, the composition user interfaces include three coordinated panels: (1) node/operator library, (2) node-graph editor, and (3) node setting specification.

### Dataset Preview

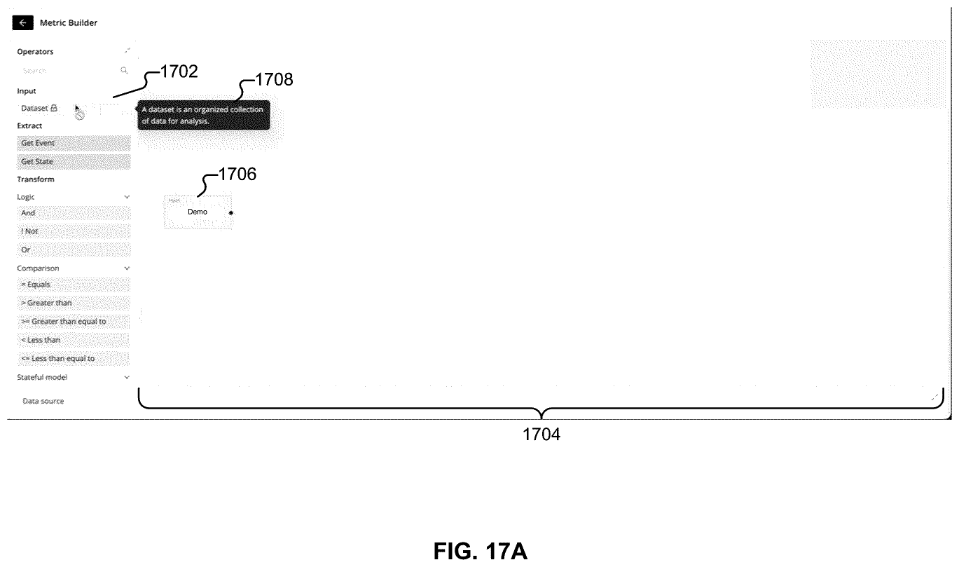

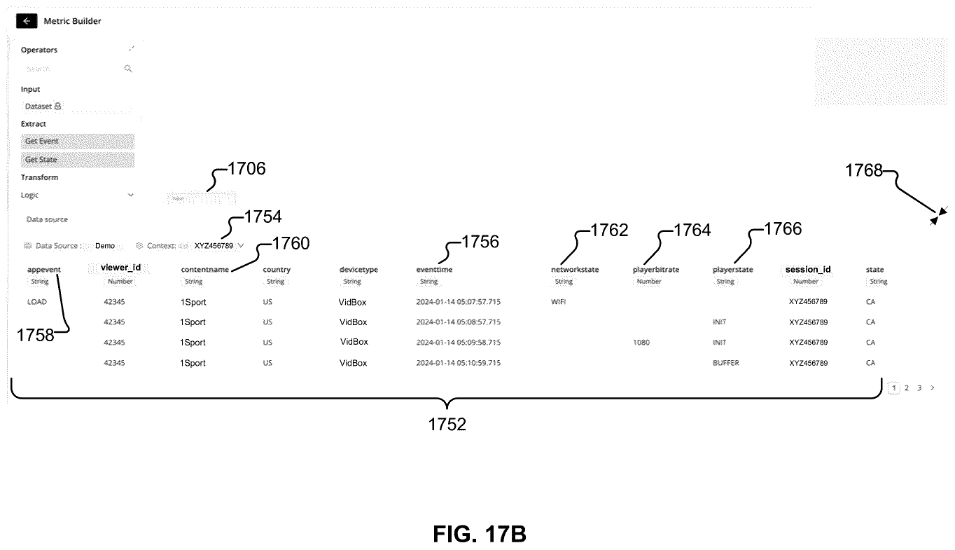

Suppose that the developer would like to build a new metric to process data such as that shown in the source input data set of FIG. 16. FIG. 17A illustrates an embodiment of selecting an input data set. In some embodiments, metrics creation begins with dragging a dataset operator into the editor canvas. The developer also selects an input dataset to ingest into the system.

In this example, the developer has dragged the dataset label representation 1702 to the editor canvas 1704, thereby adding the operator as a starting node for the stateful metric. The input dataset is represented graphically in the canvas as node 1706. In this example, the dataset of FIG. 16 (named “Demo” in this example) has been selected as the input dataset for the stateful metric being composed. In this example, an explanation of a dataset (that it is an organized collection of data for analysis) is also shown at 1708. In this example, the demo dataset is represented as an initial node in the stateful metric graph being constructed.

The developer may not be familiar with the dataset. In some embodiments, to facilitate efficient understanding of the input data set, the composition engine provides a dataset preview interface for viewing the contents of the input dataset.

FIG. 17B illustrates an embodiment of a dataset preview. In this example, a dataset preview of the “Demo” dataset 1706 is shown at 1752. In this example, the developer can select a particular session in the data source to view. For example, at 1754, the developer has selected a session “XYZ456789.” Various timestamped logical event information/data relevant to the selected session is shown in the dataset preview interface. Timestamps for the events are shown at 1756. In this example, for a particular viewer's data, the data shows various events, such as app events (1758), the name of the content (1760), network state (1762), player bitrate (1764), player states (1766), etc. The presentation of portions of the source data is a form of visual feedback that allows the developer to understand the schema of the data that they are building stateful analytics and metrics for. For example, the developer is able to view the various types of events (as well as their value types, such as string, number, Boolean, etc.) that they are able to operate on.

In this example, the dataset preview is embedded within the editor canvas. In some embodiments, the preview of the dataset is available after it is uploaded. The developer can display/hide the preview as desired by interacting with element 1768 of the dataset preview. With the input dataset/source selected, the developer can then select the operator logic to be applied, as well as specify what fields in the selected dataset are of interest for the stateful metric being composed.

In some embodiments, to facilitate and aid creation of the stateful metric, a selection of an exemplar data is specified as context for providing, to the user, example outputs of the stateful metric when applied to the exemplar data. Having an exemplar data in a particular context (e.g., for a specific example session such as session 1754) allows the developer to determine whether the stateful metric they are composing is behaving in the manner desired, such as by allowing them to preview how their chain of operators is manipulating example input data.

Operator Library and Tooltips with Animations

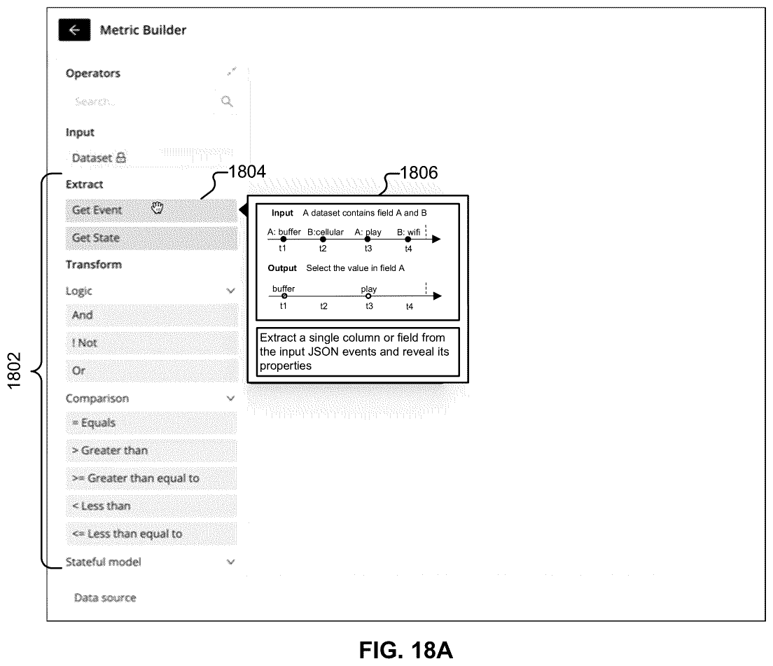

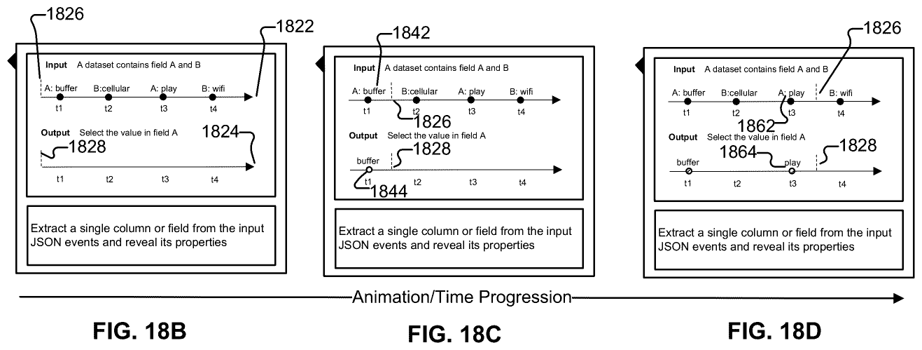

FIG. 18A illustrates an embodiment of an operator tooltip. At 1802 is shown a portion of a library of various nodes/operators that can be included in the stateful metric node-graph. The library of nodes includes various timeline operators that are available to the developer in constructing their stateful metric. In some embodiments, the available timeline operators are included in a timeline operator library (e.g., operator library 308). In some embodiments, the selectable timeline operators include composite operators created from timeline operator primitives. As shown in this example, the different available operators are organized or bucketed by type, such as extraction operators, transform operators, comparison operators, etc.

As shown in this example, the node/operator library panel 1802 lists a set of timeline operators (embodiments of which are described in further detail above). The operator library provides building blocks that users can compose to express stateful metrics. In this example, the stateful metrics are expressed in the form of a directed acyclic graph (DAG).

In the example nodes library panel, operators are grouped into different categories based on their logical function in the DAG creation workflow. Such grouping provides ease of navigation. In some embodiments, the operators are grouped into domain-specific groups, such as for different industries using stateful analytics (e.g., operators specific to, or adapted for, fitness, IoT monitoring, cybersecurity monitoring, etc.). The following are example categories of operators:
Input Category: In some embodiments, by using dataset operators (e.g., dataset operator 1702), users can choose the input dataset file they wish to analyze. Input dataset files of various formats (e.g., JSON (JavaScript Object Notation) format, CSV (comma-separated values), etc.) are supported.
Extract Category: In some embodiments the operator library includes operators for extracting a timeline out of the input dataset file. For example, an extraction operator converts collected raw event data into a timeline data representation. As one example, extraction operators include operators that convert event stream data in a tabular format into logical timelines that include spans. As will be shown in the examples below, “Get Event” and “Get State” are two example operators for performing such extraction of a timeline out of an input dataset file. In some embodiments, the extraction includes specifying a name of a data field in the input dataset to be extracted and converted into a timeline format. In some embodiments, such extraction operators should be connected to the dataset operator (e.g., dataset operator 1702). In some embodiments, the “Get Event” operator outputs an event timeline. In some embodiments, the “Get State” operator outputs a state timeline.

In some embodiments, given a set of (time, fieldname, value time) measurement entries in the input dataset file (one example fieldname is PlayerState, where “buffer” is an example of the valueₜᵢₘₑ, as shown at 1766), the “Get Event” operator visualizes each valueₜᵢₘₑ as a discrete event occurring at time time with the associated fieldname.

In some embodiments, the “Get State” operator alternatively interprets each measurement entry (time, fieldname, valueₜᵢₘₑ) as a logical state transition event in a finite state machine, and visualizes the fieldname as a step function over time, where, as one example, the value of the step function on the Y-axis is set to the valueₜᵢₘₑ until the next measurement reported for that fieldname.

### Transform Category

The following are example groupings of operators that perform transformations on timelines.
Logical Operator Group: In some embodiments, this group of operators handles logic operations. For example, AND (&) and OR (|) operators perform logical operations. The NOT operator flips a Boolean value. In some embodiments, for such logic operators, the value type (e.g., type of values that are included in a timeline) of the input timelines (that are provided as inputs to the operators) are required to be Boolean, where the value type of the output timelines is also Boolean.
Arithmetic Operator Group: In some embodiments, this group of operators performs arithmetic operations: Add (+), Subtract (−), Multiply (x), Divide (/). In some embodiments, the value type of the input timelines and the output timelines for these operators is number (e.g., numerical type values, such as integers).
Comparison Operator Group: In some embodiments, this operator group performs comparison operations: GreaterThan (>), GreaterThanOrEqualTo (≥), LessThan (<), LessThanOrEqualTo (≤). In some embodiments, the value type of the input timelines for these four example operators is required to be of type number.

In some embodiments, the Equal (=) operator permits or accepts other value types for the input timelines other than number, such as string (e.g., for string value equality comparison). In some embodiments, the equal operator can allow the input timelines to be of any value type.

In some embodiments, the value type of the output timelines for the above example comparison operators is Boolean.
Stateful Model Operator Group: In some embodiments, this operator group performs stateful operations. For example, the HasBeenTrue operator receives an input timeline of Boolean value type and outputs a state timeline of Boolean value type (state-type timeline whose values are of type Boolean). In some embodiments, the output timeline is false until it sees the first true value. Afterwards, it remains true. In some embodiments, LatestEventToState is an operator that converts an event timeline into a state timeline.
Accumulation Operator Group: In some embodiments, a DurationTrue operator receives a state timeline of Boolean value type as input, and outputs a state timeline of number value type. In some embodiments, the output number value indicates the total duration (e.g., in seconds, or any other unit of time as appropriate) while the input state timeline is in the true state.

As exemplified above, timelines may be characterized according to two type-dimensions: timeline type, and value type. Timeline type indicates the type of the timeline (e.g., event timeline, state timeline, or numerical timeline with continuously changing values). Value type indicates the type of the values that are included in the timeline (e.g., string, Boolean, number, etc.). Different timelines may be of various combinations of timeline type and value type. For example, one event timeline can have Boolean type values, while another timeline that is also an event-type timeline can have string value types. Operators take data as input, apply a transform, and provide transformed data as output. As shown above, some operators take timelines as input, and produce timelines as outputs. In some embodiments, the configuration of an operator includes a specification of allowed or permitted timeline types/value types for input timelines and output timelines. As will be described in further detail below, such a type system for timelines can be used to govern the chaining of operators (e.g., what next operators are permitted or prohibited to connect to a current operator).
Export Category: In some embodiments, a MakeMetric (also referred to herein as a “Make the Metric” operator) is attached to the final node of interest in the DAG of the metric so that the system will use the output of the specified node to create the metric. Via the make the metric operator, a user can specify a name for the metric, an aggregation type, etc.

Continuing with the example of FIG. 18A, suppose the developer would like to learn about the extraction operator, “Get Event.” In some embodiments, to facilitate user understanding of operators, the composition engine provides operator tooltips. In some embodiments, when a user or developer mouses over an operator, either in the nodes library (left panel) or in the editor canvas (center panel), a tooltip UI (user interface) element is popped up or otherwise presented. As will be described in further detail below, the tooltip assists users in better understanding operators, such as their semantics, aiding users in using operators to create stateful metrics in a visual programming interface rather than writing code.

In this example, the developer hovers or mouses over the visual label representation of the “Get Event” operator, as shown at 1804. In response to the developer's hovering, a corresponding operator tooltip 1806 is presented.

In some embodiments, the operator tooltip presents explanatory information that explains the function of the selected operator. For example, the tooltip includes a textual explanation of the operator semantics. In this example, tooltip 1806 explains, via a presented text description, that the “Get Event” operator is configured to extract a single column or field from the input events (which in this example are JSON events, for illustrative purposes), and reveals its properties.

In some embodiments, the operator tooltip includes a dynamic animation. In some embodiments, the animation illustrates the time-elapsed aspect of stateful operators. In some embodiments, the animation directly shows how a timeline object changes its value as time changes. The animation displays what the particular operator will perform if given input data.

In some embodiments, the “Get Event” operator is configured to output each measurement entry (time, fieldname, valueₜᵢₘₑ) as a discrete event occurring at time time (visualized, for example, as a dot).

FIGS. 18B-18D illustrate an embodiment of a tooltip animation. In this example, the animation illustrates, within tooltip 1806, applying of the “Get Event” operator with field A (e.g., selecting the value in field A of an input dataset, which has the value buffer at time t1, and a different value of play at time t3). In this example, three points in the progression of the animation are shown.

FIG. 18B illustrates animation of a stateful operator at an initial or starting time. As shown in the example tooltip of FIG. 18B, an example input dataset to the “Get Event” operator is shown at 1822. In this example, the input is a dataset that contains fields A and B, with the values of the fields at various points in time (t1, t2, t3, and t4 in this example) also shown. As part of the animation, the output of applying the “Get Event” operator over time (until t4) is shown at 1824.

In this example, as shown at FIG. 18B, the animation starts from an initial stage, or time t0. In this example, time markers 1826 and 1828 are markers for the input and output timelines, respectively, that indicate where in time the animation is currently. In this example, the movement of time markers 1826 and 1828 is synchronized such that they proceed together forward through time. In this example, at time t0, the “Get Event” operator is yet to be applied, and there is no output yet.

FIG. 18C illustrates animation of a stateful operator at an intermediate time. In this example, time has progressed to be between t1 and t2, as indicated by markers 1826 and 1828 now being between times t1 and t2. At t1, the value for field A is buffer (as shown at 1842). As the “Get Event” operator is to select the value in field A, the buffer value for field A is recorded at time t1 in the output timeline, as shown at 1844.

FIG. 18D illustrates animation of a stateful operator at an intermediate time. In this example, time has progressed further to now be between t3 and t4, as indicated by markers 1826 and 1828 now being between times t3 and t4. At t3, the value for field A is play (as shown at 1862). As the “Get Event” operator is to select the value in field A, the play value for field A is recorded at time t3 in the output event timeline, as shown at 1864. Note that in this example, the “Get Event” operator is configured to select values in Field A. Because of this, the values of field B (e.g., at time t2) are not recorded in the output timeline. In some embodiments, the animation continues to proceed past time t4 (where the WiFi value of field B will not be included in the example output timeline). In some embodiments, the animation repeats (starting from the beginning of the input data set and output timeline upon reaching the end of the timelines).

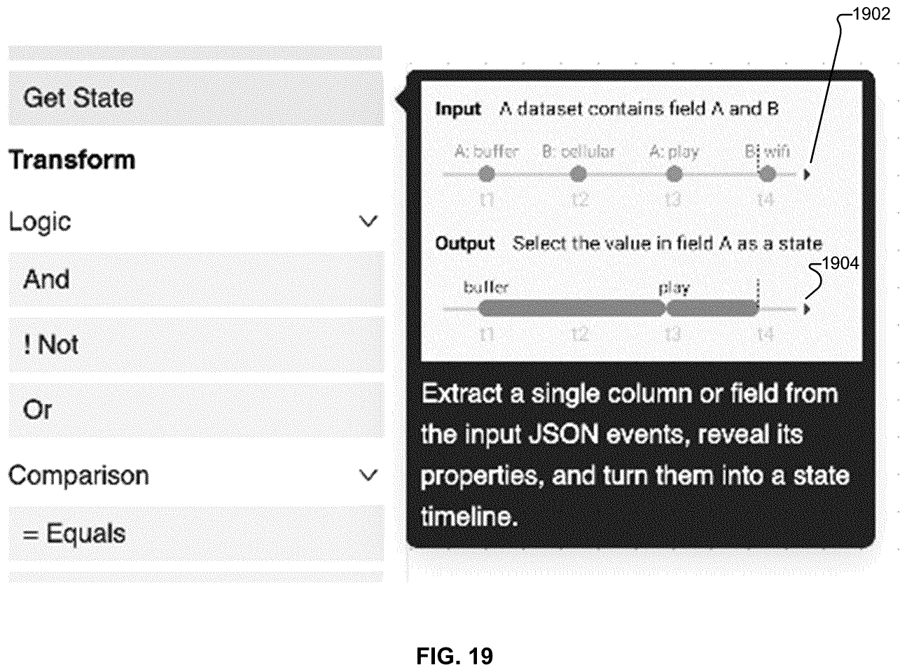

FIG. 19 illustrates an embodiment of an operator tooltip. In this example, an operator tooltip for the “Get State” operator is shown. In some embodiments, a dynamic animation is presented within the tooltip that illustrates applying the “Get State” operator with field A (from visualization 1902 of the input)—that is, the continuous value over time for field A (where field A has the value buffer from t1 to t3 and a different value of play from time t3 to t4, as shown in the visual representation 1904 of the output timeline that is produced). In some embodiments, the “Get State” operator is configured to output each measurement entry as a logical state transition event (visualized, for example, as a line).

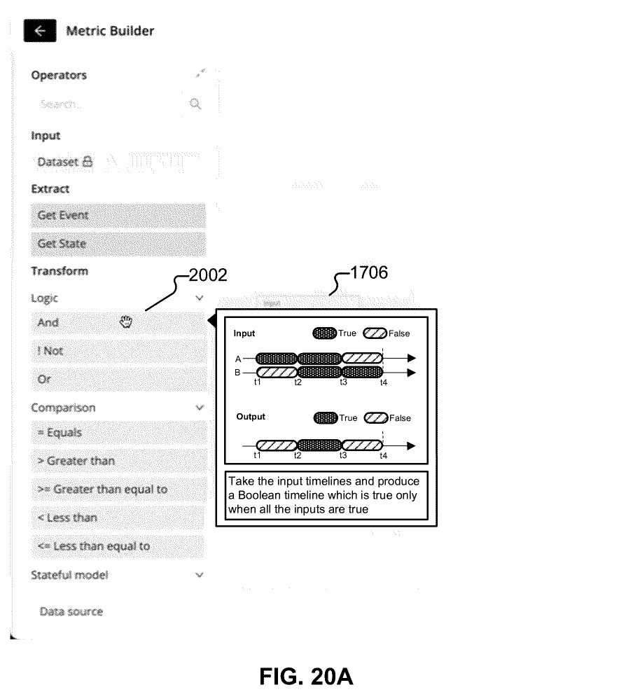

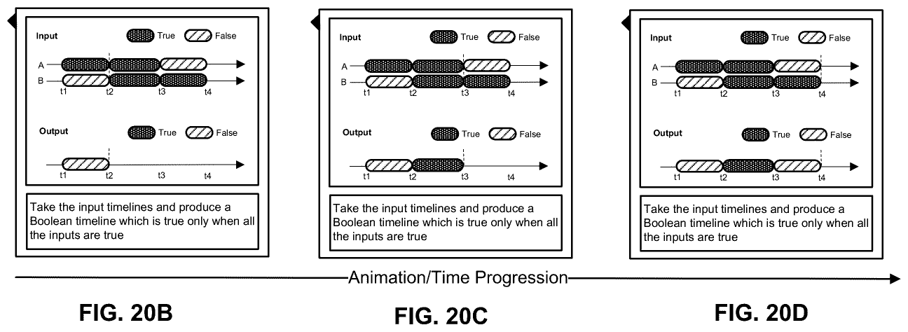

FIG. 20A illustrates an embodiment of an operator tooltip. In this example, suppose the developer would like to explore and learn further about the logical transformation operator, “AND,” and hovers over the label representation of the AND operator at 2002. In this example, the tooltip presents an example animation of applying the AND operator to two Boolean type input timelines, A and B. In this example, the output of the AND operator on the two inputs is also visualized.

FIGS. 20B-20D illustrate an example of an operator tooltip animation. In this example, an operator tooltip animation of the AND operator applied to two input Boolean timelines over time t1-t4 is shown. The output Boolean timeline as a result of applying the AND timeline operator to the two input timelines is also shown over time.

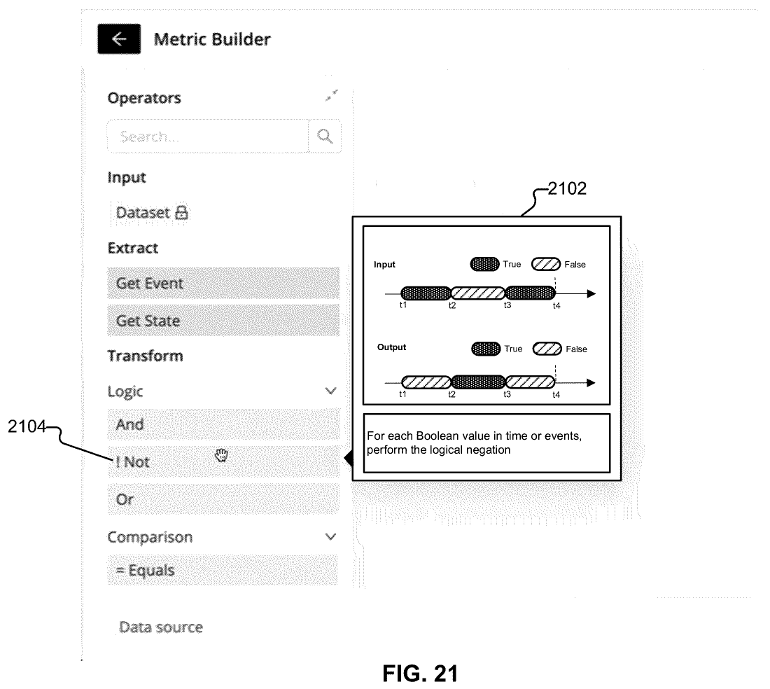

FIG. 21 illustrates an embodiment of an operator tooltip. In this example, an operator tooltip for the logical operator “NOT” is shown at 2102 in response to the developer hovering over “! Not” in the node operator library at 2104. In some embodiments, a tooltip animation is also presented that illustrates how the applying of the NOT operator results in an output Boolean timeline that is the logical negation of the Boolean values of the input Boolean timeline when moving from time t1 to time t4.

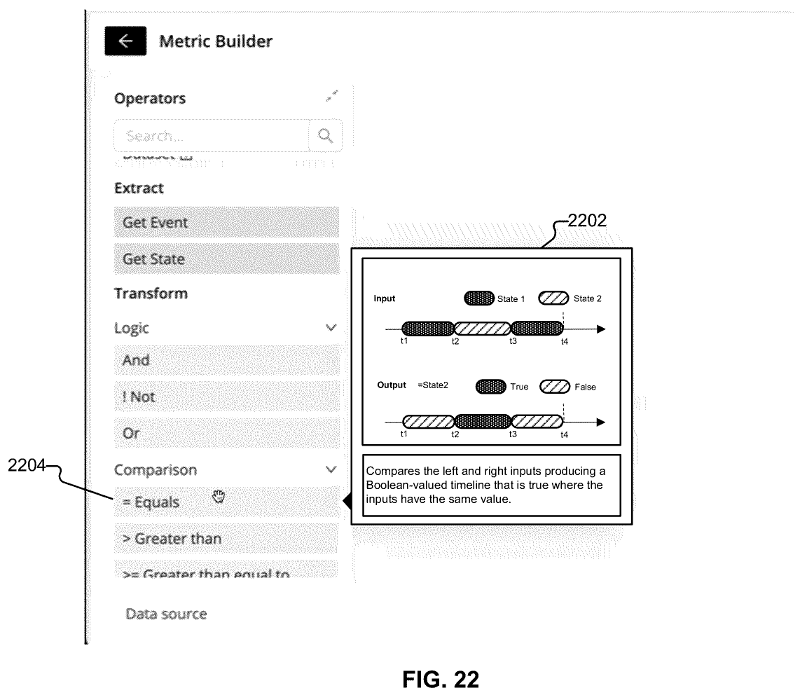

FIG. 22 illustrates an embodiment of an operator tooltip. In this example, a tooltip for an Equals comparison operator is shown at 2202 in response to the developer hovering over “=Equals” in the node operator library at 2204.

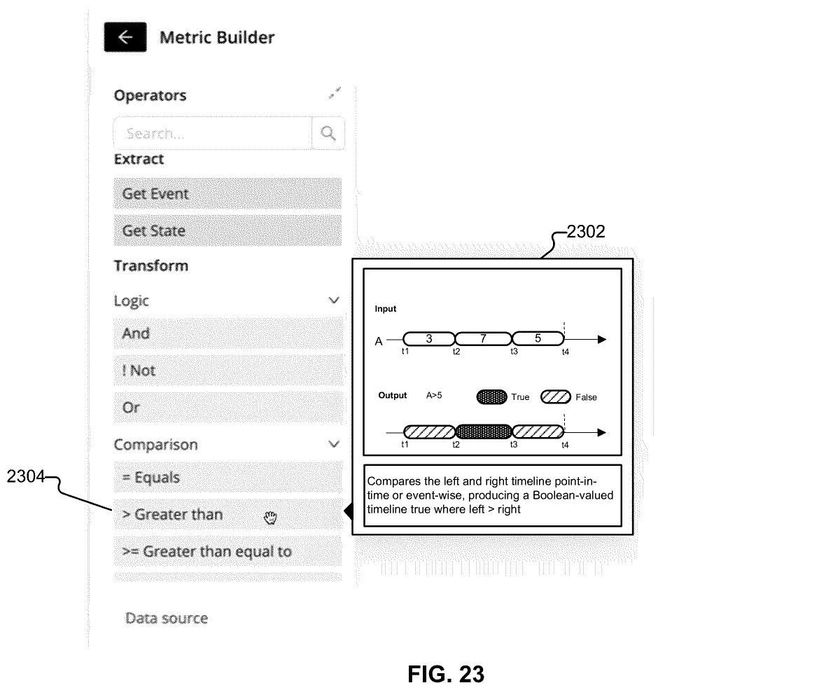

FIG. 23 illustrates an embodiment of an operator tooltip. In this example, a tooltip for a Greater Than comparison operator is shown at 2302 in response to the developer hovering over “>Greater than” in the node operator library at 2304. In this example, the operator takes as input a timeline of numerical-type values. The operator is configured to generate an output timeline of Boolean values, where the output Boolean value at a given point in time is true if the value in the input timeline at the corresponding time is greater than 5, and false if less than or equal to 5.

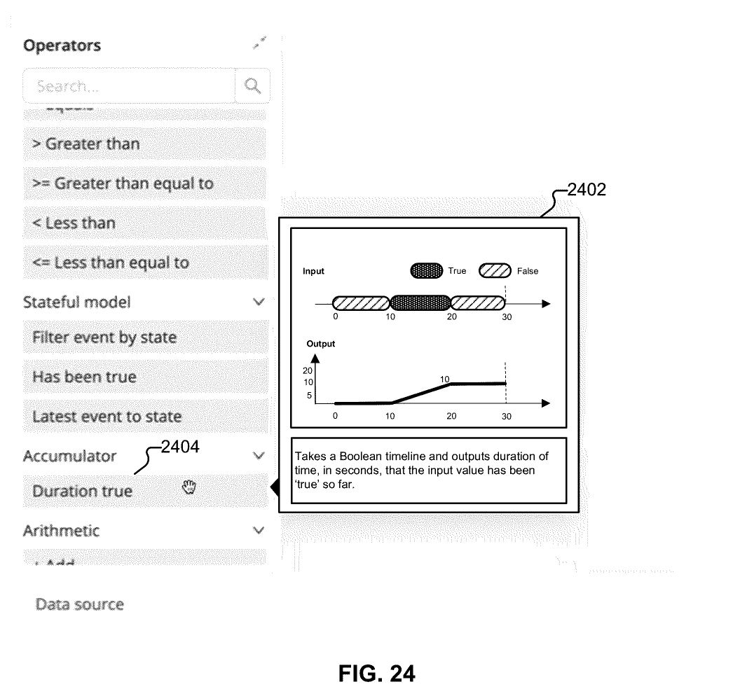

FIG. 24 illustrates an embodiment of an operator tooltip. In this example, a tooltip for a duration true operator is shown at 2402 in response to the developer hovering over “Duration True” in the node operator library at 2404. In this example, the duration true operator takes as input a Boolean timeline and outputs duration of time (e.g., in seconds) that the input value has been “true” so far. In some embodiments, a corresponding animation of the duration true operator is also shown.

As shown in the above examples, via the tooltips, the composition engine provides visualizations to a developer of what the various operators will logically do to the data. While visualizations for a subset of the nodes/operators in the library have been shown for illustrative purposes, visualizations and operator tooltips and animations can be presented for other types of operators as well.

Now that the developer has utilized the tooltips and animations to familiarize themselves with the various available operators, the developer begins drawing the graph of the stateful metric they are interested in composing. In this example, suppose that the developer would like to determine the amount of time spent buffering when using WiFi. The following are example stateful metric visual composition interfaces for constructing such a metric using the visual node-graph editor described herein.

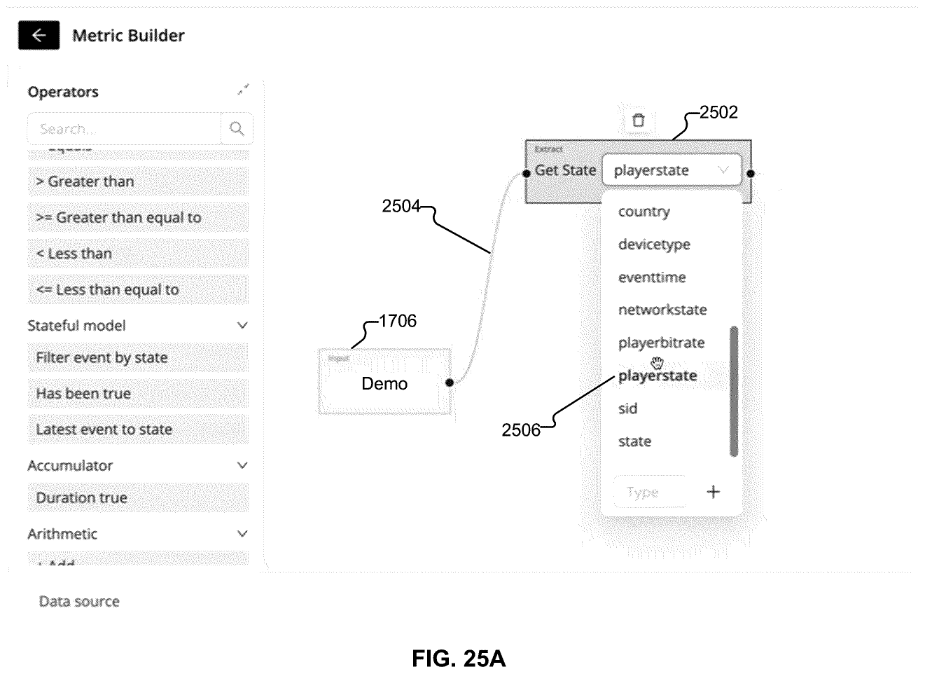

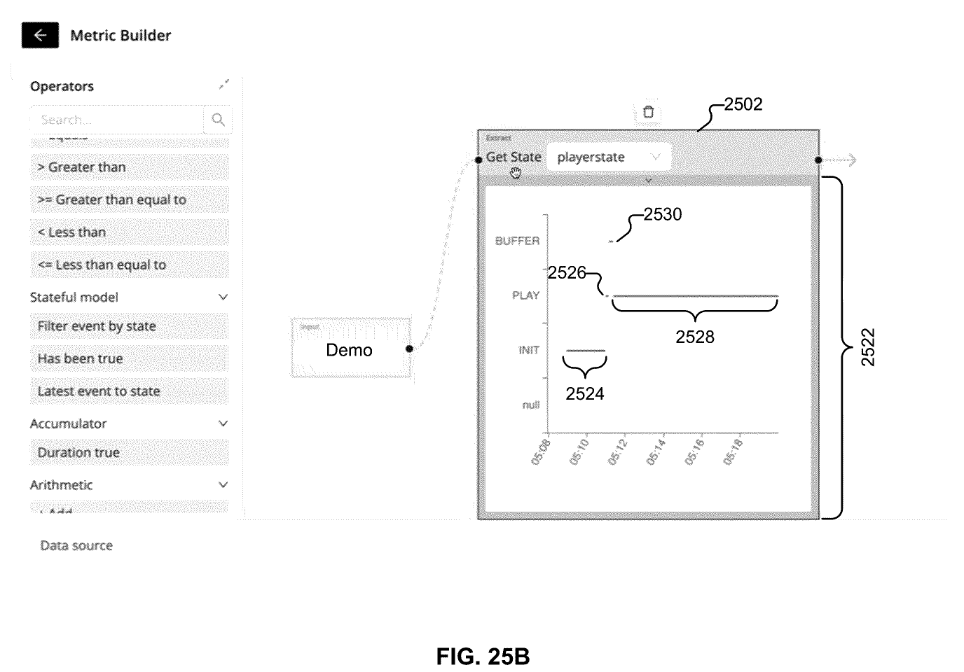

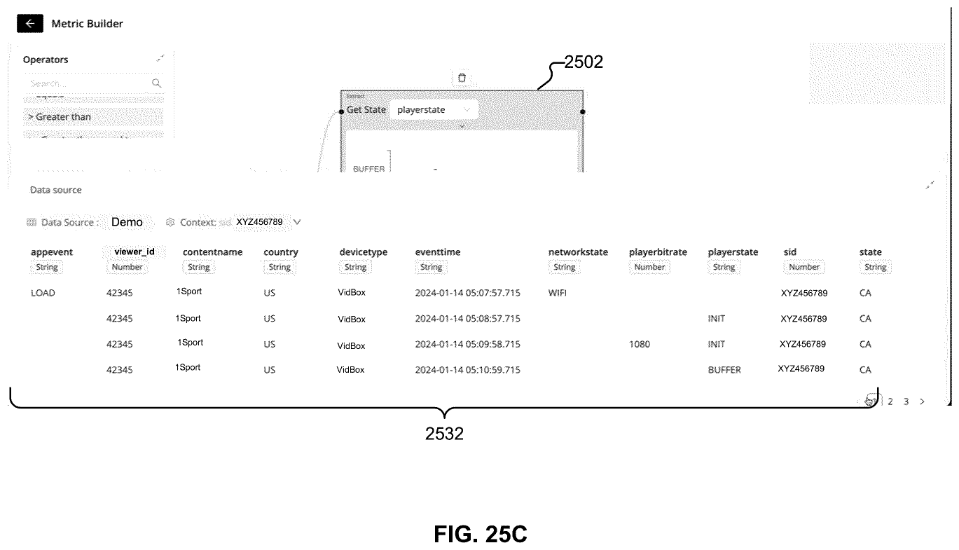

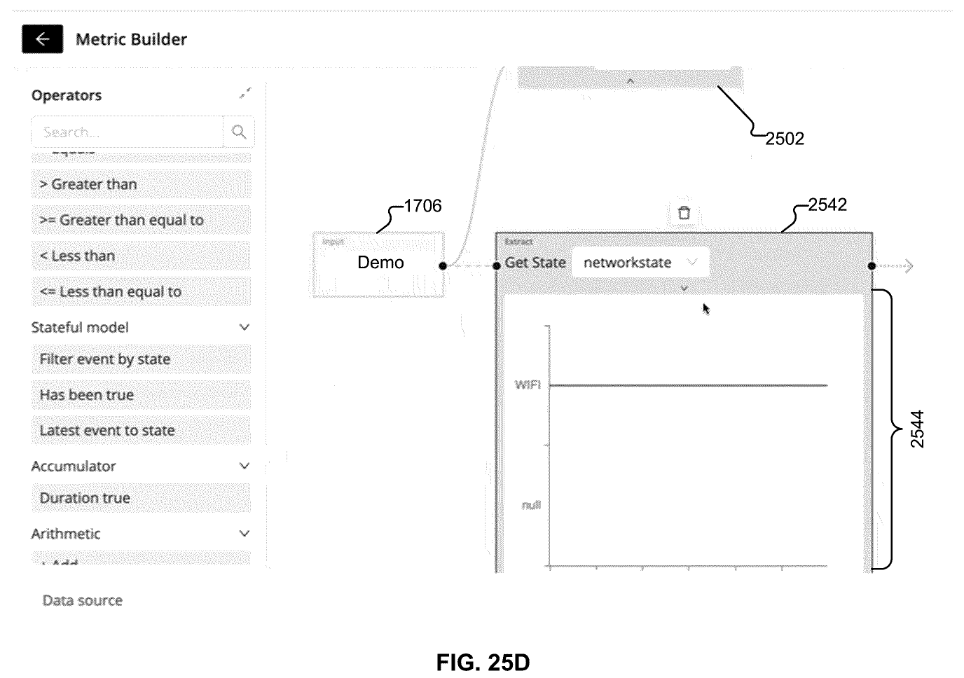

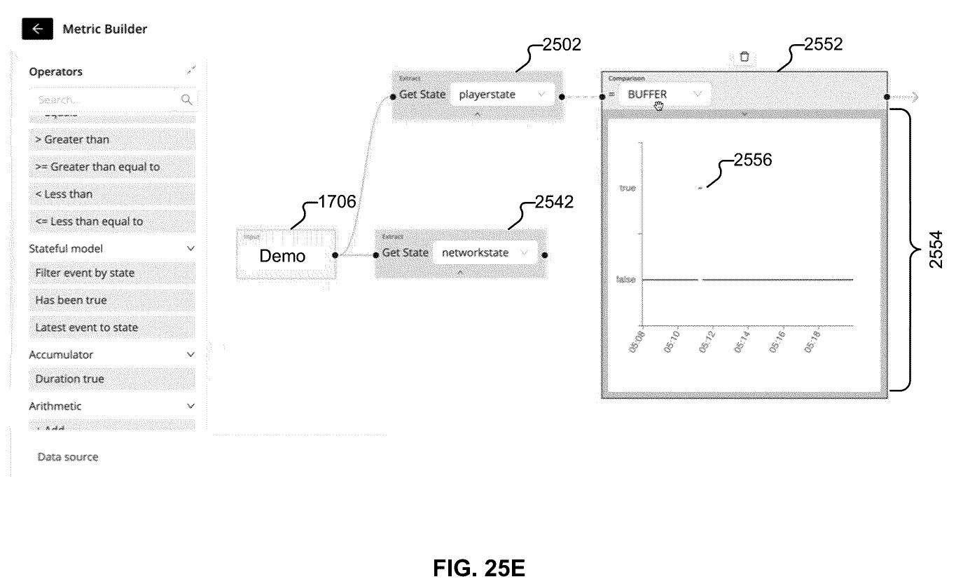

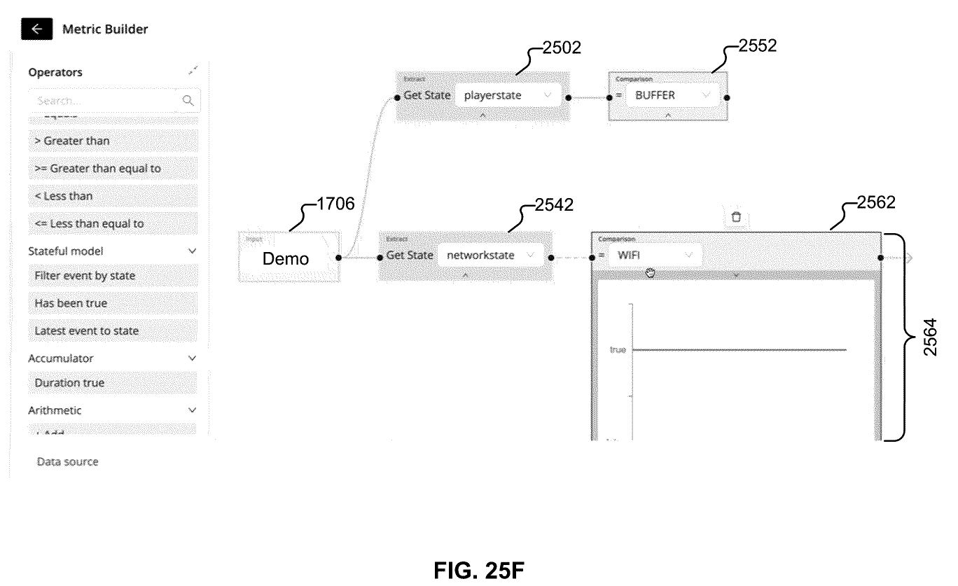

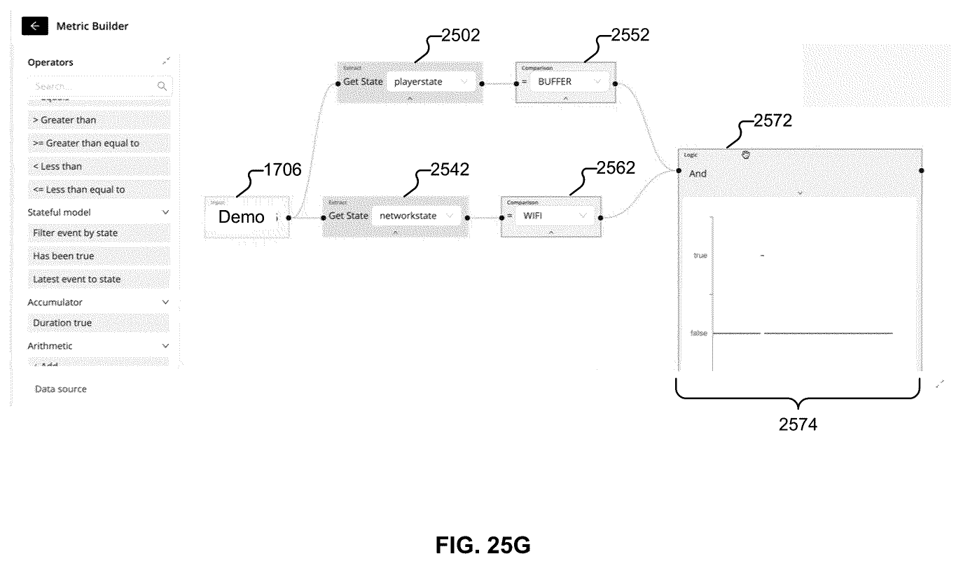

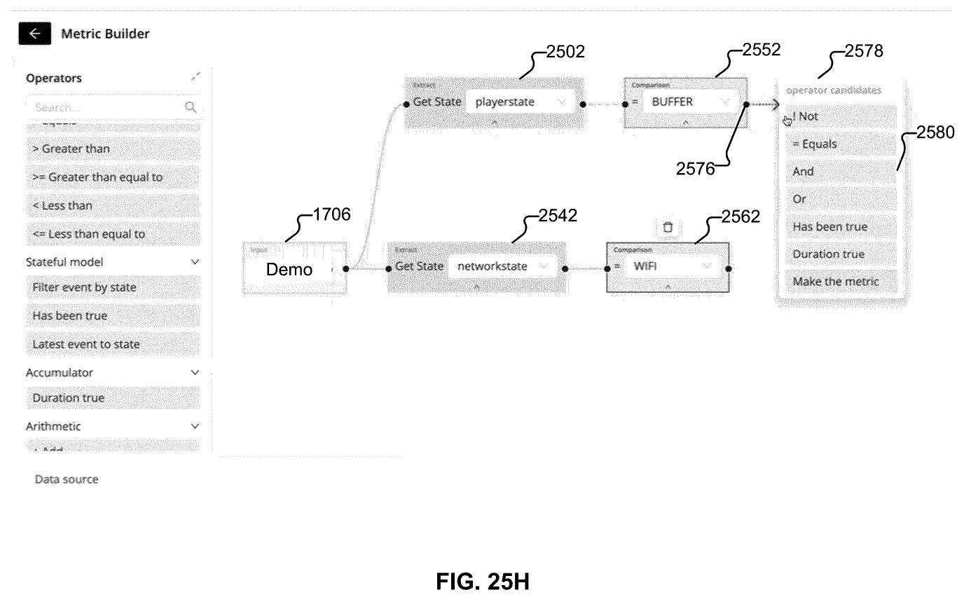

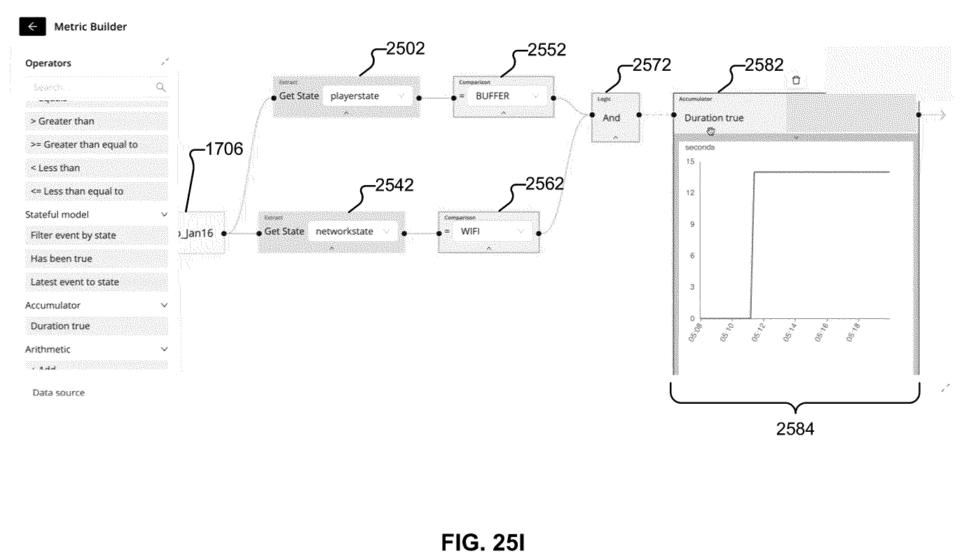

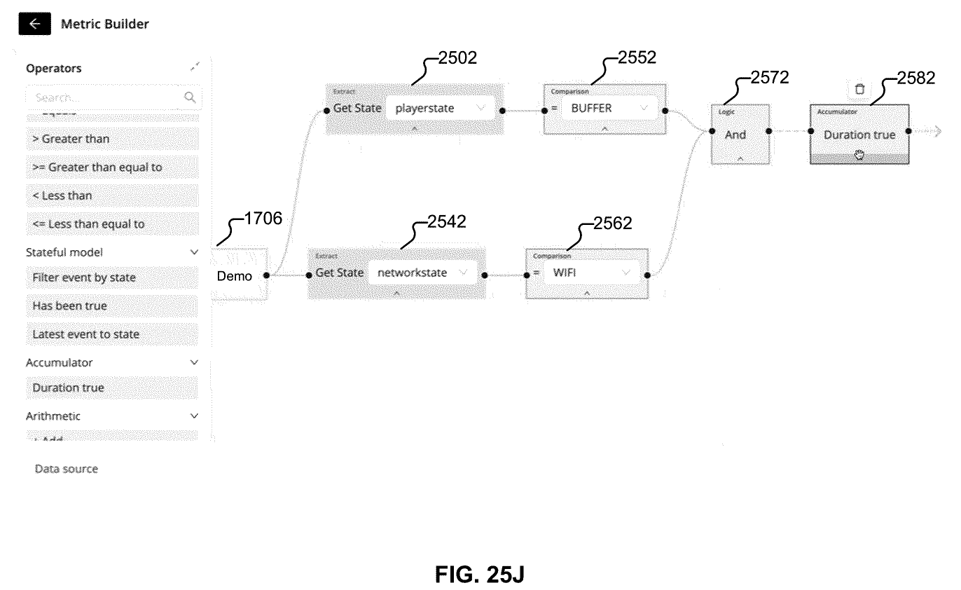

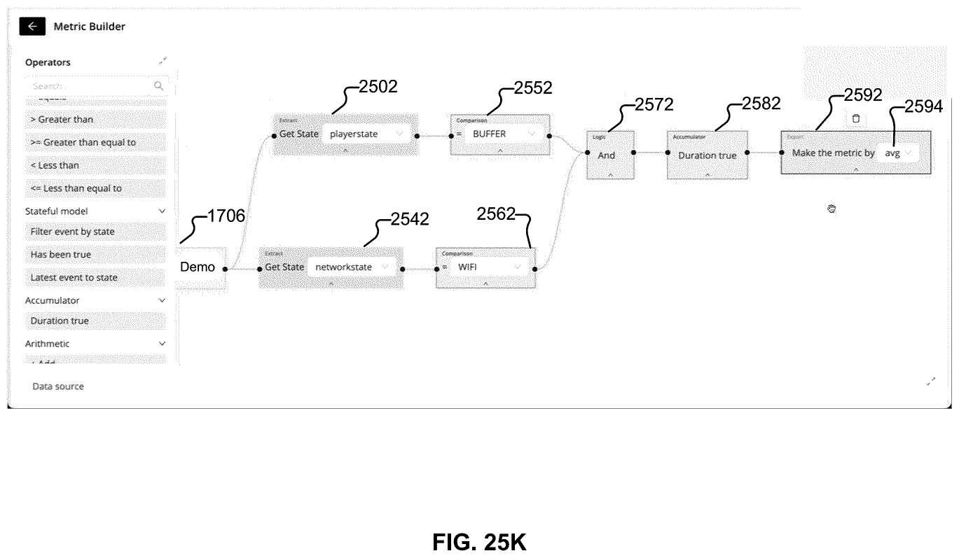

FIG. 25A illustrates an embodiment of a visual stateful metrics composition interface. In this example, after having previewed the schema of the dataset, as described above in conjunction with the example of FIG. 17B, the developer knows that the state of buffering is a value of the player state field. In this example, the developer drags the “Get State” operator from the operator library and places it as a node on the editor canvas, as shown at 2502. The developer also connects the “Get State” operator to the Demo dataset 1706, as shown via connection 2504 that the developer generates by dragging a line between the output connector of dataset node 1706 and the input connector of “Get State” operator node 2502.

In this example, for the “Get State” operator, a dropdown menu is shown of events that apply for the “Get State” operator. In this example, the developer selects the playerstate event at 2506. In some embodiments, the composition system provides lists of values that the user can select from, rather than the user needing to find, copy, and paste the values manually. In some embodiments, the available fields are determined based on scanning of the selected input dataset (e.g., to identify field names, key names, column names, etc.).

FIG. 25B illustrates an embodiment of a visual stateful metrics composition interface. In the example of FIG. 25B, in response to the developer placing the “Get State” operator, specifying or setting the field for which the state should be retrieved, and connecting the “Get State” operator to the input data set, visual feedback is provided. For example, real-time feedback is shown visualizing the output of applying the transformation of the “Get State” operator to the specified playerstate field in an exemplar session of the selected input dataset. In this example, real-time feedback is presented at 2522, visually illustrating an example of the output timeline generated by the “Get State” operator (given data from an exemplar session in the input data set). In this example, the timeline preview visualizes that the player was in the init state for time period 2524, in the play state for time period 2526, in the buffer state for time period 2530, and back in the play state for time period 2528.

In some embodiments, the real-time, interactive feedback is generated by processing data in the exemplar session in real time, on the fly. FIG. 25C illustrates an example of session data. In this example, the feedback portion 2522 is generated based on session data such as that shown at 2532 (in this example, the session data shown at 2532 is the same as the session data shown at 1752). As shown in this example, the player state in its tabular form is shown at 2532 (which can be difficult for the developer to visualize what is occurring over time), and has been transformed into the timeline visual representation shown at 2522, allowing the developer to visually determine how the operator is transforming the tabular player state data into a timeline representation of the player state.

In this example, the exemplar input data that is used to power the timeline preview is for a single session. In this example, a per-user or per-session stateful metric is being computed. As one example, the input data set may include data from multiple sessions. In some embodiments, a session is selected at random, and the selected session's data is used to power the interactive feedback shown in the example of FIG. 25B. Specific sessions (identified by session identifier) or users (identified by viewer identifier) can also be selected by the developer as exemplar data for powering interactive visual feedback.

In this example, the metrics composer facilitates composing of logic that is applicable to all sessions. In some embodiments, data from exemplar sessions is used to facilitate building of the logic of the stateful metric, such as to provide the interactive feedback and example results of application of the arrangement of nodes/operators specified in the editor canvas.

The developer can also change the context of the data on which metrics are built. For example, the developer can change the context to build stateful metrics on the identifier instead of the session identifier. For example, the context of viewer identifiers may be used when building user-level metrics, rather than using session identifiers for when building session-level metrics.

Continuing with the example of FIG. 25C, in order to build the stateful metric of duration of buffering when using WiFi, the developer also needs to determine when the player or device was on WiFi. By viewing the preview of the dataset, the developer is able to ascertain that the state of WiFi is indicated as a value in the network state field. In this example, the developer uses the node-graph editor to select a “Get State” operator to represent the network state field data as a state timeline.

FIG. 25D illustrates an embodiment of a visual stateful metrics composition interface. In this example, similar to the example of FIG. 25B, the developer drags the “Get State” operator from the operator library, adding it as a node to the stateful metric graph being composed in the editor canvas. The developer selects or specifies or sets “networkstate” as the field for which the “Get State” operator is applied on. The new “Get State” operator node 2542 is also connected to the Demo dataset 1706. A visualization of the network state as a state timeline or step function over time (based on applying the operator in real time to the exemplar session data) is shown at 2544.

Continuing with the example of FIG. 25D, as part of building the stateful metric of duration of buffering when using WiFi, the developer is interested in when the player state is buffering. Configuring the sub-logic for identifying when the player state is buffering is shown in the example of FIG. 25E.

FIG. 25E illustrates an embodiment of a visual stateful metrics composition interface. In this example, the user configures the logic for determining when the value of the playerstate field is buffering by dragging the operator “=Equals” from the comparison section of the operator library into the editor canvas. This causes node 2552 to be added to the canvas. In this example, the developer connects the input connector of =Equals node 2552 to the output connector of “Get State” (playerstate) node 2502. This visually signifies that the output state timeline of node 2502 will be passed as an input timeline to the Equals operator for processing. In this example, the value to be matched on is specified in the Equals operator as “BUFFER.” As one example, the developer selects the “BUFFER” value from a dropdown menu that includes a list of available fields of the “playerstate” field. The system determines the available fields based on the type of operator being used, as well as the type of input permissible for, or otherwise compatible with, node 2552.

A real-time visualization of the output of applying the =Equals operator based on the value “Buffer” to the timeline generated by “Get State” node 2502 is shown at 2554. For this example visualization, the developer can immediately observe, in the output timeline of 2554, that there is buffering only during a short amount of time (where player state==Buffer was True, corresponding to portion 2530 of the timeline shown at 2522 of FIG. 25B), as shown at 2556 (given the exemplar input session data). In this example, a Boolean timeline is produced as output.

Continuing with the example of FIG. 25E, as part of composing their overall stateful metric of duration of buffering when using WiFi, the developer also configures sub-logic for determining a timeline of when the device was using WiFi (e.g., Boolean timeline of when it is True that the network state of the device was on WiFi). An example of such logic configuration is shown in the example of FIG. 25F.

FIG. 25F illustrates an embodiment of a visual stateful metrics composition interface. In this example, the developer configures the sub-logic (of the overall stateful metric) for determining when the value of the networkstate field is WiFi. In this example, similarly to as shown in the example of FIG. 25E, the developer drags another instance of the operator “=Equals” from the comparison section of the operator library into the editor canvas. This causes node 2562 to be added to the canvas. In this example, the developer connects the input connector of node 2562 to the output connector of “Get State” (networkstate) node 2542. In this example, the value to be matched on is specified or set in the Equals operator node as “WIFI.” A real time visualization of when it was True that networkstate==WIFI is shown at 2564. For example, using the exemplar session data as input, a Boolean, True/False timeline is generated and visualized, illustrating when it is True that the device was on WiFi. The output timeline shown at 2564 visually illustrates application of the Equals operator to the network state timeline shown at 2544 of FIG. 25D.

Now, in order to compose the stateful metric of duration of buffering when on WiFi, the developer configures sub-logic for generating a timeline of when the player was both buffering and was using WiFi. The user is able to visually configure such sub-logic via the editor, as shown in the example of FIG. 25G.

FIG. 25G illustrates an embodiment of a visual stateful metrics composition interface. In this example, to determine when it was true that the device with both buffering and using WiFi, the developer configures logic for implementing the logical AND of the output timelines of nodes 2552 and 2562. For example, logical AND operator 2572 is added to the editor canvas. The outputs of both nodes 2552 and 2562, which will both produce Boolean type output timelines, are connected to the input connector of AND node 2572. AND node 2572 will produce as output a Boolean timeline that is TRUE when both Buffering and on WiFi, and FALSE otherwise. A visualization of an example output timeline is provided as interactive real-time feedback at 2574.

In this example, the AND operator 2572 can be added via a number of paths. As one example, the user drags a logical AND operator from the operator library. In another embodiment, the AND operator is automatically suggested by the stateful metrics visual composition engine. Consider the example of FIG. 25H, which shows the canvas editor prior to addition of the AND node operator in the stateful metrics node-graph.

FIG. 25H illustrates an embodiment of a visual stateful metrics composition interface. In this example, rather than selecting a node operator from the operator library in the nodes library panel, the developer can interact with the output connector 2576 of the Equals comparison node 2552 to see what candidate operators are applicable to be a next node whose input is connectable to, or compatible with, the output of node 2552. For example, the stateful metrics visual composition engine is configured to make automatic suggestions for the next operators. In this example, to explore the available operation for the next operator to connect the current operator to, the developer clicks on the output connector of the current operator, in response to which an automatically suggested list of candidate operators is presented that the developer can explore and choose from. In some embodiments, the auto-suggest feature or functionality is triggered when a user clicks on another part of the operator node (e.g., right middle point of an operator to an edge to another operator).

For example, in response to interacting with output connector 2576 of node 2552, the menu of operator candidates 2578 is presented. The menu 2578 includes operator candidates that are automatically generated by the metrics composition engine. In some embodiments, the candidate operators include those operators that are able to take as input the type of output that node 2552 produces. For example, permitted candidate operators are those whose allowed input type (e.g., input timeline type and value type) is compatible with the output type of the node to which the next operator is to be connected. In this example, this includes operator candidates that operate on, or can be applied to, Boolean timelines of True/False values (where the output of node 2552 is a timeline of type Boolean, which has Boolean type values).

As described above, in some embodiments, the operators that are automatically suggested as candidate next nodes for a current node are determined based on the type of output of the current node. For example, operators whose input type matches to the output type of the current node are automatically suggested as candidate operators to be next connected nodes in the stateful metric graph. For example, the auto-suggestion candidates are presented based on a rule that the output type of the current operator and the input type of the next operator should be compatible. In some embodiments, the auto-suggestion feature provides a list of “next” operators whose input data type should be compatible with the output data type of the “previous” or “current” operator. As one example, a “Get State” operator with string values may only be allowed to connect with (or otherwise be compatible with) an Equals comparison operator, and as such, only the Equals operator would be displayed as an operator candidate.

As described above, there are various types of timelines, whose values may be of various types. For example, timeline operators may allow certain types of inputs, and produce certain types of outputs. In some embodiments, incompatibility between two nodes to be connected is also determined. For example, if an output type of a current or previous node does not match (or is otherwise incompatible) with the input type of a connected next node, the metrics composition engine, in response to detecting the incompatibility, generates and presents an alert or other visual feedback indicating that there is an error in the attempt to connect the two incompatible operator nodes. In this way, functionality is provided that disallows incompatible operators to be connected to avoid errors. Rules for other types of compatibility checks between operator nodes can also be configured. For example, some operators may require multiple inputs, where an error is flagged if the input of the next node is connected to an insufficient number of prior node outputs.

In this example, the user selects the “And” operator candidate at 2580, resulting in the stateful metric graph (DAG) shown in FIG. 25G. In some embodiments, when selecting an auto-suggested operator, the selected candidate is included in the editor and automatically connected to the node from which automatic suggestion was triggered.

In this example, the developer is composing a metric to determine an amount of time that was spent buffering when using WiFi. At this stage of the composition of the stateful metric, the output of logical AND operator 2572 is used to generate a timeline that indicates when buffering occurred while using WiFi (e.g., Boolean timeline that is TRUE during the periods of time when both player state was buffering and network state was WiFi). Continuing with the example, the developer then configures the sub-logic of the overall stateful metric for computing the amount of time in which the device was both buffering and on WiFi.

FIG. 25I illustrates an embodiment of a visual stateful metrics composition interface. In this example, to determine the amount of time when buffering while using WiFi (e.g., amount of time in aggregate when it is TRUE that playerstate==Buffer and networkstate==WIFI), a duration true node (example of an accumulator operator) 2582 is added as a next operator connected to the output of the And operator 2572. Real-time visual feedback visualizing an output of the duration time operator node 2582 (based on using the session data as exemplar data) is shown at 2584.

FIG. 25J illustrates an embodiment of a visually composed representation of a stateful metric. In this example, a node-graph, DAG representation of the stateful metric has been drawn via the editor. As shown in the examples of FIGS. 25A-25J, a complex stateful metric that determines the time spent in buffering when using WiFi has been efficiently programmed, visually. With existing techniques, the creation of such a metric would have required hundreds of lines of code, as well as non-trivial debugging.

In this example, a session-level stateful has been visually composed. In some embodiments, the user can export the session-level metric for deployment. As one example, the visual composition described above is performed in a sandbox environment. By performing metrics composition (e.g., visually composing the graph of operator nodes to implement the desired logic for a metric) in a sandbox environment using imported or uploaded exemplar input data allows a metric to be defined without affecting production environments. In some embodiments, once a user has completed composition of their stateful metric, they can then save and commit their metric, and then deploy the new metric to a runtime environment. The use of the visual composition system described herein as a sandbox provides a rapid prototyping system for creating and validating stateful computation metrics.

FIG. 25K illustrates an embodiment of exporting a visually composed stateful metric. In this example, the developer adds an export operator 2592 to make the metric. The make the metric operator is connected to the output of the final timeline operator node 2582 of the stateful metric visual DAG. In some embodiments a computed metric value based on the single exemplar context (e.g., a user session) is included in the final node of the metric DAG.

In this example, the “make the metric by” operator 2592 allows specification of an aggregation (e.g., for multi-dimensional analytics). For example, the “average” selected at 2594 is a specification of an aggregation across sessions. In this example, a session-level stateful metric (computed for each individual session) has been visually composed in the examples described above. At deployment time, the session-level metric is computed across many sessions. In this example, a statistical average across the session-level metric values will be performed to determine an aggregate or rolled-up metric. Other examples of aggregations that can be specified for the “make the metric by” operator include sums, max, etc. Further complex logic can also be built on top of the example session-level stateful metric that has been visually composed.

In the example of FIGS. 25A-25K, a stateful metric has been visually composed. Real-time, interactive feedback is provided to the developer-user as they build up the logic of their stateful metric. Example output of the nodes in the graph is dynamically generated in real-time, providing a preview of the transformations at various points in the node-graph representation of the stateful metric. Tooltip animations are provided to aid the developer in understanding the functions performed by various operators. Auto-suggestion of what are available next operators are also provided to assist in guiding the user in efficiently constructing their stateful metric.

The example of FIGS. 25A-25K illustrate a metrics builder workflow. For example, exemplar sessions with mapped events are obtained (e.g., an input data set is received). The visual metric is built by specifying various timeline operators. The metric is made with different types of statistical aggregations. The metric is now immediately made available in other environments, such as analytics dashboards. Using the visual composition techniques described herein, a user can efficiently (e.g., in a matter of minutes) build a stateful metric and see it in action.

### Node Setting Specification

Embodiments of the user interfaces described herein for visually composing stateful metrics allow for users to specify or modify the settings of a node/operator by selecting various options (e.g., from a drop-down menu), or to edit a metric name when selecting the “Make the metric” node.

### Auto-Suggestions for Next Operators and Type System

The following are further embodiments of auto-suggesting candidate operators. In some embodiments, automatically suggesting candidate operators includes evaluating a timeline type, such as whether it is an event timeline or a state timeline, as well as the type of values the timeline includes, such as string, Boolean, or numerical value. Based on the timeline type and the type of values that are included in the timeline, the operators that can be applied to such timeline types/value types are determined as candidate operators that are automatically suggested. In some embodiments, each operator includes a specification of the timeline types and/or value types it can take as input and operate on, as well as a specification of the type of timeline/value types it outputs. Embodiments of the type system described herein are used to guide the auto-suggestion described herein.

As one example, suppose an input data set. The data type of the input data set is a raw data type. In some embodiments, the operators that apply to raw data type values are “Get Event” and “Get State” operators, which are used to perform extraction from the raw data (and take raw data as input) to generate timelines.

As another example, suppose that the output timeline of an operator is an event-type timeline that has a string value-type. In this example, based on the string value-type a “greater than” operator is not suggested as a candidate next operator, as it may not be meaningful. On the other hand, an equality check on strings (e.g., “Equals” operator) is automatically suggested as a candidate operator that is compatible with the string-value type of the output of a current operator.

In some embodiments, the auto-suggestion processing automatically suggests both candidate operators, as well as the set of values that can apply to the operator. As another example, suppose that the output of a current operator is an event timeline of type Boolean (event timeline-type, and Boolean value-type). In this example, based on the event timeline-type and the Boolean value-type, candidate operators that are automatically suggested include Boolean operators that are able to operate on Boolean value types (e.g., Not, Equals, And, Or, Has been true), as well as operators that apply to event timeline-types (e.g., “Latest event to state” operator).

As yet another example, suppose that a “Latest event to state” operator is the current operator, and converts an event timeline of type Boolean to an output state timeline also of type Boolean. In this example, the candidate operators that are suggested/presented as next operators include operators that apply to state timeline-types.

As yet another example, suppose that a duration operator is the current operator. The duration operator produces as output a numerical timeline with number value-types (e.g., integers). In some embodiments, a duration true operator, which performs accumulation, produces a numerical timeline that is a continuous value timeline that is monotonically increasing in value. In this example, the candidate operators that are automatically suggested as next operators are operators that apply to, or are otherwise compatible with, numerical values, such as operators for adding, subtracting, multiplying, dividing, making greater than comparisons, etc.

As described above, for a current or prior operator, candidate next operators are determined based on the compatibility of input timeline type/value type specified for a candidate next operator with the characteristics of the output timeline produced by the current operator, such as the type of the timeline, and the type of values that the timeline includes. Three example timeline types include event, state, and continuous values. Within each timeline type, the type system further includes different types of values that a timeline type includes (e.g., string, numerical, Boolean, etc.).

In some embodiments, the timeline type is also referred to as the temporal dynamics of a timeline (e.g., events in time, state evolving over time, continuously changing values over time). Put another way, a timeline is characterized by its temporal dynamics and the types of values included in the timeline.

In some embodiments, each operator is well-defined in terms of what temporal dynamics and what value type it expects as input, and what temporal dynamics and value type the operator will produce as output. The auto-suggesting of next operators described herein is supported or facilitated by embodiments of the type system (temporal dynamics and value types for timelines) described above.

Developers may attempt to manually connect the input of a next operator to the output of the current operator when the input of the next operator and the output of the current operator are incompatible. In some embodiments, the type system described herein is also used to prevent such incompatible connections. For example, if the temporal dynamics/value types of the input of the next operator do not match or are otherwise incompatible with the temporal dynamics/value types of the output of the current operator, then the mismatch in temporal dynamics/value types is used to trigger blocking of connecting of the incompatible operators. As another example, error messages are provided as output. Other types of visual feedback may be provided in response to detecting temporal dynamics/value type incompatibility, as appropriate. In some embodiments, panels for real-time interactive feedback (and timeline previewing) may be left blank, as the output may be undefined.

### Exporting a Metric

The following are further embodiments of exporting a metric. As shown in the example above, when the developer is satisfied with the logical implementation of their stateful metric, they can finalize the creation of the metric by using an operator to make the stateful metric.

In some embodiments, the “make the metric” operator commits the metric and saves it. After the metric is saved, the saved metric can be exported for various uses. As one example, the saved metric can be deployed.

As one example, when successfully deployed, the new metric is now available in analytics dashboards. For example, the deployed metric is made available in an aggregate metric dashboard. This allows analytic users to see aggregated metric results of applying a metric across multiple contexts (e.g., users or sessions) and grouping by different attributes such as devices and locations.

In some embodiments, the UI (user interface) DAG representation of the stateful metric drawn by the developer is converted or translated into a metrics configuration file (e.g., where the metric is exported as a YAML configuration file). The configuration file can then be deployed to other environments, such as a real-time running system or a production system. The new configuration file can also be exported to a configuration database (e.g., included in configuration files 304 of FIG. 3).

### Timeline Preview

The following are further embodiments regarding real-time, interactive feedback. As described above, in some embodiments, the developer can interact with an operator node to see what output would be produced by the operator, given exemplar data for a single session. Such functionality is also referred to herein as a timeline preview. In some embodiments, the timeline preview is a data preview feature for each operator in the DAG pipeline (chain or DAG of operators that collectively specifies the logic for the stateful metric being composed) that allows users to visualize what the operator does to transform the underlying data.

In some embodiments, once a user adds and connects operators in the editor canvas to compose the metric graph, the user can obtain a timeline preview of any node/operator in the metric graph. As one example, the timeline preview can be presented in response to clicking a bottom edge of a node. In some embodiments, timeline previews are an example of a validation feature. The timeline preview provides just-in-time visual cues and visual feedback that allow users to check whether they are composing the metric graph as they expected. The timeline preview feature also allows users to debug the metric graph if they identify any discrepancies between the preview and their expected results. Further, the timeline preview provides increased transparency at how their stateful metric arrives at final results, as well as increases the control users have in creating stateful metrics.

The following are further embodiments of generating timeline previews and real-time interactive visual feedback. In some embodiments, providing visual feedback, such as timeline previews, cues, hints, etc. is implemented by dynamically coordinating interaction between a UI frontend and a time-state backend (also referred to herein as a timeline backend). Further embodiments and details regarding implementation of such UI frontend and time-state backend interaction are described below.

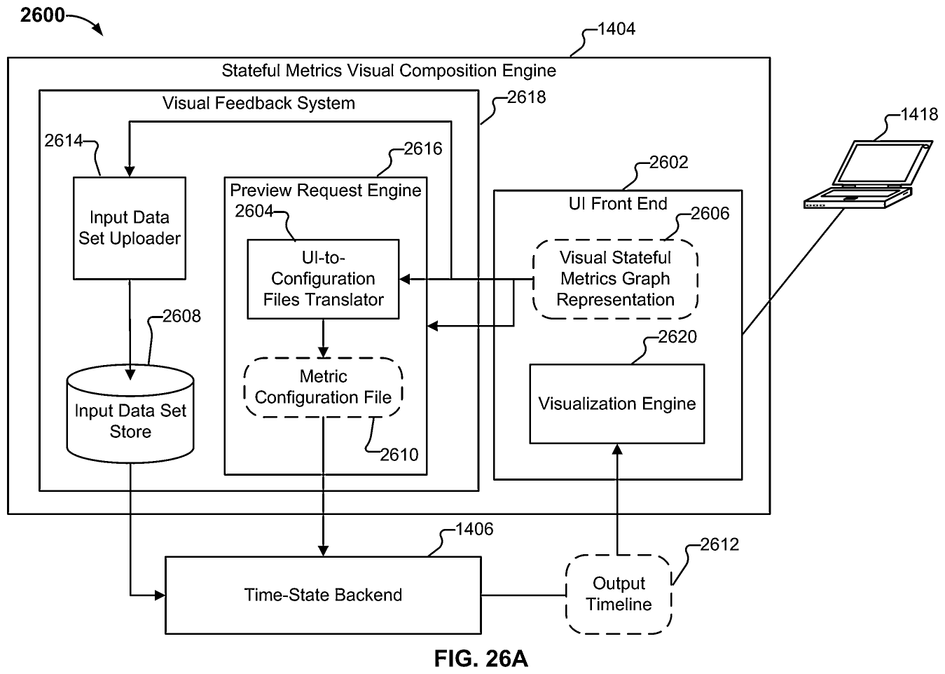

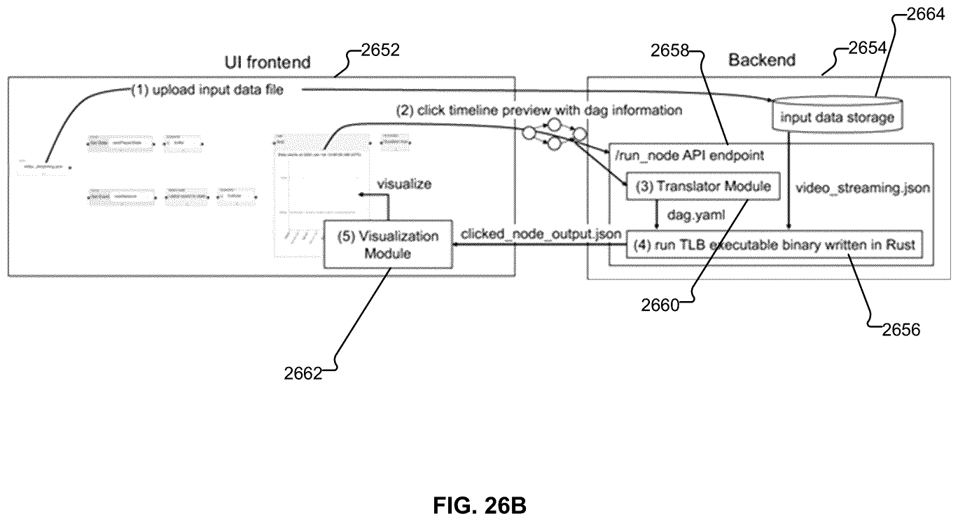

FIG. 26A illustrates an embodiment of a stateful event analytics platform. In this example, the stateful event analytics platform 2600 is an alternative view of stateful event analytics platform 1402. In some embodiments, the stateful event analytics platform provides a visual programming platform for stateful analytics, including dynamic visual feedback.

As shown in this example, stateful metrics visual composition engine 1404 leverages time-state backend 1406 to provide visual feedback dynamically, responsive to a user's interaction with the node graph editor when composing a stateful metric (e.g., request for visual feedback or timeline preview). As described above, in some embodiments, time-state backend 1406 is an alternative view of time-state metrics system 300 of FIG. 3.

In this example, stateful metrics visual composition engine 1404 further includes UI (user interface) frontend 2602. Stateful metrics visual composition engine 1404 further includes visual feedback system 2618. Visual feedback system 2618 is configured to provide dynamic visual feedback.

In this example, visual feedback system 2618 includes input data set uploader 2614 and input data set store 2608. In this example, visual feedback system 2618 further includes preview request engine 2616. In this example, preview request engine 2616 further includes UI-to-configuration files translator 2604. Translator 2604 is configured to translate requests between the UI and the time-state backend 1406.

In one example implementation, the UI front end 2602 is written in JavaScript (React), underlying timeline operators are implemented in Rust, translator 2604 is implemented in Python, and the time-state backend 1406 is implemented in Rust. For example, the UI frontend is implemented with JavaScript Reach Flow. As another example, the visual feedback system is an HTTP web server implemented with the Python FastAPI framework. As one example, the time-state backend 1406 is implemented as a binary with which the metric DAG is executed. Other implementations may be utilized, as appropriate. While the time-state backend is shown to be separate from the visual feedback system in this example, in other embodiments, the time-state backend is incorporated as a component of the visual feedback system.

The following is an example of using system 2600 to provide a timeline preview for a target node in the metric being composed. In this example, the time-state backend 1406 is configured to receive two inputs: the input dataset file (e.g., input dataset file that is uploaded to input data set store 2608) and the metric DAG with the target output node (encoded within metric configuration file 2610 in this example). With these two inputs, the time-state backend generates a file that contains the timeline output to be previewed for the requested node (represented in this example as output timeline 2612). In some embodiments, the dynamic visual feedback system provides both batch and streaming modes of operation.

The following are further embodiments of integrating the UI frontend and the time-state backend. Embodiments of the integration described herein include example steps to run or execute the metric DAG and visualize a timeline preview into the UI frontend.

1. Upload the input dataset file. As described above, users of the composition interface described herein first select the input dataset file they want to analyze. In some embodiments, this input dataset file is uploaded (by input data set uploader 2614) to input data set store 2608.

2. Click a node to see the timeline preview. After, or as the user composes a visual representation of a visual stateful metrics graph representation 2606 (which need not be its final form, and can be an intermediate state of composition), a user can interactively see the timeline preview of any of the nodes that they created (e.g., by clicking the node). In some embodiments, in response to the timeline preview request received via the UI, the UI frontend sends an HTTP request to preview request engine 2616 (which as one embodiment is an API endpoint referred to herein also as a “run_node” API endpoint, as shown in the example of FIG. 26B) with the DAG information (from the UI).

3. In some embodiments, the DAG information is generated by a built-in export API of the ReactFlow framework (that the UI front end is implemented in). In some embodiments, the DAG information is translated into a form that is executable and can be understood and interpreted by the time-state backend. As one example, the metric DAG follows a predefined set of rules so that an internal compiler of the time-state backend (an example of which is compiler 306) can parse and run the metric DAG. In some embodiments, UI-to-configuration files translator 2604 is configured to translate exported DAG information into a configuration file 2610 (e.g., into a YAML (human-readable markup language) file) that represents the metric DAG and can be parsed by the time-state backend 1406.

4. Run the metric DAG using the DAG configuration file 2610 and the input dataset file (from input data set store 2608). For example, configuration file 2610 is included in configurations files 304 for processing. In some embodiments, the time-state backend 1406 runs the metric DAG (e.g., using embodiments of processing described above by timeline processor 310) and outputs an output timeline 2612. In some embodiments, exemplar data (e.g., data for a single session or single user, or any other context as appropriate) from the input data set is used to determine an example output. As one example, the output timeline 2612 is output in a JSON format. In some embodiments, the timeline output results are returned to the UI front end. In one embodiment, the preview request engine, as an API (Application Programming Interface) endpoint, returns the timeline output results to the UI frontend.

5. In some embodiments, when the UI frontend receives the timeline output results, it is in a timeline representation or form, with a set of spans of time and the corresponding y-axis values. In some embodiments, in order to provide visual cues and feedback, visualization engine 2620 is configured to plot output results on the UI frontend (e.g., generate a visual representation of the output timeline). As one example, the visualization model is implemented using the JavaScript Apache ECharts library. Other implementations may be utilized, as appropriate.

In some embodiments, the time-state backend is run in (near) real time to provide interactive feedback. For example, requests are provided to the time-state backend (to compute stateful metrics including a DAG of timeline operators applied to an input dataset), which provides results in response that are visualized to the developer via the UI frontend.

As described above, one example underlying data structure representation of a stateful metric is as a directed acyclic graph (DAG). As shown in the examples above, in some embodiments, the DAG structure is exposed as a building or composition representation as well. The use of the DAG representation facilitates both an efficient internal data structure representation, as well as the visual building representation. There is then a correspondence between the visual building representation and the underlying internal data structure representation. Put another way, the visual composition interface described visualizes or otherwise provides a direct mapping between visual programming constructs (DAG) and the underlying data. While a DAG visual representation is utilized in the examples described herein for illustrative purposes, other visual representations may also be utilized that are then translated into the internal or underlying DAG structure.

The timeline previewing can be performed at any time during the composition of the metric. For example, while a completed metric is associated with a certain DAG, the partial or incomplete or intermediate DAG is still a DAG that can be run and computed. In this way, results so far, or intermediate results of the DAG, can be computed on demand, with results provided dynamically. In this way, interactive composition and feedback is provided in near real time.

In some embodiments, each time the visual stateful metrics graph representation 2606 is edited, a request is sent to the preview request engine to perform recomputation on the exemplar data (where changing of exemplar data context can also trigger recomputation). For example, a new internal DAG data structure corresponding to the updated UI DAG representation is generated (e.g., by translator 2604). Recomputation using the new or updated internal DAG data structure is then performed. In some embodiments, anytime a change is made to the DAG visualization, a recomputation event is triggered. In this way, interaction between the developer and the visual composition system is facilitated, where updates made to the DAG visualization by the user trigger a new request to the preview request engine to recompute with an updated DAG and provide back updated results.

As one example, suppose the developer adds a node in the editor/canvas, changing the DAG. The UI frontend detects the change to the visual stateful metrics graph visualization 2606 (adding of the new node in this example) and sends a request to trigger a recomputation and sending of results. Deletions and modifications to nodes are other examples of UI DAG representation updates that trigger a time-state recomputation and cause results to be refreshed.

In some embodiments, within the sandbox environment for composing a stateful metric, the state of the computations can be in flux, and any changes made to the graph in the UI result in a new stateful metric being generated, where time-state computations are performed whenever the updates are made. In this way, the time-state backend generates an internal, underlying DAG data structure that reflects the current state of the DAG in the UI.

In some embodiments, the computation performed by the time-state backend is performed using exemplar data selected from the input data set. In some embodiments, the exemplar data is used for the purposes of testing and validating the composition of the metric. In some embodiments, the context of the exemplar data can be modified. For example, the exemplar session or user data can be changed.

In some embodiments, the visual stateful metrics graph representation 2606 is converted into a configuration file. As one example, the configuration file is implemented as a YAML file. Other formats may be utilized, as appropriate. In some embodiments, the configuration file is added to a configuration database. In some embodiments, the time-state backend is a runtime streaming system that pulls configuration files from the database and performs timeline processing and computation. In this example, whenever an update to the UI DAG is made, a new, corresponding configuration file is generated and added to the configuration database. The time-state backend then performs computation according to the new configuration file. In this example, the developer visually composes a metric. The metric is published as a configuration file, and is run in real time by the timeline backend. Any time there is an update in the sandbox, the new UI representation of the metric being composed is converted into a configuration file that is exported to a configuration database to be run.

As one example, whenever a change to the UI representation of the metric is detected (e.g., adding, modification, deletion, etc.), new JSON output is created by the UI frontend (JSON is but one example output that represents the state of the visually composed DAG in the UI). The new JSON output is translated into a YAML configuration file. Based on the detected change, a request for recomputation is made with the new YAML configuration file.

For example, the UI frontend monitors for whether a UI event has changed the UI DAG representation. If a change is detected, the UI front end triggers a recomputation in the time-state backend. The translator provides a translation layer between the UI JSON and the time-state backend. The time-state backend sends back the output of the computation. In some embodiments, the output is provided in a format understandable by the UI frontend.

In the example of FIG. 26A, the time-state backend, in response to the new metric configuration file translated based on the updated UI DAG representation, generates as output an output timeline 2612. The output timeline includes a representation that is a sequence of spans (described in further detail above). Visualization engine 2620 is configured to translate the timeline span representation into a visually compatible format that can be presented via the UI frontend (e.g., Apache charts, JS library, etc.). For example, span data from the time-state backend is configured or interpreted into a charts library to be presented by the UI frontend. As shown in the above, both input as well as output translation are performed. The translator module translates the visual representation of the metric being composed into a YAML configuration file of the metric. The visualization engine translates the output timeline data structure into a visually presentable format.

In some embodiments the translator 2604 is a middleware intermediary that takes the logic expressed in the UI and converts or translates it into a form consumable and understandable by the time-state backend. The translator acts as a “glue” between the UI frontend and the time-state backend. For example, as described above, the translator converts the UI operators into a YAML configuration file (e.g., configuration file 2610).

In some embodiments, the middleware is implemented to be sufficiently efficient to support interactive feedback. In this way, as soon as (or soon after) a user adds an operator in the UI, visual feedback is provided in response (based on time-state backend processing triggered in response to the UI addition). The efficiency of both the translator middleware and the time-state backend facilitates real-time interactivity. In some embodiments, the translator middleware and the time-state backend are implemented in a fast programming language, such as Rust.

Put another way, the translator module is configured to act as an intermediate layer that is an interpreter or a translator between the UI front end and the time-state backend. As one example, the UI frontend outputs JSON (e.g., JSON representing the chain of operator label representations that a developer user has created in the UI). The translator (implemented, for example, as a Python module) takes the UI JSON output and converts it into a YAML configuration that the time-state backend understands. For example, the translator includes a translation library that takes the UI representation of the DAG and converts it into timeline operators to include in the configuration file.

In some embodiments, the translator middleware facilitates the extrapolation and creation of complex high level operators from low level operators. As one example, the “Get State” operator is implemented as a composite operator of two atomic operators. The ability of the middleware to extrapolate and create complex high level operators from low level operators simplifies the job of the composition user interface.

For example, suppose a composite operator that is created that is a composite of atomic operators A, B, and C. In this case, a meta-level operator block has been created (and presented in the nodes library panel of the visual composition interface). It may be beneficial to a user to be able to have such a composite operator to work with in the user interface. The time-state backend need not understand that some new operator has been created. From the perspective of the time-state backend, there are atomic operators A, B, and C being utilized in a particular manner (e.g., in their own sub-graph). In some embodiments, the middleware layer of the translator facilitates composite operators.

In this way, the UI can show atomic operators, composite operators, and higher level operators. While the time-state backend is configured to perform processing at the level of atomic operators, the UI and the translator are able to perform processing at a higher level language. A composite operator can also be considered as a sub-DAG or a sub-chain of operators.

As described above, in some embodiments, the visual composition system described herein provides a sandbox environment in which to build or construct or compose a stateful metric. In some embodiments, upon completion of the stateful metric, the metric can be saved and committed (e.g., via the “make the metric” operator) and exported (e.g., deployed to a full runtime system).

FIG. 26B illustrates an alternative embodiment of a stateful event analytics platform. In the example of FIG. 26B, an alternative implementation of platform 2600 is shown. In this example, UI frontend 2652 is an alternative embodiment of UI frontend 2602. In the example of FIG. 26B, UI frontend 2652 includes visualization module 2662, which as one example is an alternative embodiment of visualization engine 2620.

Backend 2654 is an alternative embodiment of visual feedback system 2618 that, in this example, also includes a time-state backend as a component. For example, TLB (timeline backend) 2656 is an example of time-state backend 1406. In the example of FIG. 26B, backend 2654 further includes run_node API endpoint 2658, which is an alternative embodiment of preview request engine 2616. Backend 2654 further includes translator module 2660, and is an alternative embodiment of translator 2604. Backend 2654 further includes input data storage 2664, and is an alternative embodiment of input data set store 2608.

Embodiments of the visual composition system are performant, such as due to the efficiency of the time-state backend. For example, implementing the time-state backend in a programming language such as Rust achieves significant throughput improvements. Such high efficiency and throughput allows users to see the results of adding operators in near real time. This interactivity also aids users in exploring different operators and learning the tool as they use it.

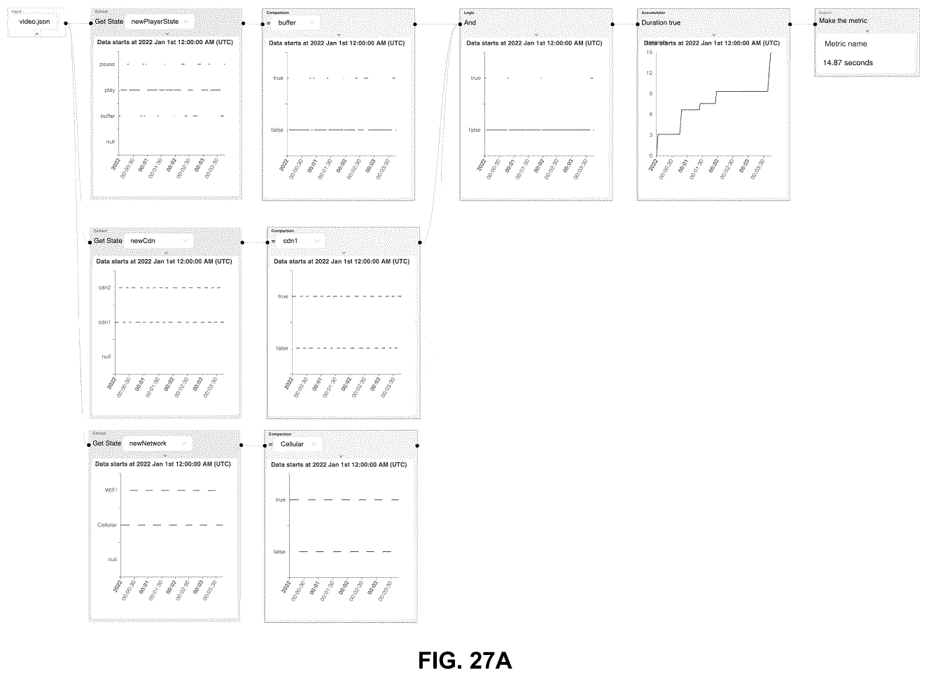

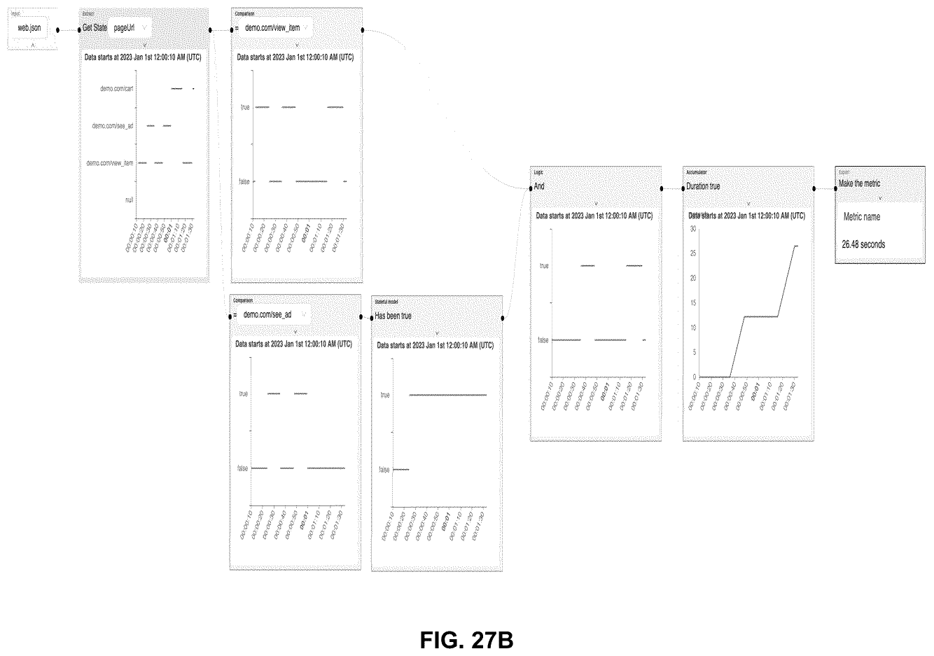

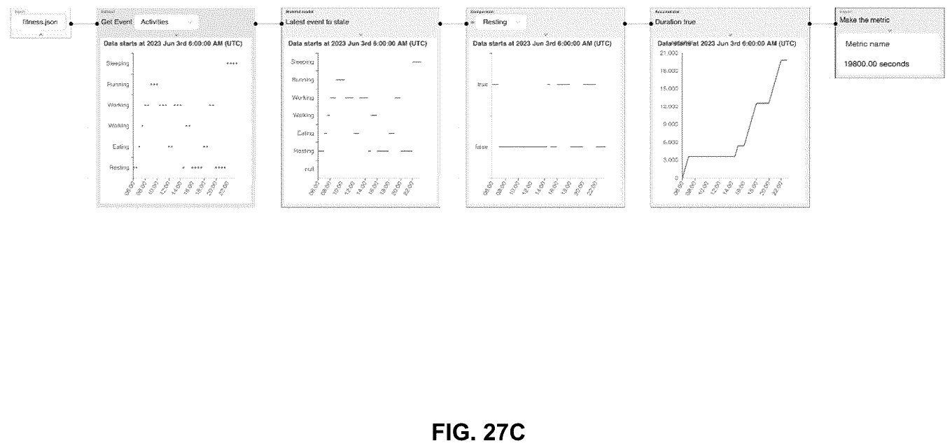

While examples of visual composition of stateful metrics in the context of video streaming have been described for illustrative purposes, the stateful metrics visual composition tool described herein can be used to create stateful metrics for various other applications. Various examples of stateful metric DAGs created for various contexts using embodiments of the stateful metrics visual composition tool described herein are shown in FIGS. 27A-27C. FIG. 27A illustrates an embodiment of a visually composed stateful metric DAG for video streaming. FIG. 27B illustrates an embodiment of a visually composed stateful metric DAG for website browsing. FIG. 27C illustrates an embodiment of a visually composed stateful metric DAG for fitness tracking.

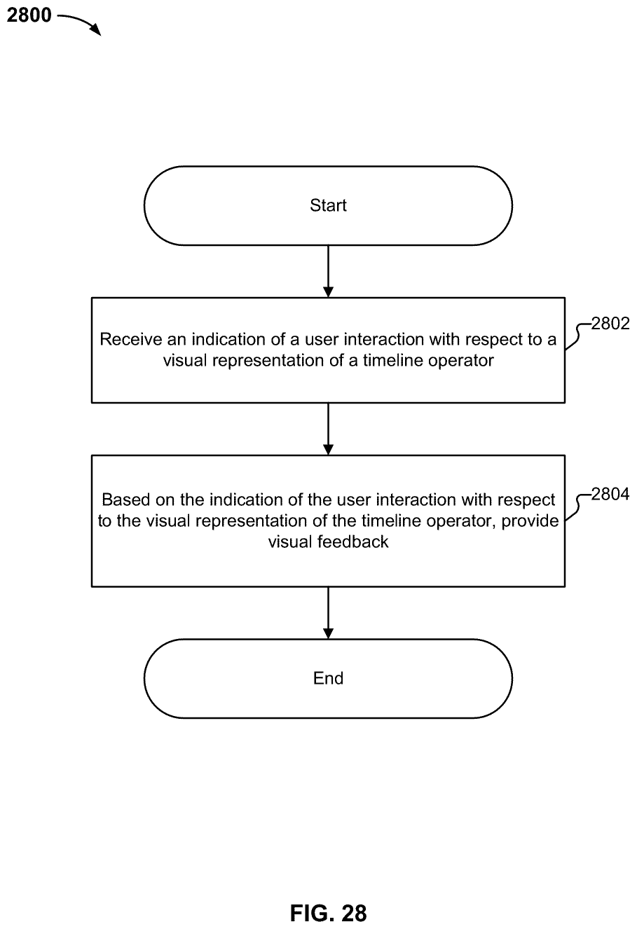

FIG. 28 is a flow diagram illustrating an embodiment of a process for visual composition of stateful metrics. In some embodiments, process 2800 is executed by stateful event analytics platform 1402. The process begins at 2802 when an indication of user interaction with respect to a visual representation of a timeline operator is received. For example, an indication of selection of, or interaction with, the visual representation of a timeline operator is received via a stateful metrics visual composition interface. For example, the visual representation of the timeline operator is presented in a node graph editor. The visual representation of the timeline operator is included as a node in a graph representation of a stateful metric that is being visually composed. The timeline operator is configured to transform an input into an output timeline representation. The input can include an input data set or a timeline.

At 2804, based on the indication of the user interaction with respect to the visual representation of the timeline operator, visual feedback is provided. In some embodiments, a timeline operator takes as input a measurement over time of events, states, or continuous values, and manipulates the input to produce an output timeline. That is, in some embodiments, the timeline operator takes as input one or more graphical sequences over time, and applies a function or transform to produce one or more sequences over time. For example, the timeline operator performs a mathematical transformation of a given set of inputs, into a new output timeline in a stateful manner. Visual feedback is provided of the output of applying the transformation prescribed by the timeline operator to the exemplar data (or to input data as a function of having applied previous transformations in the DAG to the exemplar data).

As one example, a visual timeline representation of output of the timeline operator is provided. The timeline representation of the output of the timeline operator is an example of the timeline previewing described above. In some embodiments, the visual representation of the output of the timeline operator is generated based on processing of a stream of event data. For example, the stream of event data is included in exemplar data of an input dataset.

In some embodiments, the visual representation of the timeline operator is included in a visual graph representation of the stateful metric being composed. In some embodiments, generating the timeline preview includes generating a data structure representation of the stateful metric based on the visual representation of the stateful metric. For example, in response to a user interaction with the visual representation of the timeline operator, a request is sent to run the stateful metric in its current form (e.g., visual graph representation, as currently visually composed). As one example, the visual (graph) representation of the stateful metric is converted into a metrics configuration file that includes a data structure representation of the stateful metric. The metrics configuration file is then computed, where a timeline corresponding to the output of the timeline operator is returned to the UI front end for presentation in the visual composition interface. The visual representation of the stateful metric may include a chain of multiple timeline operators. In some embodiments, intermediary output timelines are also generated and made available for visualization. Further embodiments of timeline previewing are described above.

In some embodiments, the user interaction with respect to the timeline operator causes updating of the visual representation of the stateful metric (e.g., adding, removing, or otherwise modifying the visual representation of the stateful metric). In some embodiments, each time the visual representation of the stateful metric is updated, recomputation of the stateful metric (according to the current state of its visual representation) is performed.

Another example of visual feedback includes a tooltip providing explanatory information with respect to the timeline operator. In some embodiments, the tooltip includes an animation that visualizes the transformation performed by the timeline operator.

Another example of visual feedback includes providing output (e.g., an alert) indicating that the timeline operator is prohibited from being connected to a previous timeline operator in the visual graph representation of the stateful metric. For example, connecting of incompatible operators (based, for example, on incompatibility of output/input timeline types and/or value types) is disallowed to avoid errors.

As described above, in various embodiments, visual feedback associated with the metrics composition is provided. Providing visual feedback includes providing visual indications of the impact of the logic that has been added and arranged as part of composing the stateful metric. In some embodiments, the visual feedback that is provided includes timeline feedback (e.g., timeline previewing, as described above). Timeline feedback includes a visualization of the output timeline generated by a timeline operator in the stateful metric being composed. For example, the visual feedback includes a result of applying a chain of operators (as currently configured in the editor) to exemplar data, visualized as a timeline. For example, the visual feedback includes a timeline that is a result of the actions of the chain or DAG of operators as applied to the exemplar data (at a certain requested target point (e.g., output of a target node in the chain of operators)). In some embodiments, the editor described herein facilitates building of logic as a chain of steps. Visual feedback is provided along each step (at the output of each node). End-to-end feedback is provided as well.

In some embodiments, an operator is associated with a corresponding visual tooltip. In some embodiments, the tooltip includes an animated data graph that visualizes applying of the operator to data. In some embodiments, a data preview of the dataset is provided.

In some embodiments, a starting graph representation template is provided. In some embodiments, a graph of the current data for each operator in the graph representation (e.g., DAG) is provided. In some embodiments, an auto-suggestion feature is provided that provides a list of “next” operators whose input data type are compatible with the output data type of the “previous” or “current” operator. In some embodiments, a (drop-down) list of selectable values for an operator (e.g., node setting specification) is presented.

Another example of visual feedback is providing visual error cues, such as when a user attempts to connect two operators that are incompatible, where the input data type of the next operator is not compatible with the output data type of the previous operator.

In some embodiments, each operator in a time-state operator library has a specification of permissible input timeline types and value types. In some embodiments, each operator also includes a specification of the output timeline type and value type that it produces. Different example types of timelines include event timelines, state timelines, and numerical timelines. Timelines can also have different types of values, such as Boolean timelines, string timelines, integer timelines, etc. That is, in some embodiments, a timeline is characterized by a timeline-type (e.g., event timeline, state timeline, or numerical timeline) and a value-type (e.g., Boolean, string, integer, etc.). Based on such a type system, next operators can be automatically suggested based on whether the next node's input timeline types/values types are compatible with the output timeline type/value type of the previous node to which the next node is to be connected.

Embodiments of the visual programming system for stateful analytics described herein provide various benefits and address challenges in creating stateful analytics. As one example benefit, embodiments of the visual composition techniques described herein provide a visual programming platform that simplifies metric creation and validation. For example, using existing techniques, analysts have to write complex query code to calculate stateful metrics. This makes the metric implementation and subsequent validation complex, error-prone, and time-consuming. The visual composition techniques described herein provide an improvement over existing systems when creating stateful metrics, such as by providing users a no-coding visual programming platform to rapidly create and validate metrics. The composition techniques described herein allow users to more easily and efficiently create stateful analytics, as compared to having to write low-level code or queries. In various embodiments, the visual composition system described herein supports stateful data explorations, rapid prototyping of stateful metrics, validation of stateful metrics, etc.

As another example benefit, embodiments of the visual composition techniques described herein support users to understand their datasets. For example, users often want to use visual cues to explore their data to see, for example, the names of various fields and their values. The visual composition techniques described herein allow users to explore and examine the underlying dataset (e.g., slice and dice using timeline operators, as well as have visualizations rendered). This allows the user to, for example, detect potential abnormal behavior or patterns.

As another example benefit, embodiments of the visual composition techniques described herein support user provided datasets. Using the techniques described herein, users can provide their own dataset (where they may be more aware of the ground truth associated with that dataset). The ability to utilize user-provided datasets in metrics composition supports both metric creation and validation. For example, in industry settings, one practice is to run experiments with controllable and configurable end points to learn ground truth metrics. Using the techniques described herein, users can import ground truth data they have obtained to create stateful metrics.

As yet another example benefit, embodiments of the visual composition techniques described herein provide semantics of visual constructs such as nodes or timeline operators of the underlying timeline framework. For example, as described above, various visualizations such as tooltips with animations are provided to explain to analysts the semantics about timeline operators so that users can more easily and appropriately use these operators to create stateful metrics.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A stateful metrics visual composition system, comprising:
one or more processors configured to:
receive, via a user interface, an indication of a user interaction with respect to a visual representation of a timeline operator included in a stateful metric that is being visually composed; and
based on the indication of the user interaction with respect to the visual representation of the timeline operator, provide visual feedback; and
a memory coupled to the one or more processors and configured to provide the one or processors with instructions.

2. The stateful metrics visual composition system of claim 1, wherein the visual representation of the timeline operator is included as a node in a graph representation of the stateful metric that is being visually composed.

3. The stateful metrics visual composition system of claim 2, wherein the graph representation comprises a directed acyclic graph (DAG).

4. The stateful metrics visual composition system of claim 1, wherein the visual feedback comprises a representation of output of applying a transformation prescribed by the timeline operator.

5. The stateful metrics visual composition system of claim 4, wherein the representation of the output of applying the transformation prescribed by the timeline operator is determined at least in part by requesting computing of the stateful metric.

6. The stateful metrics visual composition system of claim 5, wherein requesting of computing of the stateful metric is performed in response to adding of the visual representation of the timeline operator to a visual representation of the stateful metric that is being visually composed.

7. The stateful metrics visual composition system of claim 6, wherein requesting the computing comprises translating a format of the stateful metric.

8. The stateful metrics visual composition system of claim 1, wherein the visual feedback comprises a tooltip that provides explanatory information pertaining to the timeline operator.

9. The stateful metrics visual composition system of claim 8, wherein the tooltip comprises an animation that visualizes a transformation performed by the timeline operator.

10. The stateful metrics visual composition system of claim 1, wherein the one or more processors are further configured to suggest a next timeline operator to connect to the timeline operator.

11. The stateful metrics visual composition system of claim 1, wherein the one or more processors are further configured to provide an alert in response to detecting of incompatibility between a next timeline operator whose visual representation is connected to the visual representation of the timeline operator.

12. The stateful metrics visual composition system of claim 11, wherein the detected incompatibility comprises an incompatibility between an output type of the timeline operator and an input type of the next timeline operator.

13. The stateful metrics visual composition system of claim 1, wherein the timeline operator is configured to transform an input into an output timeline representation.

14. The stateful metrics visual composition system of claim 1, wherein the user interface comprises a node-graph editor.

15. The stateful metrics visual composition system of claim 1, wherein the timeline operator is selected from a library of timeline operators presented in the user interface.

16. A method, comprising:
receiving, via a user interface, an indication of a user interaction with respect to a visual representation of a timeline operator included in a stateful metric that is being visually composed; and
based on the indication of the user interaction with respect to the visual representation of the timeline operator, providing visual feedback.

17. The method of claim 16, wherein the visual representation of the timeline operator is included as a node in a graph representation of the stateful metric that is being visually composed.

18. The method of claim 17, wherein the graph representation comprises a directed acyclic graph (DAG).

19. The method of claim 16, wherein the visual feedback comprises a representation of output of applying a transformation prescribed by the timeline operator.

20. The method of claim 19, wherein the representation of the output of applying the transformation prescribed by the timeline operator is determined at least in part by requesting computing of the stateful metric.

21. The method of claim 20, wherein requesting of computing of the stateful metric is performed in response to adding of the visual representation of the timeline operator to a visual representation of the stateful metric that is being visually composed.

22. The method of claim 21, wherein requesting the computing comprises translating a format of the stateful metric.

23. The method of claim 16, wherein the visual feedback comprises a tooltip that provides explanatory information pertaining to the timeline operator.

24. The method of claim 23, wherein the tooltip comprises an animation that visualizes a transformation performed by the timeline operator.

25. The method of claim 16, further comprising suggesting a next timeline operator to connect to the timeline operator.

26. The method of claim 16, further comprising providing an alert in response to detecting of incompatibility between a next timeline operator whose visual representation is connected to the visual representation of the timeline operator.

27. The method of claim 26, wherein the detected incompatibility comprises an incompatibility between an output type of the timeline operator and an input type of the next timeline operator.

28. The method of claim 16, wherein the timeline operator is configured to transform an input into an output timeline representation.

29. The method of claim 16, wherein the user interface comprises a node-graph editor.

30. The method of claim 16, wherein the timeline operator is selected from a library of timeline operators presented in the user interface.
